(19) United States
(12) Patent Application Publication
(10) Pub. No.: US 2005/0281187 A1
(43) Pub. Date: Dec. 22, 2005

(54) Optical memory device and optical reproducing device

(75) Inventors: Junji Hirokane, Nara (JP); Michinobu Mieda, Nara (JP); Masanori Shimo, Nara (JP); Ikuo Nakano, Nara (JP); Toshihiko Sakai, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/156,284

(22) Filed: Jun. 17, 2005

(30) Foreign Application Priority Data
Jun. 17, 2004 (JP) 180098/2004
Jul. 2, 2004 (JP) 197318/2004
Feb. 4, 2005 (JP) 29822/2005

(51) Int. Cl. G11B 7/00; G11B 7/24

(52) U.S. Cl. 369/275.4; 369/275.1; 369/44.34

(57) ABSTRACT

An optical disk includes a plurality of information units, each of which has a pit array made up of a phase pit on an information track and phase pits surrounding the phase pit. With this structure, information can be recorded at high density, and recorded information can be reproduced from the optical disk under stable conditions.

This non-provisional application claims priority under 35 U.S.C. § 119(a) on Patent Application No. 2004/180098 filed in Japan on Jun. 17, 2004, Patent Application No. 2004/197318 filed in Japan on Jul. 2, 2004, and Patent Application No. 2005/29822 filed in Japan on Feb. 4, 2005, the entire contents of which are hereby incorporated by reference.

### FIELD OF THE INVENTION

The present invention relates to an optical memory device in which a plurality of information units are formed corresponding to recorded information.

### BACKGROUND OF THE INVENTION

Conventionally, optical disks such as DVDs, CDs, etc., are arranged so as to record information by forming pits (phase pits) on the surface of the disk.

Known methods for recording information on optical disks include the technique for recording information on the single information unit using a plurality of pits as disclosed in Japanese Laid-Open Patent Publication 7-21568/1995 ((Tokukaihei 7-21568/1995), published on Jan. 24, 1995), hereinafter referred to as a “Patent Document 1”). This conventional recording method is explained in FIGS. 26(0) to 26(F).

As shown in FIGS. 26(O) to 2(F), each information unit 100 is recorded using pit(s) 101 in the number of zero to four.

Each pit 101 is located at an apex of the square T, a center of which is located on a recording track 102.

In this conventional recording method, the information (recorded content) of each information unit 100 is determined by a combination of the number and the position of the pits (pit array). In this recording method, sixteen kinds of information can be recorded as illustrated in FIGS. 26(O) to 26(F).

Here, a reproducing operation of the information unit 100 shown in FIGS. 26(O) to 26(F) will be explained. When reproducing, a reflected light from each pit of a light beam incident on the information unit 100 is received by a photodetector 103 having eight divided receiving faces D1 to D8 as shown in FIG. 27 obtained by dividing the receiving face into eight. Then, a pit array is identified based on the light receiving state of the divided light receiving faces D1 to D8, thereby reading out the recorded information.

According to the foregoing recording method, however, as the pits 101 are located at apexes of the square T in the information unit 100, the recordable information in the single information unit 100 is limited to sixteen kinds.

Furthermore, in the foregoing conventional recording method, since an eight-divided photodetector made up of eight divided light receiving faces is adopted for the receiving of the reflected light from the information unit 100, a large scale signal processing circuit of the complicated structure is required for processing signals from eight divided light receiving faces D1 to D8.

Problems therefore arise in that it is difficult to reduce the cost for the reproducing device, and the reproducing rate (the rate of transferring information) is liable to be lowered as a longer time is needed for processing signals.

### SUMMARY OF THE INVENTION

It is therefore an object of the present invention to provide an optical disk (optical memory device) on which information can be recorded at high density, and from which information can be reproduced under stable conditions without requiring a reproducing circuit of the complicated structure.

In order to achieve the foregoing object, the optical memory device (optical disk) of the present invention, in which a plurality of information units in which information are recorded according to the pit arrays, is characterized in that:

the pit array of each information unit is made up of a phase pit provided at the center of the information unit, and phase pits provided surrounding the phase pit at the center.

According to the optical memory device, the pit array of the information unit is made up of a phase pit provided at the center of the information unit and the phase pits surrounding the center of the information unit.

With the foregoing structure of the optical memory device of the present invention, as compared to the case wherein the pit array is made up of only the surrounding phase pits, the recording density can be significantly improved.

According to the optical memory device of the present invention, the phase pit is provided at the center of the surrounding phase pits. Therefore, the phase pits can be provided at high density, and the recording density can be still improved.

According to the optical memory device of the present invention, the number of divided light receiving faces (divided light receiving faces) required for reproducing information is set in the number of the surrounding phase pits.

According to the optical memory device of the present invention, the number of divided light receiving faces of the reproduction photodetector required for reproducing recorded information can be set in the number of the surrounding phase pits. Namely, according to the optical memory device of the present invention which adopts for the information unit, the phase pit array made up of phase pits in the number of n (n is an integer) including the pit array provided at the center, it is possible to reproduce the recorded information using the divide photodetector whose light receiving face is divided in the number of n-1.

As a result, the present invention provides the optical memory device which permits information to be recorded at high density and the recorded information to be reproduced without requiring the reproduction circuits of complicated structure.

In order to achieve the foregoing object, the optical reproducing device of the present invention wherein light is emitted onto the information unit of the optical memory device to reproduce the recorded information based on the reflected light, is arranged so as to include:

the reproduction photodetector which receives the reflected light from the information unit and outputs a light receiving signal according to the received amount of light; and

the pit array identification circuit which specifies the pit array of the information unit to be reproduced based on the light receiving signal from the reproduction photodetector.

The optical reproducing device of the present invention for reproducing recorded information from the optical memory device is arranged such that light is emitted onto the information unit of the optical memory device of the present invention, and the pit array of the information unit is identified based on the reflected light, thereby reproducing recorded information.

Namely, according to the optical reproducing device of the present invention, the reproduction photodetector receives reflected light from the information unit and outputs a light receiving signal according to the received amount of light. Then, based on the light receiving signal, the pit array identification circuit specifies the pit array of the information unit (the information unit irradiated with light) to be reproduced.

The optical reproducing device of the present invention may be arranged so as to include the control photodetector separately provided from the foregoing reproduction photodetector. This control photodetector receives the reflected light from the information unit and outputs to the optical control circuit, a light receiving signal according to the received amount of light.

The light control circuit controls the light to be emitted onto the optical memory device based on the light receiving signal from the control photodetector (controls the irradiation position or the focal position of light).

Generally, as the reflected light incident onto the control photodetector is subjected to focusing by the cylindrical lens, the wave front of the reflected light is disturbed. For this reason, in the case where the same photodetector is used both as the control photodetector and the photodetector, the reflected light with uneven wave front is incident on the reproduction photodetector. A problem therefore arises in that the intensity distribution of the light incident on the light receiving face is disturbed, and it is difficult to accurately identify the pit array of the information unit.

In response, according to the structure of the present invention by separately providing the reproduction photodetector and the control photodetector, the light intensity distribution on the reproduction photodetector is not disturbed. As a result, it is possible to accurately control the light, and in the meantime, the recorded information can be reproduced accurately.

It is preferable that the optical memory device (optical disk) of the present invention be provided with a pair of patterns arranged on both sides of the information track.

According to the foregoing structure of the optical memory device provided with the servo units, the tracking can be controlled by the sample servo method based on the reflected light from the servo unit. Therefore, by adopting the foregoing optical memory device, the tracking can be performed under stable condition, and the recorded information can be reproduced with high precision.

In order to achieve the foregoing object, another optical reproducing device of the present invention for reproducing recorded information from an optical memory device which includes a plurality of information units arranged along an information track, each of said plurality of information units having information recorded according to a pit array, wherein the pit array of each information unit in a recording region is made up of a combination of a central phase pit provided on the information track and surrounding phase pits surrounding said central phase pit, and a pair of servo units are formed on both sides of the information track, said optical reproducing device emitting lights onto said optical memory device and reproducing the recorded information based on reflected lights, is characterized by including:

a reproduction photodetector which receives the reflected light from the information unit, and outputs a light receiving signal according to the received amount of light; and

a pit array identification circuit for identifying the pit array of the information unit to be reproduced based on the light receiving signal outputted from said reproduction photodetector.

Namely, according to the optical reproducing device of the present invention, the reproduction photodetector receives reflected light from the information unit and outputs a light receiving signal according to the received amount of light. Then, based on the light receiving signal, the pit array identification circuit specifies the pit array of the information unit (the information unit irradiated with light) to be reproduced.

The optical reproducing device of the present invention may be arranged so as to include the control photodetector. This control photodetector receives the reflected light from the information unit and outputs to the optical control circuit, a light receiving signal according to the received amount of light.

The light control circuit controls the light to be emitted onto the optical memory device based on the light receiving signal from the control photodetector.

This control photodetector may be provided separately from the foregoing reproduction photodetector.

Generally, as the reflected light incident onto the control photodetector is subjected to focusing by the cylindrical lens, the wave front of the reflected light is disturbed. For this reason, in the case where the same photodetector is used both as the control photodetector and the photodetector, the reflected light with uneven wave front is incident on the reproduction photodetector.

A problem therefore arises in that the intensity distribution of the light incident on the light receiving face is disturbed, and it is difficult to accurately indentify the pit array of the information unit.

In response, according to the structure of the present invention by separately providing the reproduction photodetector and the control photodetector, the light intensity distribution on the reproduction photodetector is not disturbed. As a result, it is possible to accurately control the light, and in the meantime, the recorded information can be reproduced accurately.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an explanatory view showing the kind of the pit arrays (kinds of information) of each information unit formed on an optical disk in accordance with one embodiment of the present invention.

FIG. 2 is an explanatory view showing the structure of an optical disk device in accordance with one embodiment of the present invention.

FIG. 3 is a plan view of the optical disk.

FIG. 4 is a cross-sectional view of the optical disk shown in FIG. 3.

FIG. 5 is an explanatory view showing the information unit formed on the optical disk shown in FIG. 3.

FIG. 6 is an explanatory view showing the kind of the pit array (kind of information) of the information unit formed on the optical disk shown in FIG. 3.

FIG. 7 is an explanatory view showing the arrangement of phase pits in the information unit formed on the optical disk shown in FIG. 3.

FIG. 8 is an explanatory view showing the structure of the photoreceptor provided in the optical disk device shown in FIG. 2.

FIG. 9 is an explanatory view showing the kind of other pit arrays (other kind of information) in the information unit formed on the topical disk shown in FIG. 3.

FIG. 10 is an explanatory view showing another structure of the photodetector provide in the optical disk device shown in FIG. 2.

FIG. 11 is an explanatory view showing another structure of the photodetector provide in the optical disk device shown in FIG. 2.

FIG. 12 is an explanatory view showing other information units formed on the optical disk shown in FIG. 3.

FIG. 13 is an explanatory view showing the information unit and the synchronous unit formed on the optical disk shown in FIG. 3.

FIG. 14 is an explanatory view showing other structure of the optical disk device in accordance with one embodiment of the present invention.

FIG. 15 is an explanatory view showing the structure of a synchronous signal generation circuit provided in the optical disk device shown in FIG. 14.

FIG. 16 is a graph showing a sum of the light receiving signals (R1+R2+R3+R4; total light receiving signals) outputted from the photo detector when scanning the information track of the optical disk shown in FIG. 13 by a light beam, i.e., moving the light beam spot on the information track.

FIG. 17 is an explanatory view showing phase shifts of the light receiving signal as occurred when reproducing information unit of the optical disk.

FIG. 18 is an explanatory view showing the kinds of other pit arrays (other kind of information) in the information unit formed on the topical disk shown in FIG. 3.

FIG. 19 is an explanatory view showing another structure of the synchronous unit formed on the topical disk shown in FIG. 3.

FIG. 20 is an explanatory view showing still another structure of the synchronous unit formed on the topical disk shown in FIG. 3.

FIG. 21 is an explanatory view showing the structure of an information unit and a servo unit formed on the optical disk in accordance with another embodiment of the present invention.

FIG. 22 is a graph showing a sum of all the light receiving signals (total amount of signals) outputted from the control photo detector when scanning the information track of the optical disk shown in FIG. 3 by a light beam, i.e., moving the light beam spot on the information track.

FIG. 23 is an explanatory view showing the kind of other pit arrays (other kind of information) in the information unit formed on the topical disk shown in FIG. 3.

FIG. 24 is an explanatory view shown another structure of the servo unit, formed on the optical disk shown in FIG. 3.

FIG. 25 is an explanatory view showing still another structure of the servo unit, formed on the optical disk shown in FIG. 3.

FIG. 26 is an explanatory view showing pit arrays of information units formed on a conventional optical disk.

FIG. 27 is an explanatory view showing the structure of a photodetector provided in a conventional optical disk device.

### DESCRIPTION OF THE EMBODIMENTS

### First Embodiment

The following will explain one embodiment of the present invention.

An optical disk device (disk device; optical reproducing device) in accordance with the present embodiment is a reproducing device for reproducing information recorded on an optical disk.

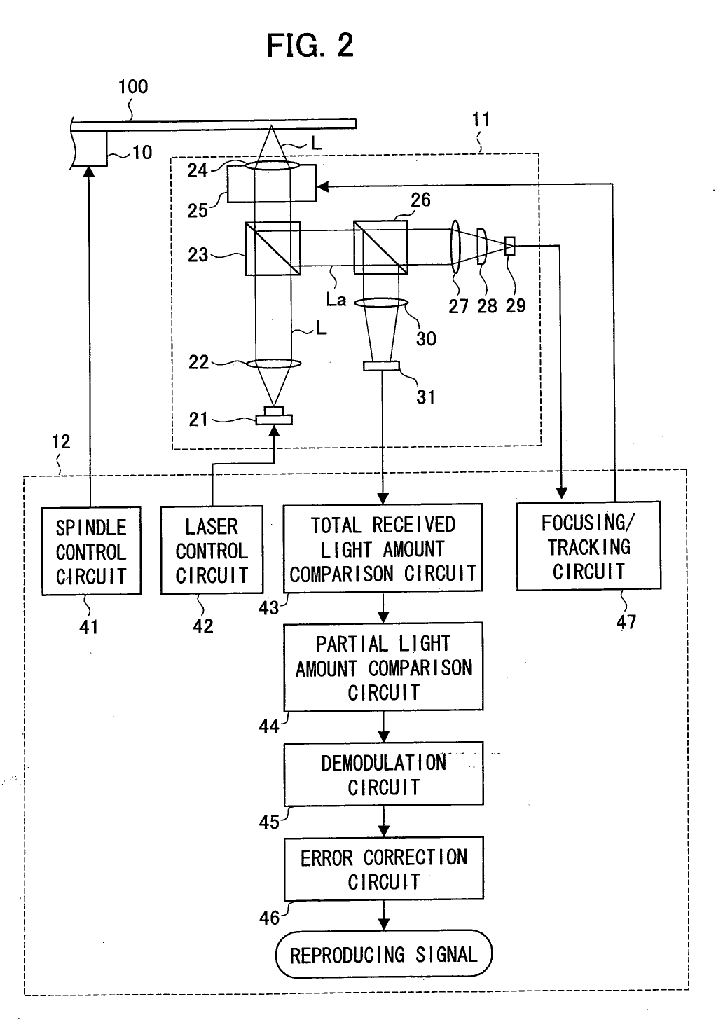

FIG. 2 is an explanatory view illustrating the structure of a disk device in accordance with the present embodiment. As illustrated in FIG. 2, the disk device of the present embodiment includes a spindle 10, an optical pickup 11, and a circuit substrate 12.

The spindle 10 rotates the optical disk 1, from which information are to be reproduced, in a fixed state.

The structure of the optical disk 1 will be explained in detail later.

The optical pickup 1 1 emits a laser light (light beam) L onto the rotating optical disk 1 while moving in the radius direction of the optical disk 1. The disk device of the present invention reproduces information recorded on the optical disk 1 by emitting the laser light L. The circuit substrate 12 includes a group of a plurality of circuits for driving the spindle 10 and the optical pickup 11.

As illustrated in FIG. 2, the optical pickup 11 includes a semiconductor laser light source 21, a collimator lens 22, a beam splitter 23, a condenser lens 24, an actuator 25, a beam splitter 26, a condenser lens 27, a cylindrical lens 28, a control photodetector 29, a condenser lens 30, and a photodetector (reproduction photodetector) 31.

The semiconductor laser light source 21 is a light source which produces a laser light L. The collimator lens 22 shapes the flux of the laser light L emitted from the semiconductor laser light source 21 into parallel light.

The beam splitter 23 allows the laser light L to pass through the collimator lens 22 and reflects the laser light L incident from the side of the optical disk 1 (condenser lens 24) and bends the optical path of the reflected laser light L at a right angle.

The condenser lens 24 condenses the laser light L as passed through the beam splitter 23 to be converged onto the recording surface of the optical disk 1. The condenser lens 24 also converges the reflected laser light La from the optical disk 1.

The actuator 25 adjusts the position of the condenser lens 24 (drives the condenser lens 24) for the focusing control and the tracking control.

The reflected laser light La from the optical disk 1 is returned to the optical path of the light when incident on the optical disk 1, and is reflected from the beam splitter 23 and is then guided to the beam splitter 26.

Some of the reflected laser light La incident on the beam splitter 26 pass therethrough, and some are reflected to the side of the condenser lens 30.

The condenser lens 27 and the cylindrical lens 28 are provided for condensing the laser light La as passed through the beam splitter 26 onto the control photodetector 29.

The control photodetector 29 outputs a light receiving signal for use in the focusing control and the tracking control based on the reflected laser light La.

The condenser lens 30 is provided for condensing the reflected laser light La from the beam splitter 26 onto the photodetector 31.

The photodetector 31 receives the reflected laser light La and generates an electrical signal (light receiving signal).

The structure of this photodetector 31 will be explained later.

As illustrated in FIG. 2, the circuit substrate 12 includes a spindle control circuit 41, a laser control circuit 42, the total received light amount comparison circuit 43, a partial light amount comparison circuit 44, a demodulation circuit 45, an error correction circuit 46, and a focusing/tracking circuit 47.

The spindle control circuit 41 drives the optical disk 1 fixed to the spindle 10 to rotate together with the spindle 10.

The laser control circuit 42 is provided for controlling (driving) the semiconductor laser light source 21 to emit laser light L.

The focusing/tracking circuit 47 generates a focusing signal by the astigmatism method and a tracking signal by the push-pull method, based on a light receiving signal generated by the control photodetector 29. The focusing/tracking circuit 47 then drives the actuator 25 based on the resulting focusing signal and the tracking signal to perform the focusing control and the tracking control.

By the group of the foregoing circuits 43 to 46, a reproducing signal is generated based on the light receiving signal as outputted from the photodetector 31.

These circuits 43 to 46 will be explained in detail later.

The disk device of the present embodiment is provided with a control section (not shown) for controlling overall operations of the disk device by controlling the circuits on the circuit substrate 12.

The structure of the optical disk 1 will be explained here.

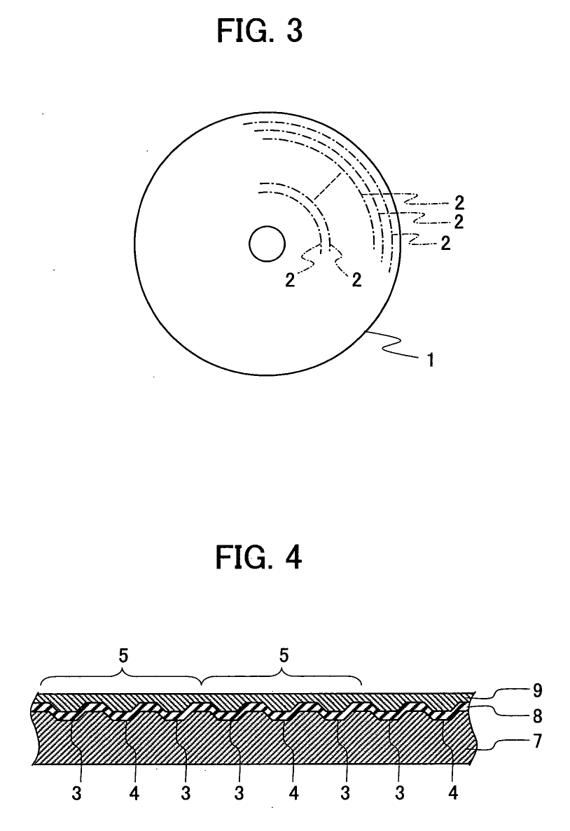

FIG. 3 is a plan view illustrating the structure of the optical disk (optical memory device) 1. The optical disk 1 has a diameter of 120 mm, and as illustrated in FIG. 3, and on this optical disk 1, spiral information tracks 2 for recording information are formed on the recording surface (surface) thereof.

FIG. 4 is a cross-sectional view of the optical disk 1.

As illustrated in FIG. 4, the optical disk 1 includes a transparent substrate 7 whereon the metal reflective film 8 and the protective film 9 are laminated in this order.

The transparent substrate 7 is made of a transparent material such as polycarbonate resin.

The metal reflective film 8 is formed over the transparent substrate 7. This metal reflective film 8 is made of, for example, aluminum.

The protective film 9 is formed over the metal reflective film 8.

On the surface of the transparent substrate 7 on the side of the metal reflective film 8, formed are convex-shaped phase pits 3 and 4. The phase pits 3 and 4 constitute the information unit 5 as a unit of the recorded information (recorded information unit). These phase pits 3 and 4 are formed long the information tracks 2.

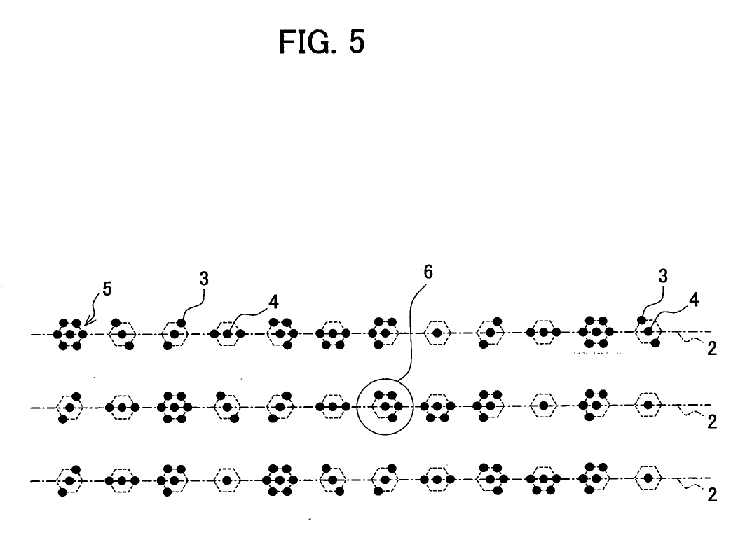

FIG. 5 is an explanatory view illustrating the detailed structure of the information track 2. As illustrated in FIG. 2, in the information tracks 2, a plurality of information units 5 (units of recorded information) are arranged in the direction of the information tracks 2.

The information unit 5 is made up of phase pits 3 in the number of six at the maximum, and the phase pit 4 in the number of one at the maximum, which are arranged regularly (at regular intervals) in the information track 2. The phase pits 3 are located at respective apexes of the equilateral hexagon the center of which is on the information track 2 (the respective phase pits 3 are provided at the same distance from the center of the equilateral hexagon). This equilateral hexagon is arranged such that one of the diagonal lines is overlapped with the information track 2. The phase pit 4 is located at the center of the equilateral hexagon.

In the optical disk 1, the information (recorded content) of the information unit 5 are defined by a combination of the number and the position of the phase pits 3 and. 4 (arrangement of the phase pits; pit array).

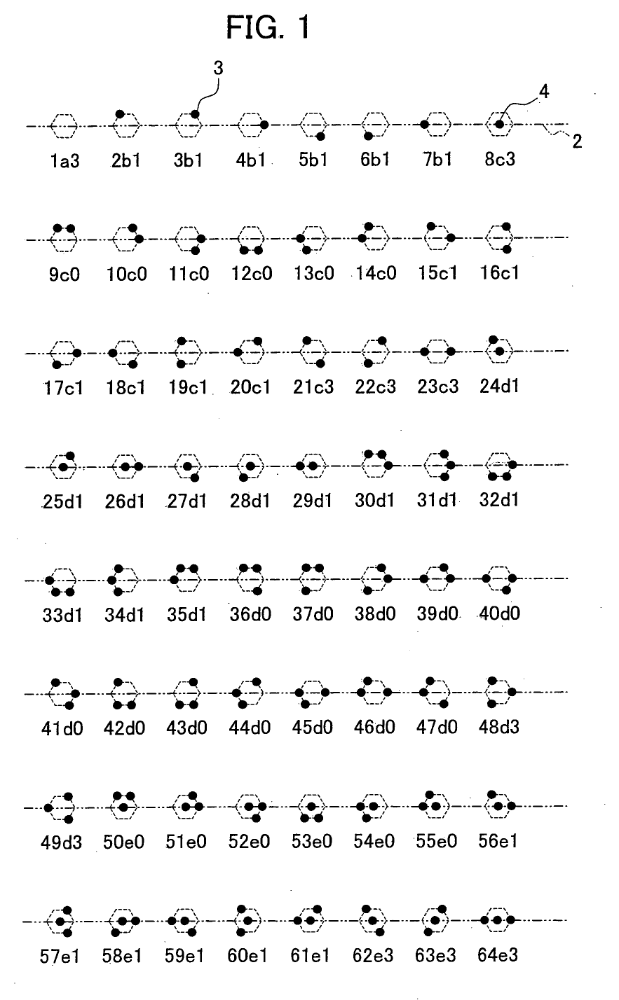

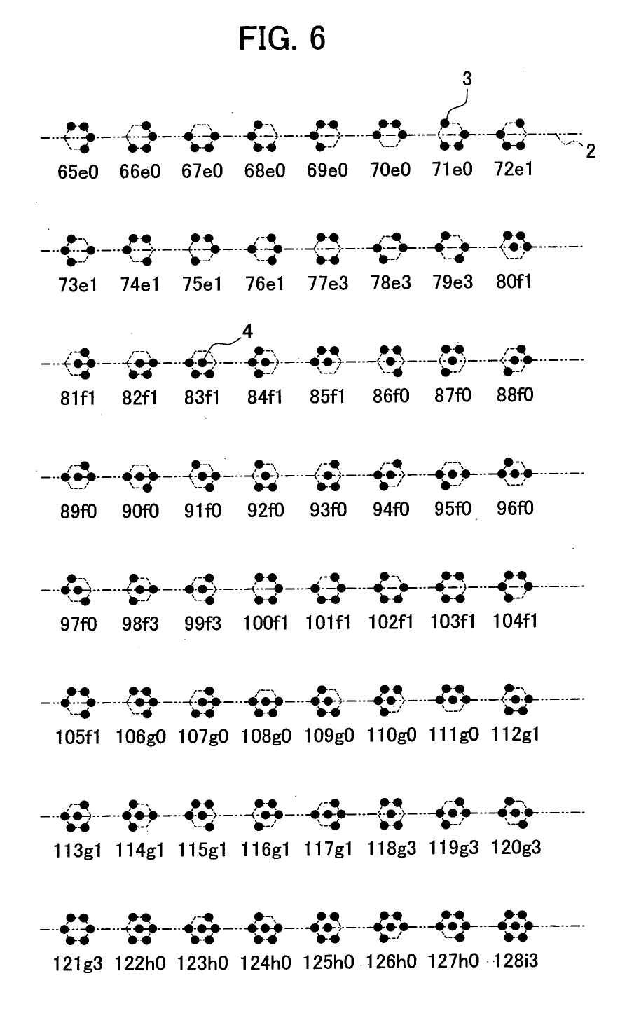

The FIG. 1 and FIG. 6 are explanatory views which show respective structures of pit arrays (kinds of information) in the information unit 5. As illustrated in these FIG. 1 and FIG. 6, the information unit 5 of the optical disk 1 is designed to have 128 kinds of information as expressed by the pit arrays 1a3 to 128i3.

Namely, the information units 5 are designed to have 128 kinds of information according to the pit arrays 1a3 to 128i3.

The pit array 1a3 is a pit array without a phase pit.

The pit arrays 2b1 to 8c3 are pit arrays made up of one phase pit.

The pit arrays 9c0 to 29d1 are pit arrays, each being made up of two phase pits.

The pit arrays 30d1 to 64e3 are pit arrays each being made up of three phase pits.

The pit arrays 65e0 to 99f3 are pit arrays, each being made up of four phase pits.

The pit arrays 100f1 to 120g3 are pit arrays, each being made up of five phase pits.

The pit array 121g3 to 127h0 are pit arrays, each being made up of six phase pits.

Lastly, the pit array 128i3 is a pit array made up of seven phase pits.

Here, the reference numerals of these pit arrays 1a3 to 128i3 are defined by a combination of a serial number, a light amount identification factor and a symmetry identification factor. Namely, the serial numbers are from 1 to 128 respectively assigned to all the 32 kinds of the pit arrays.

Each amount of light identification factor corresponds to a total amount of reflected laser light La (total amounts of reflected light) of the light incident on the photodetector 31 (to be described later) and reflected from the information unit 5 made up of a pit array.

Namely, when reproducing from the disk device of the present invention, the control section controls the spindle control circuit 41 to rotate the optical disk 1. This control section also controls the laser control circuit 42 to emit laser light L from the condenser lens 24 onto the optical disk 1, and to scan beam spots 6 along the information tracks 2 of the optical disk 1 as illustrated in FIG. 5. In this operation, the laser light L is emitted so that the center of the beam spot 6 is on the center of the information unit 5.

As a result, the laser light L is reflected from the information unit 5 formed along the information track 2 to be a reflected laser light La.

This amount of reflected laser light La differs for each pit array of the information unit 5.

Namely, the light amount identification factors are respectively indicative of amounts of reflected laser light La corresponding to the respective pit arrays of the information unit 5. In the optical disk 1, respective total reflected light amounts from the pit arrays are classified into the light amount identification factors a to i of nine kinds.

Incidentally, the respective pit arrays having the same light amount identification factors a to i have substantially the same total reflected light amounts. Here, “a” indicates the largest total reflected light amount, and respective total reflected light amounts indicated by a to i are smaller in this order.

Here, the relationship between the respective number and the locations of the phase pits 3 and 4 and the total reflected light amounts will be explained.

As compared to the reflected amount of light from the pit array without phase pits 3 and 4, the reflected amount of light from the pit array with the phase pits 3 and 4 is smaller.

The intensity distribution of the beam spot 6 of the laser light L shows the Gaussian distribution. Therefore, for the beam spot 6, the light intensity of its center is higher than that in the circumferential region. Furthermore, as explained earlier, the laser light L is emitted such that the center of the beam spot 6 is on the center of the information unit 5.

Therefore, generally, the amount of reflected light of the central phase pit 4 is smaller than the amount of reflected light of the surrounding phase pits 3 at apexes.

For any of the pit arrays 2b1 to 7b1, a single phase pit is located in the circumference of the beam spot 6, and respective total reflected light amounts for these pit arrays 2b1 to 7b1 are all equal. For the pit array 8c3, a single phase pit 4 is located at position corresponding to the center of the beam spot 6, and total reflected light amount from the pit array 8c3 is smaller than those obtained from the pit arrays 2b1 to 7b1.

Next, for the pit arrays 9c0 to 23c3 made up of two phase pits 3, with an increase in the number of the phase pits, the total reflected light amounts from these arrays 9c0 to 23c3 are the same as that obtained from the pit array 8c3.

For the pit arrays 24d1 to 29d1, each being made up of one phase pit 4 and one phase pit 3, the total reflected light amounts are smaller than those obtained from the pit arrays 9c0 to 23c3. Similarly, for the rest of the pit arrays, with an increase in the number of the phase pits, the total reflected light amount decreases.

The symmetry identification factors 0, 1 and 3 of the pit array are defined as follows.

The hexagon formed by the phase pits 3 have six sides, and each of these six sides has an opposed side (Hereinafter, a pair of opposite sides is referred to as an opposite side pair).

Each of these symmetry identification factors indicates the number of such opposed side pairs (symmetry opposed side pairs) that the respective numbers of phase pits 3 assigned to each side are equal.

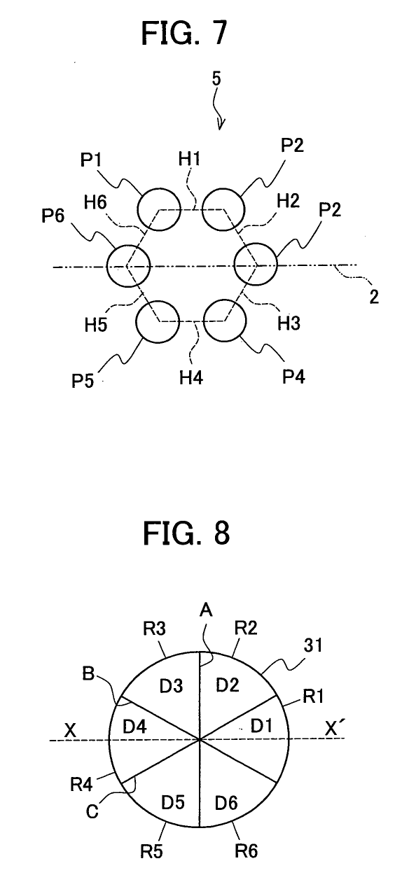

For example, the pit array 31d1 shown in FIG. 1 has three phase pits 3 at three positions Pt to P4 among the apexes P1 to P6 shown in FIG. 7. Specifically, for the pit array 31d1, one phase pit 3 is assigned to the side H1, two phase pits 3 are assigned to each of the side H2 and the side H3, one phase pit 3 is assigned to the side H4, and no phase pits 3 are assigned to the side H5 and the side H6.

For this pit array 31d1, among three side pairs H1 and H4, H2 and H5, and H3 and H6, only the side pair of H1 and H4 is the symmetry opposite side pair. Therefore, the symmetry identification factor of this pit array 31d1 is one “1”.

Next, the structure of the photodetector 31 will be explained.

FIG. 8 is an explanatory view illustrating the structure of the photodetector 31. As illustrated in FIG. 8, the photodetector 31 is made up of six divided light receiving faces (photo-detecting elements) D1 to D6.

The divided light receiving faces D1 to D6 are obtained by dividing the circular light receiving face of the photodetector 31 by the three parting lines A to C, and these divided light receiving faces D1 to D6 are in the shape of a fan that radically expands from the center of the light receiving face of the photodetector 31.

Here, the respective parting lines A to C are provided so as to pass the center of the light receiving face, and divide the light receiving face equally into six, i.e., 60° for each divided light receiving face. Therefore, respective divided light receiving faces D1 to D6 have the same area and the shape.

These divided light receiving faces D1 to D6 respectively output voltage signals (the light receiving signal) R1 to R6 indicative of voltage values respectively corresponding to the received reflected light amounts. For the photodetector 31, one of the parting lines A to C (the parting line A in FIG. 8) which divide the light receiving face into six divided light receiving faces D1 to D6 is provided so as to cross at right angle the straight line X-X′ corresponding to the information track 2 on the optical disk 1 (the straight line corresponding to the information track on the light receiving face of the photodetector 31).

Other two parting lines (the parting lines B and C in Figures B and C) are provided so as to form an angle of 30° with the straight line X-X′.

Here, the relationship between each of the phase pits 3 and 4 and the divided light receiving faces D1 to D6 will be explained.

A reflected light from each phase pit is diffracted, and is then incident on the divided light receiving faces D1 to D6. For a pit array made up of a plurality of phase pits, the diffracted light from respective phase pits interfere each other and is then incident on the divided light receiving faces D1 to D6. Namely, the reflected light from each phase pit is not incident on only one of the divided light receiving faces D1 to D6 but incident on the entire surface of the divided light receiving faces D1 to D6.

On the other hand, for a pit array made up of a single phase pit 3, the reflected from the phase pit 3 incident on any one of the divided light receiving faces D1 to D6 corresponding to that phase pit 3 has a relatively high intensity (the further is the incident position of the reflected light beam from the position corresponding to that phase pit 3, the lower is the intensity).

For example, for the pit array 2b1, the intensity of the reflected light incident on the divided light receiving face D3 is relatively high, and the intensity of the reflected light incident on the divided light receiving face D6 is relatively low.

Incidentally, the reflected light from the phase pit 4 at the center of the hexagon is evenly incident around the center of all the divided light receiving faces D1 to D6.

Therefore, for the pit array 8c3 made up of only one phase pit 4, the intensity of the reflected light incident in the vicinity of the centers of all the divided light receiving faces D1 to D6 is relatively high, and the intensity of the reflected light incident on the circumferential region is relatively low.

Next, the circuits 43 to 46 in the circuit substrate 12 shown in FIG. 2 will be explained.

These circuits 43 to 46 are provided for identifying respective pit arrays of the information unit 5 to be reproduced based on the light receiving signals outputted from the photodetector 31, and generate reproducing signals according to the identification results.

The total received light amount comparison circuit 43 adds all the light receiving signals R1 to R6 outputted from the divided light receiving faces D1 to D6 of the photodetector 31 to obtain the total reflected light amount. The total received light amount comparison circuit 43 then derives the light amount identification factors a to i for the pit array of the information unit 5 to be reproduced from the resulting the total reflected light amount.

Here, there is no other pit array which has the same amount of total reflected light as these pit arrays 1a3 and 128i3. Therefore, in the case where the information unit 5 to be reproduced is the foregoing pit arrays 1a3 and 128i3, it is possible to identify these pit arrays only by means of the total received light amount comparison circuit 43.

The partial light amount comparison circuit 44 identifies the pit array of the information unit 5 to be reproduced based on the light amount identification factors a to i derived by the total received light amount comparison circuit 43.

In the following Tables 1 to 3, the conditions for identification in the partial light amount comparison circuit 44 are shown.

TABLE 1

| | LIGHT AMOUNT | IDENTI- | IDENTI- | IDENTI- | IDENTI- | | |
|---|---|---|---|---|---|---|---|
| PIT | IDENTIFICATION | FICATION | FICATION | FICATION | FICATION | IDENTIFICATION | DEMODULATION |
| ARRAY | FACTOR | CONDITION I | CONDITION II | CONDITION III | CONDITION IV | CONDITION V | SIGNAL |
| 1a3 | a | — | — | — | — | — | 0000000 |
| 2b1 | b | Y1 > Y4 | X2 < X5 | — | — | — | 0000001 |
| 3b1 | | | X2 > X5 | — | — | — | 0000010 |
| 5b1 | | Y1 < Y4 | X2 > X5 | — | — | — | 0000011 |
| 6b1 | | | X2 < X5 | — | — | — | 0000100 |
| 4b1 | | Y1 = Y4 | X2 > X5 | — | — | — | 0000101 |
| 7b1 | | | X2 < X5 | — | — | — | 0000110 |
| 10c0 | c | Y1 > Y4 | X2 > X5 | Z1 < Z2 | — | — | 0000111 |
| 15c1 | | | | Z1 > Z2 | — | — | 0001000 |
| 14c0 | | | X2 < X5 | Z1 > Z2 | — | — | 0001001 |
| 20c1 | | | | Z1 < Z2 | — | — | 0001010 |
| 9c0 | | | X2 = X5 | — | — | — | 0001011 |
| 11c0 | | Y1 < Y4 | X2 > X5 | Z1 > Z2 | — | — | 0001100 |
| 17c1 | | | | Z1 < Z2 | — | — | 0001101 |
| 13c0 | | | X2 < X5 | Z1 < Z2 | — | — | 0000110 |
| 18c1 | | | | Z1 > Z2 | — | — | 0001111 |
| 12c0 | | | X2 = X5 | — | — | — | 0010000 |
| 16c1 | | Y1 = Y4 | X2 > X5 | — | — | — | 0010001 |
| 19c1 | | | X2 < X5 | — | — | — | 0010010 |
| 21c3 | | | X2 = X5 | Z1 > Z2 | — | — | 0010011 |
| 22c3 | | | | Z1 < Z2 | — | — | 0010100 |
| 23c3 | | | | Z1 = Z2 | Z2 < Z3 | — | 0010101 |
| 8c3 | | | | | Z2 = Z3 | — | 0010110 |
| 36d0 | d | Y1 > Y4 | X2 > X5 | Z1 > Z3 | — | — | 0010111 |
| 39d0 | | | | Z1 < Z3 | — | — | 0011000 |
| 25d1 | | | | Z1 = Z3 | X1 − X4 < S1 | — | 0011001 |
| 30d1 | | | | | X1 − X4 > S1 | — | 0011010 |
| 37d0 | | | X2 < X5 | Z2 > Z3 | — | — | 0011011 |
| 46d0 | | | | Z2 < Z3 | — | — | 0011100 |
| 24d1 | | | | Z2 = Z3 | X6 − X3 < S1 | — | 0011101 |
| 35d1 | | | | | X6 − X3 > S1 | — | 0011110 |
| 43d0 | | Y1 < Y4 | X2 > X5 | Z2 > Z3 | — | — | 0011111 |
| 40d0 | | | | Z2 < Z3 | — | — | 0100000 |
| 27d1 | | | | Z2 = Z3 | X3 − X6 < S1 | — | 0100001 |
| 32d1 | | | | | X3 − X6 > S1 | — | 0100010 |
| 42d0 | | | X2 < X5 | Z1 > Z3 | — | — | 0100011 |
| 45d0 | | | | Z1 < Z3 | — | — | 0100100 |
| 28d1 | | | | Z1 = Z3 | X4 − X1 < S1 | — | 0100101 |
| 33d1 | | | | | X4 − X1 > S1 | — | 0100110 |
| 41d0 | | Y1 = Y4 | X2 > X5 | Z1 > Z2 | — | — | 0100111 |
| 33d0 | | | | Z1 < Z2 | — | — | 0101000 |
| 25d1 | | | | Z1 = Z2 | Y2 > Y5 | X2 − X5 < S1 | 0101001 |
| 31d1 | | | | | | X2 − X5 > S1 | 0101010 |
| 49d3 | | | | | Y2 = Y5 | — | 0101011 |
| 47d0 | | | X2 < X5 | Z1 > Z2 | — | — | 0101100 |
| 44d0 | | | | Z1 < Z2 | — | — | 0101101 |
| 29d1 | | | | Z1 = Z2 | Y2 < Y5 | X5 − X2 < S1 | 0101110 |
| 34d1 | | | | | | X5 − X2 > S1 | 0101111 |
| 48d3 | | | | | Y2 = Y5 | — | 0110000 |

TABLE 2

| | LIGHT AMOUNT | IDENTI- | IDENTI- | IDENTI- | IDENTI- | | |
|---|---|---|---|---|---|---|---|
| PIT | IDENTIFICATION | FICATION | FICATION | FICATION | FICATION | IDENTIFICATION | DEMODULATION |
| ARRAY | FACTOR | CONDITION I | CONDITION II | CONDITION III | CONDITION IV | CONDITION V | SIGNAL |
| 51e0 | e | Y1 > Y4 | X2 > X5 | Y2 − Y5 < S2 | — | — | 0110001 |
| 65e0 | | | | Y2 − Y5 > S2 | — | — | 0110010 |
| 55e0 | | | X2 < X5 | Y6 − Y3 < S2 | — | — | 0110011 |
| 69e0 | | | | Y6 − Y3 > S2 | — | — | 0110100 |
| 56e1 | | | X2 = X5 | Z1 > Z2 | Y2 > Y5 | — | 0110101 |
| 74e1 | | | | | Y2 = Y5 | — | 0110110 |
| 61e1 | | | | Z1 < Z2 | Y3 < Y6 | — | 0110111 |
| 75e1 | | | | | Y3 = Y6 | — | 0111000 |
| 50e0 | | | | Z1 = Z2 | Y1 − Y4 < S2 | — | 0111001 |
| 70e0 | | | | | Y1 − Y4 > S2 | — | 0111010 |
| 52e0 | | Y1 < Y4 | X2 > X5 | Y3 − Y6 < S2 | — | — | 0111011 |
| 66e0 | | | | Y3 − Y6 > S2 | — | — | 0111100 |
| 54e0 | | | X2 < X5 | Y5 − Y2 < S2 | — | — | 0111101 |
| 66e0 | | | | Y5 − Y2 > S2 | — | — | 0111110 |
| 59e1 | | | X2 = X5 | Z1 > Z2 | Y2 < Y5 | — | 0111111 |
| 71e1 | | | | | Y2 = Y5 | — | 1000000 |
| 58e0 | | | | Z1 < Z2 | Y3 > Y6 | — | 1000001 |
| 72e1 | | | | | Y3 = Y6 | — | 1000010 |
| 53e1 | | | | Z1 = Z2 | Y4 − Y1 < S2 | — | 1000011 |
| 67e0 | | | | | Y4 − Y1 > S2 | — | 1000100 |
| 57e1 | | Y1 = Y4 | X2 > X5 | X2 − X5 > S3 | — | — | 1000101 |
| 76e1 | | | | X2 − X5 < S3 | — | — | 1000110 |
| 60e1 | | | X2 < X5 | X5 − X2 > S3 | — | — | 1000111 |
| 73e1 | | | | X5 − X2 < S3 | | — | 1001000 |
| 62e3 | | | X2 = X5 | Z1 > Z2 | Z1 > Z3 | — | 1001001 |
| 79e3 | | | | | Z1 = Z3 | — | 1001010 |
| 63e3 | | | | Z1 < Z2 | Z1 = Z3 | — | 1001011 |
| 78e3 | | | | | Z1 < Z3 | — | 1001100 |
| 64e3 | | | | Z1 = Z2 | Z1 < Z3 | — | 1001101 |
| 77e3 | | | | | Z1 > Z3 | — | 1001110 |
| 86f0 | f | Y1 > Y4 | X2 > X5 | Z1 > Z3 | — | — | 1001111 |
| 89f0 | | | | Z1 < Z3 | — | — | 1010000 |
| 80f1 | | | | Z1 = Z3 | X1 − X4 > S4 | — | 1010001 |
| 105f1 | | | | | X1 − X4 < S4 | — | 1010010 |
| 87f0 | | | X2 < X5 | Z2 > Z3 | — | — | 1010011 |
| 96f0 | | | | Z2 < Z3 | — | — | 1010100 |
| 85f1 | | | | Z2 = Z3 | X6 − X3 > S4 | — | 1010101 |
| 104f1 | | | | | X6 − X3 < S4 | — | 1010110 |
| 90f0 | | Y1 < Y4 | X2 > X5 | Z2 < Z3 | — | — | 1010111 |
| 93f0 | | | | Z2 > Z3 | — | — | 1011000 |
| 82f1 | | | | Z2 = Z3 | X3 − X6 > S4 | — | 1011001 |
| 101f1 | | | | | X3 − X6 < S4 | — | 1011010 |
| 92f0 | | | X2 < X5 | Z1 > Z3 | — | — | 1011011 |
| 95f0 | | | | Z1 < Z3 | — | — | 1011100 |
| 83f1 | | | | Z1 = Z3 | X4 − X1 > S4 | — | 1011101 |
| 102f1 | | | | | X4 − X1 < S4 | — | 1011110 |
| 88f0 | | Y1 > Y4 | X2 > X5 | Z1 < Z2 | — | — | 1011111 |
| 91f0 | | | | Z1 < Z2 | — | — | 1100000 |
| 81f1 | | | | Z1 = Z2 | Y2 > Y5 | X2 − X5 > S4 | 1100001 |
| 100f1 | | | | | | X2 − X5 < S4 | 1100010 |
| 99f3 | | | | | Y2 = Y5 | — | 1100011 |
| 94f0 | | | X2 < X5 | Z1 < Z2 | — | — | 1100100 |
| 97f0 | | | | Z1 > Z2 | — | — | 1100101 |
| 84f1 | | | | Z1 = Z2 | Y2 < Y5 | X5 − X2 > S4 | 1100110 |
| 103f1 | | | | | | X5 − X2 < S4 | 1100111 |
| 98f3 | | | | | Y2 = Y5 | — | 1101000 |

TABLE 3

| | LIGHT AMOUNT | IDENTI- | IDENTI- | IDENTI- | IDENTI- | | |
|---|---|---|---|---|---|---|---|
| PIT | IDENTIFICATION | FICATION | FICATION | FICATION | FICATION | IDENTIFICATION | DEMODULATION |
| ARRAY | FACTOR | CONDITION I | CONDITION II | CONDITION III | CONDITION IV | CONDITION V | SIGNAL |
| 106g0 | g | Y1 > Y4 | X2 > X5 | — | — | — | 1101001 |
| 110g0 | | | X2 < X5 | — | — | — | 1101010 |
| 111g0 | | | X2 = X5 | Z1 = Z2 | — | — | 1101011 |
| 115g1 | | | | Z1 > Z2 | — | — | 1101100 |
| 116g1 | | | | Z1 < Z2 | — | — | 1101101 |
| 107g0 | | Y1 < Y4 | X2 > X5 | — | — | — | 1101110 |
| 109g0 | | | X2 < X5 | — | — | — | 1101111 |
| 108g0 | | | X2 = X5 | Z1 = Z2 | — | — | 1110000 |
| 112g1 | | | | Z1 > Z2 | — | — | 1110001 |
| 113g1 | | | | Z1 < Z2 | — | — | 1110010 |
| 114g1 | | Y1 = Y4 | X2 < X5 | — | — | — | 1110011 |
| 117g1 | | | X2 > X5 | — | — | — | 1110100 |
| 119g3 | | | X2 = X5 | Z1 < Z2 | — | — | 1110101 |
| 120g3 | | | | Z1 > Z2 | — | — | 1110110 |
| 118g3 | | | | Z1 = Z2 | Z2 > Z3 | — | 1110111 |
| 121g3 | | | | | Z2 = Z3 | — | 1111000 |
| 126h1 | h | Y1 > Y4 | X2 < X5 | — | — | — | 1111001 |
| 127h1 | | | X2 > X5 | — | — | — | 1111010 |
| 123h1 | | Y1 < Y4 | X2 > X5 | — | — | — | 1111011 |
| 124h1 | | | X2 < X5 | — | — | — | 1111100 |
| 122h1 | | Y1 = Y4 | X2 > X5 | — | — | — | 1111101 |
| 125h1 | | | X2 < X5 | — | — | — | 1111110 |
| 128i3 | i | — | — | — | — | — | 1111111 |

The reference numerals X1 to X6, Y1 to Y6, and Z1 to Z3 in these Tables respectively indicate the results of adding the light receiving signals R1 to R6 from the divided light receiving faces D1 to D6.

The following Table 4 shows the relationship between the light receiving signals R1 to R6, and the result of each addition.

TABLE 4

| | LIGHT RECEIVING SIGNAL |
|---|---|
| RESULT OF ADDITION | TO BE ADDED |
| X1 | R1 + R2 + R3 |
| X2 | R2 + R3 + R4 |
| X3 | R3 + R4 + R5 |
| X4 | R4 + R5 + R6 |
| X5 | R5 + R6 + R1 |
| X6 | R6 + R1 + R2 |
| Y1 | R1 + R2 |
| Y2 | R2 + R3 |
| Y3 | R3 + R4 |
| Y4 | R4 + R5 |
| Y5 | R5 + R6 |
| Y6 | R6 + R1 |
| Z1 | R1 + R4 |
| Z2 | R2 + R5 |
| Z3 | R3 + R6 |

As shown in Table 4, the partial light amount comparison circuit 44 compares the respective intensities of the results of adding a plurality of light receiving signals R1 to R6, according to light amount identification factors a to i. The partial light amount comparison circuit 44 then identifies the pit array of the information unit 5 based on the intensity comparison result.

The partial light amount comparison circuit 44 first compares Y1 with Y4 under the identification condition I.

Specifically, based on the intensity comparison result, the partial light amount comparison circuit 44 identifies the axisymmetry of the pit array of the information unit 5 about the axis of the information track 2 (the axisymmetry (line symmetry) in the radial direction; whether it is axisymmetric (line symmetric) about the information track 2).

Next, the partial light amount comparison circuit 44 compares X1 with X5 under the identification condition II.

Specifically, based on the intensity comparison result, the partial light amount comparison circuit 44 identifies the axisymmetry of the pit array of the information unit 5 in the circumferential direction (the axisymmetry about a straight line which passes through the center of the information unit 5, and is orthogonal to the information track 2).

By the foregoing operations, the identification of the pit arrays with the light amount identification factors b and h according to the total reflected light amounts is completed.

Next, the partial light amount comparison circuit 44 compares the respective intensities of Z1 to Z3 under the identification condition III. The specific targets to be compared are determined according to the kinds of the light amount identification factors and the results of identification under the identification conditions I and II. For example, for the pit arrays with the light amount identification factors of c and g, the partial light amount comparison circuit 44 compares Z1 with Z2. If Z1<Z2, or Z1>Z2, the identification of these pit arrays is completed for the pit arrays with the light amount identification factors c and g.

On the other hand, if Z1=Z2, the pit array to be reproduced cannot be identified, but any one of 23c3, 8c3, 118g3, and 121g3. In this case, the partial light amount comparison circuit 44 compares the intensities of Z2 and Z3 under the identification condition IV. With the foregoing operation, the identification of all the pit arrays with the light amount identification factors c and g is completed.

For the pit arrays with the light amount identification factors d, e and f, the partial light amount comparison circuit 44 compares the intensities of Z1 with Z2, Z2 with Z3, and Z1 with Z3 under the results of identification under the identification conditions I and II.

For example, for the pit array with the light amount identification factor d, if the conditions of Y1>Y4, and X2>X5 are satisfied, the partial light amount comparison circuit 44 compares Z1 with Z3.

Subsequently, the partial light amount comparison circuit 44 compares the intensities under the identification conditions IV and V as shown in the Tables 1 to 3.

For example, for the pit array with the light amount identification factor d, if the conditions of Y1>Y4, X2>X5, and the Z1=Z3 are satisfied, the partial light amount comparison circuit 44 identifies the pit array by comparing X1 and X4 with the reference value S1 (identification condition IV).

The foregoing reference value S1 is used because it is not possible to identify 25d1 and 30d1 only from the symmetric characteristic of the phase pits.

Here, the reference value (reference signal) S1 indicates a fixed value assigned to the disk device beforehand.

As described, the partial light amount comparison circuit 44 can identify all the pit arrays of 128 kinds by comparing the respective intensities of the light receiving signals R1 to R6 based on the light amount identification factors.

The demodulation circuit 45 then generates the demodulation signal (demodulation data) based on the result of identification of the pit array by the partial light amount comparison circuit 44.

In the foregoing Tables 1 to 3, a demodulation signal according to each pit array is shown.

As shown in FIG. 1, the disk device of the present embodiment adopts 128 kinds of the pit arrays for the information unit 5. It is therefore possible to record 128 kinds of information for each information unit 5. Therefore, a 7-bit demodulation signal can be obtained from one information unit 5.

The error correcting circuit 46 performs an error correction with respect to the demodulation signal generated by the demodulation circuit 45, and generate reproducing signal.

The disk device of the present embodiment then converts the reproducing signal into a video signal (video data) or a voice signal (voice data) by a converter circuit (not shown). Then, these signals are displayed on a display device (not shown) such as a display screen, a speaker, etc.

As described, the optical disk 1 of the present embodiment adopts the pit arrays of the information unit 5, which are made up of combinations of seven phase pits (six phase pits 3 located in the circumferential region and one phase pit 4 on the information track 2).

In this example, the phase pits 3 are located at apexes of the hexagon one of the diagonal lines that pass through the center of the hexagon of which is overlapped with the information track 2.

The phase pit 4 is located at a center of the hexagon.

As described, the optical disk 1 of the present embodiment adopts the pit array of the information unit 5 made up of a combination of six phase pits 3 and one phase pit 4 at the center.

With the foregoing structure, the optical disk 1 of the present embodiment permits information (7-bit data) of 128 (27) kinds to be multiplex-recorded for each information unit 5. Therefore, as compared to the arrangement adopting the pit array made up of a combination of only six phase pits 3, the recording density can be significantly raised.

According to the foregoing structure of the optical disk 1 wherein the phase pits 3 and the phase pit 4 are located at the apexes of the hexagon and the center of the hexagon, it is also possible to provide the phase pits at high density (closest packing). As a result, a larger number of information units 5 can be formed on the optical disk 1, thereby realizing a still higher recording density of the optical disk 1. Furthermore, the beam spot 6 for use in reproduction can be made significantly smaller.

According to the optical disk 1 of the present embodiment, the number of partitions for the light receiving face of the photodetector 31 required for reproduction (number of divided light receiving faces) can be set to six.

Namely, for the pit array of the information unit 5 made up of only six phase pits 3, the intensity distribution of the reflected light from the information unit 5 corresponds to the shape of hexagon (the hexagon is formed when the pixel array is made up of six phase pits). Therefore, the photodetector 31 to be adopted for reproducing information is divided into six corresponding to six phase pits 3. Namely, the six-divided photodetector made up of six divided light receiving faces D1 to D6 is adopted.

The photodetector 31 determines with or without the phase pit 3 for the six phase pits 3 in the information unit 5 (the location(s) of the phase pit(s) 3) according to the intensity of the reflected lights from the six divided light receiving faces D1 to D6. The photodetector 31 then identifies the pit array to be reproduced based on the determination result.

For the pit array of the optical disk 1 with one phase pit 4 at the center of six phase pits 3, the six divided photo detector 31 made up of six divided light receiving faces D1 to D6 may be adopted.

Namely, the reflected lights from the phase pit 4 have an intensity distribution according to the distance from the center of the photodetector 31 (the lights incident at positions apart from the center of the photodetector by the same distance have the same intensity). Therefore, the reflected lights having the same intensity distribution are incident respectively on the six divided light receiving faces D1 to D6 in the photodetector 31.

Therefore, when reproducing information from the optical disk 1 using the six-divided photodetector 31, it is possible to determine if the phase pit 4 is provided, based on the total received light amount by the entire light receiving faces (the intensity of the total reflected light amount from the entire information unit 5 (pit array)).

For the phase pit 3, it can be determined if the phase pit 3 is provided at each position based on the intensity of the light incident on each of the six divided light receiving faces D1 to D6 as described earlier.

As described, according to the optical disk 1, although the information unit 5 made up of seven phase pits 3 and 4 is adopted, it is possible to reproduce information using the six-divided photodetector 31. With this structure, the optical disk 1 permits the information to be recorded at high density, and the recorded information to be reproduced without using reproducing circuits of the complicated structure.

In the case of adopting the pit array made up of seven phase pits located at apexes of the heptagon, the intensity distribution of the reflected light from the information unit 5 corresponds to the shape of the heptagon (the shape of the heptagon is formed when the pixel array is made up of seven phase pits). Therefore, it is necessary to provide the divided light receiving faces corresponding to these seven phase pits, and to determine if each phase pit is provided based on the intensity of the light incident on each of the seven divided light receiving faces.

With this structure, it is therefore required to divide the light receiving face of the photodetector into seven (the number of divided light receiving faces is seven). Therefore, the circuit for processing the intensity of the light incident on each of these seven divided light receiving faces becomes complicated, which results in an increase in cost. In particular, the partial light amount comparison circuit 44 for determining the symmetric characteristic becomes complicated in structure.

Incidentally, when selecting adopting the photo-receptor 31 whose light receiving face is divided into seven, an angle formed between the adjacent light receiving faces becomes smaller, and a reproducing error is therefore more liable to occur due to a lower precision in determining the position of each phase pit.

In the disk device of the present embodiment, in order to identify the pit array of the information unit 5 to be reproduced according to the reflected laser light La, the total received light amount comparison circuit 43 and the partial light amount comparison circuit 44 are provided.

Then, the total received light amount comparison circuit 43 specifies the total reflected light amount and roughly classifies the pit arrays of the information unit 5 into groups according to the light amount identification factors.

Then, according to the total reflected light amount as specified, the partial light amount comparison circuit 44 compares (partially compares) the intensity of the light incident on each of the divided light receiving faces D1 to D6 and identifies the pit array of the information unit 5.

As described, according to the foregoing structure of the present embodiment, before carrying out the partial comparison by the partial light amount comparison circuit, the pit arrays are roughly classified into groups by the total right amount comparison circuit.

It is therefore possible to reduce the kinds and the number of partial comparisons to be performed for the identification of the pit array by the partial light amount comparison circuit.

In the disk device of the present embodiment, for the photodetector 31, one of the parting lines A to C which divide the light receiving face into divided light receiving faces D1 to D6 is provided so as to cross the straight line X-X′ corresponding to the information track 2 on the optical disk 1.

Here, the photodetector 31 may be arranged such that one of these parting lines A to C is overlapped with (parallel to) the straight line X-X′ corresponding to the information track 2. With this structure, it is also possible to identify the pit array of the information unit 5 by carrying out the similar process.

In this case, however, as the parting lines are formed at positions wherein the intensity of the light beam is maximized (positions corresponding to respective phase pits), a problem arises in that the precision in detecting the intensity distribution of the light reflected from the divided light receiving faces D1 to D6 is lowered.

Therefore, in order to improve the detection precision, it is preferable that the parting lines A to C be formed so as to cross the information track 2 of the optical disk 1 at right angle.

With this structure, it is possible to provide respective centers of the divided light receiving faces D1 to D6 at the corresponding phase pits (at position where the intensity of the reflected light from each phase pit 3 is maximized). Therefore, it is possible to allocate these four divided light receiving faces D1 to D6 to the phase pits 3 with one to one correspondence. It is therefore possible to determine respective phase pits 3 of six kinds with accuracy by the four divided light receiving faces D1 to D6.

As described, it is effective to provide these parting lines A to C so as to cross the straight line X-X′ at right angle as one of the diagonal lines that pass through the center of the hexagon made up of six phase pits 3 is overlapped with the information track 2.

Namely, the foregoing effect can be achieved by arranging the parting lines A to C so as to cross the straight line on the light receiving face at right angle according to the diagonal lines of this hexagon. As long as the diagonal line and one of the parting lines A to C cross at right angle, even if one of the parting lines A to C does not cross the straight line X-X′ at right angel, the same effect can be ensured.

Incidentally, according to the disk device of the present embodiment wherein one of the diagonal lines of the hexagon is overlapped with the information track 2, the pit array of the information unit 5 which is axisymmetric (line symmetry) about the information track 2 can be formed with ease.

According to the disk device of the present embodiment, the respective parting lines A to C are provided so as to divide the light receiving face equally into six, i.e., 60° for each divided light receiving face. In this structure, respective divided light receiving faces D1 to D6 have the same area, and it is therefore possible to compare respective intensities of the light receiving signals R1 to R6 by the partial light amount comparison circuit 44 with ease.

In the disk device of the present, embodiment, the control photodetector 29 is provided separately from the photodetector 31 in view of the following problem. That is, as the reflected light incident onto the control photodetector 29 is subjected to focusing by the cylindrical lens 28, the wave front of the reflected light is therefore disturbed. For this reason, in the case where the same photodetector is used both as the control photodetector 29 and the photodetector 31, the reflected light with uneven wave front is incident on the photodetector 31. Thus, a problem arises in that the intensity distribution of the light incident on these divided light receiving faces D1 to D6 is disturbed, and it is difficult to accurately identify the pit array of the information unit 5.

In response, the disk device of the present embodiment is arranged so as to form these photodetectors separately so as to avoid the foregoing problem of the reflected light with an uneven wave front being incident on the photodetector 31. With the foregoing structure of the disk device of the present invention, it is possible to reproduce recorded information accurately while accurately controlling the intensity.

Incidentally, in the present embodiment, 128 kinds of pit arrays are adopted for the information unit 5 formed on the optical disk 1 as shown in FIGS. 1 and 6.

However, the number of the kinds of the pit arrays is not limited to 128, and the smaller number of kinds of the pit arrays may be adopted.

For example, for the information unit 5 of the optical disk 1, only those having the light amount identification factors b, d, f and h may be formed.

In this case, the pit arrays are of 64 kinds, and 6-bit data is multiplex recorded in the single information unit 5.

The identification of these pit arrays is performed under the conditions shown in the foregoing Tables 1 to 3. The following table 5 shows only the identification conditions on the light amount identification factors b, d, f, and h as extracted from Tables 1 to 3.

TABLE 5

| | LIGHT AMOUNT | IDENTI- | IDENTI- | IDENTI- | IDENTI- | | |
|---|---|---|---|---|---|---|---|
| PIT | IDENTIFICATION | FICATION | FICATION | FICATION | FICATION | IDENTIFICATION | DEMODULATION |
| ARRAY | FACTOR | CONDITION I | CONDITION II | CONDITION III | CONDITION IV | CONDITION V | SIGNAL |
| 2b1 | b | Y1 > Y4 | X2 < X5 | — | — | — | 000000 |
| 3b1 | | | X2 > X5 | — | — | — | 000001 |
| 5b1 | | Y1 < Y4 | X2 > X5 | — | — | — | 000010 |
| 6b1 | | | X2 < X5 | — | — | — | 000011 |
| 4b1 | | Y1 = Y4 | X2 > X5 | — | — | — | 000100 |
| 7b1 | | | X2 < X5 | — | — | — | 000101 |
| 36d0 | d | Y1 > Y4 | X2 > X5 | Z1 > Z3 | — | — | 000110 |
| 39d0 | | | | Z1 < Z3 | — | — | 000111 |
| 25d1 | | | | Z1 = Z3 | X1 − X4 < S1 | — | 001000 |
| 30d1 | | | | | X1 − X4 > S1 | — | 001001 |
| 37d0 | | | X2 < X5 | Z2 > Z3 | — | — | 001010 |
| 46d0 | | | | Z2 < Z3 | — | — | 001011 |
| 24d1 | | | | Z2 = Z3 | X6 − X3 < S1 | — | 001100 |
| 35d1 | | | | | X6 − X3 > S1 | — | 001101 |
| 43d0 | | Y1 < Y4 | X2 > X5 | Z2 > Z3 | — | — | 001110 |
| 40d0 | | | | Z2 < Z3 | — | — | 001111 |
| 27d1 | | | | Z2 = Z3 | X3 − X6 < S1 | — | 001000 |
| 32d1 | | | | | X3 − X6 > S1 | — | 010001 |
| 42d0 | | | X2 < X5 | Z1 > Z3 | — | — | 010010 |
| 45d0 | | | | Z1 < Z3 | — | — | 010011 |
| 28d1 | | | | Z1 = Z3 | X4 − X1 < S1 | — | 010100 |
| 33d1 | | | | | X4 − X1 > S1 | — | 010101 |
| 41d0 | | Y1 = Y4 | X2 > X5 | Z1 > Z2 | — | — | 010110 |
| 38d0 | | | | Z1 < Z2 | — | — | 010111 |
| 28d1 | | | | Z1 = Z2 | Y2 > Y5 | X2 − X5 < S1 | 011000 |
| 31d1 | | | | | | X2 − X5 > S1 | 011001 |
| 49d3 | | | | | Y2 = Y5 | — | 011010 |
| 47d0 | | | X2 < X5 | Z1 > Z2 | — | — | 011011 |
| 44d0 | | | | Z1 < Z2 | — | — | 011100 |
| 29d1 | | | | Z1 = Z2 | Y2 < Y5 | X5 − X2 < S1 | 011101 |
| 34d1 | | | | | | X5 − X2 > S1 | 011110 |
| 48d3 | | | | | Y2 = Y5 | — | 011111 |
| 86f0 | f | Y1 > Y4 | X2 > X5 | Z1 > Z3 | — | — | 100000 |
| 89f0 | | | | Z1 < Z3 | — | — | 100001 |
| 80f1 | | | | Z1 = Z3 | X1 − X4 > S4 | — | 100010 |
| 105f1 | | | | | X1 − X4 < S4 | — | 100011 |
| 87f0 | | | X2 < X5 | Z2 > Z3 | — | — | 100100 |
| 96f0 | | | | Z2 < Z3 | — | — | 100101 |
| 85f1 | | | | Z2 = Z3 | X6 − X3 > S4 | — | 100110 |
| 104f1 | | | | | X6 − X3 < S4 | — | 100111 |
| 90f0 | | Y1 < Y4 | X2 > X5 | Z2 < Z3 | — | — | 101000 |
| 83f0 | | | | Z2 > Z3 | — | — | 101001 |
| 82f1 | | | | Z2 = Z3 | X3 − X6 > S4 | — | 101010 |
| 101f1 | | | | | X3 − X6 < S4 | — | 101011 |
| 82f0 | | | X2 < X5 | Z1 > Z3 | — | — | 101100 |
| 95f0 | | | | Z1 < Z3 | — | — | 101101 |
| 85f1 | | | | Z1 = Z3 | X4 − X1 > S4 | — | 101110 |
| 102f1 | | | | | X4 − X1 < S4 | — | 101111 |
| 88f0 | | Y1 > Y4 | X2 > X5 | Z1 < Z2 | — | — | 110000 |
| 91f0 | | | | Z1 < Z2 | — | — | 110001 |
| 81f0 | | | | Z1 = Z2 | Y2 > Y5 | X2 − X5 > S4 | 110010 |
| 100f1 | | | | | | X2 − X5 < S4 | 110011 |
| 99f3 | | | | | Y2 = Y5 | — | 110100 |
| 94f0 | | | X2 < X5 | Z1 < Z2 | — | — | 110101 |
| 97f0 | | | | Z1 > Z2 | — | — | 110110 |
| 84f1 | | | | Z1 = Z2 | Y2 < Y5 | X5 − X2 > S4 | 110111 |
| 103f1 | | | | | | X5 − X2 < S4 | 111100 |
| 98f3 | | | | | Y2 = Y5 | — | 111001 |
| 126h1 | h | Y1 > Y4 | X2 < X5 | — | — | — | 111010 |
| 127h1 | | | X2 > X5 | — | — | — | 111011 |
| 123h1 | | Y1 < Y4 | X2 > X5 | — | — | — | 111100 |
| 124h1 | | | X2 < X5 | — | — | — | 111101 |
| 122h1 | | Y1 = Y4 | X2 > X5 | — | — | — | 111110 |
| 125h1 | | | X2 < X5 | — | — | — | 111111 |

The pit arrays shown in this Table 5 are all made up of the phase pits 3 in the odd number. For such pit arrays 5, differences in total reflected light amounts from the information unit 5 can be made larger.

Namely, in the case of adopting all the pit arrays shown in FIG. 1 and FIG. 6, the total reflected light amounts to be identified are of nine kinds. On the other hand, in the case of adopting only the pit arrays with the light amount identification factors b, d, f and h, the total reflected light amounts to be identified are of four kinds. Furthermore, as there exist no pit arrays with the light amount identification factors a, c, e and g to be provided in between (pit arrays made up of even number of phase pits 3), differences in total reflected light amounts are increased.

According to the foregoing structure, it is therefore possible to accurately identify the total reflected light amount by the total received light amount comparison circuit 43 with ease. It is therefore possible to simplify the structure of the total received light amount comparison circuit 43, and the cost for the disk device of the present embodiment can be reduced.

Similarly, it may be arranged so as to form only the pit arrays with the light amount identification factors a, c, e, g and i (pit arrays made up of even number of phase pits (including the pit array without phase pit) for the information unit 5 of the optical disk 1.

In this case also, the pit arrays are of 64 kinds, and 6-bit data is multiplex recorded in the single information unit 5.

The identification of these pit arrays is performed under the conditions shown in the foregoing Tables 1 to 3. The following Table 6 shows only the identification conditions on the light amount identification factors a, c, e, g and i as extracted from Tables 1 to 3.

TABLE 6

| | LIGHT AMOUNT | | IDENTI- | | | |
|---|---|---|---|---|---|---|
| PIT | IDENTIFICATION | IDENTIFICATION | FICATION | IDENTIFICATION | IDENTIFICATION | DEMODULATION |
| ARRAY | FACTOR | CONDITION I | CONDITION II | CONDITION III | CONDITION IV | SIGNAL |
| 1a3 | a | — | — | — | — | 000000 |
| 10c0 | c | Y1 > Y4 | X2 > X5 | Z1 < Z2 | — | 000001 |
| 15c1 | | | | Z1 > Z2 | — | 000010 |
| 14c0 | | | X2 < X5 | Z1 > Z2 | — | 000011 |
| 20c1 | | | | Z1 < Z2 | — | 000100 |
| 8c0 | | | X2 = X5 | — | — | 000101 |
| 11c0 | | Y1 < Y4 | X2 > X5 | Z1 > Z2 | — | 000110 |
| 17c1 | | | | Z1 < Z2 | — | 000111 |
| 18c0 | | | X2 < X5 | Z1 < Z2 | — | 001000 |
| 18c1 | | | | Z1 > Z2 | — | 001001 |
| 12c0 | | | X2 = X5 | — | — | 001010 |
| 18c1 | | Y1 = Y4 | X2 > X5 | — | — | 001011 |
| 19c1 | | | X2 < X5 | — | — | 001100 |
| 21c3 | | | X2 = X5 | Z1 > Z2 | — | 001101 |
| 22c3 | | | | Z1 < Z2 | — | 001110 |
| 23c3 | | | | Z1 = Z2 | Z2 < Z3 | 001111 |
| 8c3 | | | | | Z2 = Z3 | 001000 |
| 51e0 | e | Y1 > Y4 | X2 > X5 | Y2 − Y5 < S2 | — | 010001 |
| 65e0 | | | | Y2 − Y5 > S2 | — | 010010 |
| 55e0 | | | X2 < X5 | Y6 − Y3 < S2 | — | 010011 |
| 69e0 | | | | Y6 − Y3 > S2 | — | 010100 |
| 56e1 | | | X2 = X5 | Z1 > Z2 | Y2 > Y5 | 010101 |
| 74e1 | | | | | Y2 = Y5 | 010110 |
| 61e1 | | | | Z1 < Z2 | Y3 < Y6 | 010111 |
| 75e1 | | | | | Y3 = Y6 | 011000 |
| 50e0 | | | | Z1 = Z2 | Y1 − Y4 < S2 | 011001 |
| 70e0 | | | | | Y1 − Y4 > S2 | 011010 |
| 52e0 | | Y1 < Y4 | X2 > X5 | Y3 − Y6 < S2 | — | 011011 |
| 66e0 | | | | Y3 − Y6 > S2 | — | 011100 |
| 54e0 | | | X2 < X5 | Y5 − Y2 < S2 | — | 011101 |
| 68e0 | | | | Y5 − Y2 > S2 | — | 011110 |
| 59e1 | | | X2 = X5 | Z1 > Z2 | Y2 < Y5 | 011111 |
| 71e1 | | | | | Y2 = Y5 | 100000 |
| 58e1 | | | | Z1 < Z2 | Y3 > Y6 | 100001 |
| 72e1 | | | | | Y3 = Y6 | 100010 |
| 53e0 | | | | Z1 = Z2 | Y4 − Y1 < S2 | 100011 |
| 67e0 | | | | | Y4 − Y1 > S2 | 100100 |
| 57e1 | | Y1 = Y4 | X2 > X5 | X2 − X5 > S3 | — | 100101 |
| 76e1 | | | | X2 − X5 < S3 | — | 100110 |
| 60e1 | | | X2 < X5 | X5 − X2 > S3 | — | 100111 |
| 73e1 | | | | X5 − X2 < S3 | | 101000 |
| 62e3 | | | X2 = X5 | Z1 > Z2 | Z1 > Z3 | 101001 |
| 79e3 | | | | | Z1 = Z3 | 101010 |
| 63e3 | | | | Z1 < Z2 | Z1 = Z3 | 101011 |
| 78e3 | | | | | Z1 < Z3 | 101100 |
| 64e3 | | | | Z1 = Z2 | Z1 < Z3 | 101101 |
| 77e3 | | | | | Z1 > Z3 | 101110 |
| 105g0 | g | Y1 > Y4 | X2 > X5 | — | — | 101111 |
| 110g0 | | | X2 < X5 | — | — | 110000 |
| 111g0 | | | X2 = X5 | Z1 = Z2 | — | 110001 |
| 115g1 | | | | Z1 > Z2 | — | 110010 |
| 116g0 | | | | Z1 < Z2 | — | 110011 |
| 107g0 | | Y1 < Y4 | X2 > X5 | — | — | 110100 |
| 109g0 | | | X2 < X5 | — | — | 110101 |
| 108g1 | | | X2 = X5 | Z1 = Z2 | — | 110110 |
| 112g1 | | | | Z1 > Z2 | — | 110111 |
| 113g1 | | | | Z1 < Z2 | — | 111000 |
| 114g1 | | Y1 = Y4 | X2 < X5 | — | — | 111001 |
| 117g1 | | | X2 > X5 | — | — | 111010 |
| 119g3 | | | X2 = X5 | Z1 < Z2 | — | 111011 |
| 120g3 | | | | Z1 > Z2 | — | 111100 |
| 118g3 | | | | Z1 = Z2 | Z2 > Z3 | 111101 |
| 121g3 | | | | | Z2 = Z3 | 111110 |
| 128g3 | i | — | — | — | — | 111111 |

For the information unit 5 of the optical disk 1, it may be arranged so as to form only the pit arrays shown in Table 7.

In this case also, 64 kinds of pit arrays are available, and 6-bit data can be multiplex recorded on one information unit 5.

TABLE 7

| | LIGHT AMOUNT | | | | |
|---|---|---|---|---|---|
| PIT | IDENTIFICATION | IDENTIFICATION | IDENTIFICATION | IDENTIFICATION | IDENTIFICATION |
| ARRAY | FACTOR | CONDITION I | CONDITION II | CONDITION III | CONDITION IV |
| 1a3 | a | — | — | — | — |
| 2b0 | b | Y1 > Y4 | Y3 < Y6 | — | — |
| 3b0 | | | Y3 = Y6 | — | — |
| 5b0 | | Y1 < Y4 | Y3 > Y6 | — | — |
| 6b0 | | | Y3 = Y6 | — | — |
| 4b0 | | Y1 = Y4 | Y3 > Y6 | — | — |
| 7b0 | | | Y3 < Y6 | — | — |
| 15c0 | c | Y1 > Y4 | Y3 = Y6 | — | — |
| 20c0 | | | Y3 < Y6 | — | — |
| 17c0 | | Y1 < Y4 | Y3 > Y6 | — | — |
| 18c0 | | | Y3 = Y6 | — | — |
| 16c0 | | Y1 = Y4 | Y3 > Y6 | — | — |
| 19c0 | | | Y3 < Y6 | — | — |
| 21c3 | | | Y3 = Y6 | Z1 > Z2 | — |
| 22c3 | | | | Z1 < Z2 | — |
| 23c3 | | | | Z1 = Z2 | Z2 < Z3 |
| 9c3 | | | | | Z2 = Z3 |
| 24d1 | d | Y1 > Y4 | Y3 < Y6 | — | — |
| 25d1 | | | Y3 = Y6 | — | — |
| 27d1 | | Y1 < Y4 | Y3 > Y6 | — | — |
| 28d1 | | | Y3 = Y6 | — | — |
| 26d1 | | Y1 = Y4 | Y3 > Y6 | — | — |
| 29d1 | | | Y3 < Y6 | — | — |
| 48d3 | | | Y3 = Y6 | X2 < X5 | — |
| 49d3 | | | | X2 > X5 | — |
| 56e1 | e | Y1 > Y4 | Y3 = Y6 | — | |
| 61e1 | | | Y3 > Y6 | — | |
| 58e1 | | Y1 < Y4 | Y3 > Y6 | — | |
| 59e1 | | | Y3 = Y6 | — | |
| 57e1 | | Y1 = Y4 | Y3 > Y6 | — | |
| 60e1 | | | Y3 < Y6 | — | |
| 62e3 | | | Y3 = Y6 | Z1 > Z2 | Z2 = Z3 |
| 79e3 | | | | | Z2 < Z3 |
| 63e3 | | | | Z1 < Z2 | Z2 > Z3 |
| 78e3 | | | | | Z2 = Z3 |
| 64e3 | | | | Z1 = Z2 | Z2 < Z3 |
| 77e3 | | | | | Z2 > Z3 |
| 80f1 | f | Y1 > Y4 | Y3 = Y6 | — | — |
| 85f1 | | | Y3 < Y6 | — | — |
| 82f1 | | Y1 < Y4 | Y3 > Y6 | — | — |
| 83f1 | | | Y3 = Y6 | — | — |
| 61f1 | | Y1 = Y4 | Y3 > Y6 | — | — |
| 64f1 | | | Y3 < Y6 | — | — |
| 98f3 | | | Y3 = Y6 | X2 < X5 | — |
| 99f3 | | | | X2 > X5 | — |
| 111g1 | g | Y1 > Y4 | Y3 < Y6 | Z1 = Z2 | — |
| 115g0 | | | | Z1 > Z2 | — |
| 116g0 | | | Y3 = Y6 | — | — |
| 109g1 | | Y1 < Y4 | Y3 > Y6 | Z1 = Z2 | — |
| 112g0 | | | | Z1 > Z2 | — |
| 113g0 | | | Y3 = Y6 | — | — |
| 114g0 | | Y1 = Y4 | Y3 < Y6 | — | — |
| 117g0 | | | Y3 > Y6 | — | — |
| 119g3 | | | Y3 = Y6 | Z1 < Z2 | — |
| 120g3 | | | | Z1 > Z2 | — |
| 118g3 | | | | Z1 = Z2 | Z2 > Z3 |
| 121g3 | | | | | Z2 = Z3 |
| 126h0 | h | Y1 > Y4 | Y3 < Y6 | — | — |
| 127h0 | | | Y3 = Y6 | — | — |
| 123h0 | | Y1 < Y4 | Y3 > Y6 | — | — |
| 124h0 | | | Y3 = Y6 | — | — |
| 122h0 | | Y1 = Y4 | Y3 > Y6 | — | — |
| 125h0 | | | Y3 < Y6 | — | — |
| 128i3 | i | — | — | — | — |

Each of these pit arrays are made up of phase pits 3 arranged symmetrically about one of the diagonal lines which divide the hexagon of the information unit 5 into halves.

Some pit arrays like the pit arrays 111g1 and 108g1 having the foregoing symmetric characteristic are not shown in Table 7 as a result of selecting the pit arrays of 64 kinds which are relatively easy to be identified.

Here, some of the pixel arrays shown in FIGS. 1 and 6 cannot be identified only by comparing the respective intensities of the light receiving signals R1 to R6 but can be identified by using the reference value S1 in addition to the foregoing intensity comparison. Specifically, for the pit array 26d1 and 31d1, it is possible to identify by comparing the respective intensities of X2 and X3 with the reference value S1 (Table 1).

This is because these pit arrays (the arrangements of the pits) are similar in structure, and cannot be identified by the symmetric characteristic of the pit arrays.

In this case, the difference value (X2-X3) is compared with the fixed reference signal S1, and it is therefore necessary to control the intensity of the laser light L with high precision to reproduce information without error. As a result, a circuit of a complicated structure (high precision circuit) is required for the laser control circuit 42 for controlling the semiconductor laser light source 21.

In contrast, for any of the pit arrays shown in Table 7, the reference value S1 is not needed for identification. Namely, all the pit arrays can be identified by comparing the respective intensities of the light receiving signals R1 to R6.

According to the foregoing structure, it is possible to accurately identify the pit arrays even if the intensity of the laser light L slightly fluctuates. It is therefore possible to simplify the structure of the laser control circuit 42, and the cost for the disk device of the present embodiment can be reduced.

For the information unit 5 of the optical disk 1, it may be arranged so as to form only the pit arrays shown in Table 8.

In this case also, 32 kinds of pit arrays are available, and 5-bit data can be multiplex recorded on one information unit 5.

TABLE 8

| | LIGHT AMOUNT | | | | |
|---|---|---|---|---|---|
| PIT | IDENTIFICATION | IDENTIFICATION | IDENTIFICATION | IDENTIFICATION | DEMODULATION |
| ARRAY | FACTOR | CONDITION I | CONDITION II | CONDITION III | SIGNAL |
| 1a3 | a | — | — | — | 00000 |
| 4b0 | b | X2 > X5 | — | — | 00001 |
| 7b0 | | X2 < X5 | — | — | 00010 |
| 8c3 | c | X2 = X5 | Z2 = Z3 | — | 00011 |
| 23c3 | | | Z2 < Z3 | — | 00100 |
| 16c0 | | X2 > X5 | — | — | 00101 |
| 19c0 | | X2 < X5 | — | — | 00110 |
| 26d1 | d | X2 > X5 | Y2 > Y5 | X2 − X5 < S1 | 00111 |
| 31d1 | | | | X2 − X5 > S1 | 01000 |
| 49d3 | | | Y2 = Y5 | — | 01001 |
| 29d1 | | X2 < X5 | Y2 < Y5 | X5 − X2 < S1 | 01010 |
| 34d1 | | | | X5 − X2 > S1 | 01011 |
| 48d3 | | | Y2 = Y5 | — | 01100 |
| 57e1 | e | X2 > X5 | X2 − X5 > S3 | — | 01101 |
| 76e1 | | | X2 − X5 < S3 | — | 01110 |
| 60e1 | | X2 < X5 | X5 − X2 > S3 | — | 01111 |
| 73e1 | | | X5 − X2 < S3 | — | 10000 |
| 64e3 | | X2 = X5 | Z3 > Z1 | — | 10001 |
| 77e3 | | | Z3 < Z1 | — | 10010 |
| 81f1 | f | X2 > X5 | Y2 > Y5 | X2 − X5 > S4 | 10011 |
| 100f1 | | | | X2 − X5 < S4 | 10100 |
| 99f3 | | | Y2 = Y5 | | 10101 |
| 64f1 | | X2 < X5 | Y2 < Y5 | X5 − X2 > S4 | 10110 |
| 103f1 | | | | X5 − X2 < S4 | 10111 |
| 98f1 | | | Y2 = Y5 | — | 11000 |
| 114g0 | g | X2 < X5 | — | — | 11001 |
| 117g0 | | X2 > X5 | — | — | 11010 |
| 118g3 | | X2 = X5 | Z2 > Z3 | — | 11011 |
| 121g3 | | | Z2 = Z3 | — | 11100 |
| 122h0 | h | X2 > X5 | — | — | 11101 |
| 125h0 | | X2 < X5 | — | — | 11110 |
| 128i3 | i | — | — | — | 11111 |

For these pit arrays, phase pits 3 are symmetrically arranged about the information track 2 (symmetry in the radial direction).

As described, according to the disk device of the present embodiment, the control photodetector 29 generates a focusing signal by the astigmatic method and generates a tracking signal by the push-pull method base on the reflected laser light La from the information unit 5.

For the pit arrays which are not symmetrical in the radius direction, as a push-pull signal is disturbed, a problem may arise in that the beam spot 6 of the laser light L cannot be scanned on the central axis of the information track 2 (tracking becomes unstable), which in turn causes a problem that the total reflected light amount from each information unit 5 cannot be measured with accuracy, resulting in an increase in reproduction error.

On the other hand, in the case of adopting only the pit arrays of 32 kinds shown in Table 8, as all the pit arrays are symmetrical in a radius direction, it is possible to surely prevent the foregoing disturbance in push-pull signals. As a result, tracking can be performed under stable conditions.

In the present embodiment, the respective parting lines A to C are provided so as to divide the light receiving face equally into six, i.e., 60° for each divided light receiving face. However, the present invention is not intended to limit the foregoing structure, and each angle formed by the adjacent parting lines of the photodetector 31 may be deviated from 60°. In this case, however, as respective divided light receiving faces D1 to D6 have different areas (sizes), it is preferable to change the intensity comparison process of the light receiving signals R1 to R6 by the partial light amount comparison circuit 44.

In the present embodiment, the light receiving face of the photodetector 31 is divided into six; however, the present invention is not indented to limit the number of the partitions of the light receiving face of the photodetector 31 to six. For example, the light receiving face of the photodetector 31 may be divided into twelve (the number of partitions can be increased to double), and the twelve-divided detector may be adopted. Here, it is possible to identify the information unit 5 based on the light receiving signals from the twelve divided light receiving faces of the twelve-divided photodetector 31. However, it is more preferable to adopt the six-divided photodetector as the calculation process for the identification of the information unit 5 can be simplified. This also permits the respective structures of the total received light amount comparison circuit 43 and the partial light amount comparison circuit 44 to be more simplified, thereby realizing a reduction in cost of the disk device of the present invention.

In the following Examples 1 to 4, concrete examples for manufacturing the optical disk 1 and reproducing information from the optical disk 1 are shown.

### EXAMPLE 1

On the spiral information track 2 formed on the optical disk 1, the information units 5 made up of pit arrays shown in FIG. 1 and FIG. 6 are regularly arranged at pitches (intervals) of 350 nm.

The phase pits 3 and 4 are formed on a recording surface of a transparent substrate 7 made of polycarbonate in depth of 40 nm by the injection molding method.

The phase pits 3 and 4 having a diameter of 60 nm are formed at pitches of 100 nm.

A master panel for forming the transparent substrate having formed thereon these phase pits 3 and 4 is formed by using the electron beam exposure means (aligner).

Then, an optical disk stamper is formed from the master panel, and the transparent substrate 7 is formed by carrying out the injection molding by using this stamper.

Next, on the transparent substrate 7 having formed thereon these information units 5, a metal reflective film 8 made of aluminum is formed in a thickness of 50 nm by sputtering. Further, on this metal reflective film 8, as a protective film 9, a polycarbonate sheet in a thickness of 0.1 mm is laminated using ultraviolet ray curing resin.

The optical disk 1 thus prepared is mounted to the disk device of the present embodiment shown in FIG. 3, and information is reproduced from the optical disk 1.

Here, for the semiconductor laser light source 21, a semiconductor laser device having a wavelength of 405 nm is used. For the condenser lens 24 for converging the laser light L onto the optical disk 1, a lens with the number of apertures (NA) of 0.85 is used.

In this example, the laser light L is incident from the side of the protective film 9 of the optical disk 1.

When reproducing, the focusing is performed by the control section and the focusing/tracking circuit 47 so as to converge the laser light L onto the metal reflective film 8, and the tracking is performed along the information track 2. Further, by the total received light amount comparison circuit 43 and the partial light amount comparison circuit 44, each of the light receiving signals R1 to R6 received from the detectors D1 to D6 of the photodetector 31 is processed under the identification conditions shown in Tables 1 to 3. As a result, the pit arrays of 128 kinds (7-bit) in the information unit 5 are identified, and 7-bit data are demodulated.

### EXAMPLE 2

For an optical disk 1 in accordance with the present example, only the pit arrays shown in Table 5 are adopted with the structure of the optical disk 1 in the foregoing Example 1, and the reproduction of information is performed by mounting the optical disk 1 into the disk device of the present embodiment.

For the determination and identification processes by the total received light amount comparison circuit 43 and the partial light amount comparison circuit 44, the method shown in Table 6 is adopted.

As a result, the pit arrays of 64 kinds (6-bit) in the information unit 5 are identified, and 6-bit data are demodulated.

### EXAMPLE 3

For an optical disk 1 in accordance with the present example, only the pit arrays shown in Table 7 are adopted with the structure of the optical disk 1 in the foregoing Example 1, and the reproduction of information is performed by mounting the optical disk 1 into the disk device of the present embodiment.

For the determination and identification processes by the total received light amount comparison circuit 43 and the partial light amount comparison circuit 44, the method shown in Table 7 is adopted.

As a result, the pit arrays of 64 kinds (6-bit) in the information unit 5 are identified, and 6-bit data are demodulated.

### EXAMPLE 4

For an optical disk 1 in accordance with the present example, only the pit arrays shown in Table 8 are adopted with the structure of the optical disk 1 in the foregoing Example 1, and the reproduction of information is performed by mounting the optical disk 1 into the disk device of the present embodiment.

For the determination and identification processes by the total received light amount comparison circuit 43 and the partial light amount comparison circuit 44, the method shown in Table 8 is adopted.

As a result, the pit arrays of 32 kinds (4-bit) in the information unit 5 are identified, and 4-bit data are demodulated.

The manufacturing process of the optical disk 1 will be briefly explained.

In the process of manufacturing the transparent substrate 7 including phase pits 3 and 4 which constitute information units 5, the exposure is performed by emitting an electron beam or a light beam at positions where the phase pits 3 and 4 are formed in sync with the rotations of the master panel.

When exposing with an electron beam, the movement of the electron beam is stopped for a predetermined time, at position where a phase pit is to be formed in sync with the rotations of the master panel. As a result, the phase pits are formed by exposing the master panel. The electron beam is then moved to the position where the next phase pit is to be formed at high speed, thereby forming the next phase pit by exposure.

Specifically, for example, when forming the pit array 34d1, the phase pit 3 at the left end of the hexagon (apex P6; see FIG. 7) is formed by exposure, and the electron beam is then moved at high speed to the outside of the master panel.

Then, in sync with the rotation of the master panel, the electron beam is moved at high speed to the second apex from the left (apex P1), and the electron beam is stopped for a predetermined time at that position, to form the phase pit by exposure.

On the other hand, in the case of adopting the light beam, the light beam is divided into three, and the respective focal positions of these light beams are selected to be the apexes P1 and P2 located above the information track 2; apexes P3 and P6 located on the information track 2 (apexes P3 and P6 and the center), and the apexes P4 and P5 of the phase pits below the information track 2.

Then, at respective positions where the phase pits are to be formed, a pulse injection of the light beam is performed at positions where the respective phase pits are to be formed.

According to the present embodiment, phase pits 3 are formed at respective apexes of the equilateral hexagon. However, the arrangement of the phase pits 3 is not intended to be limited to this arrangement. For example, the phase pits 3 may be provided at respective apexes of other hexagon which is symmetrical in the circumferential direction and the radial direction (the hexagon formed by compressing the equilateral hexagon shape in the circumferential direction or radial direction). With this structure of the disk device, it is also possible to identify the pit array of the information unit 5.

Incidentally, the phase pits 3 may be arranged at the apexes of the square. With this structure, it is also possible to identify the pit array by appropriately setting the process (identification conditions) for the partial light amount comparison circuit 44.

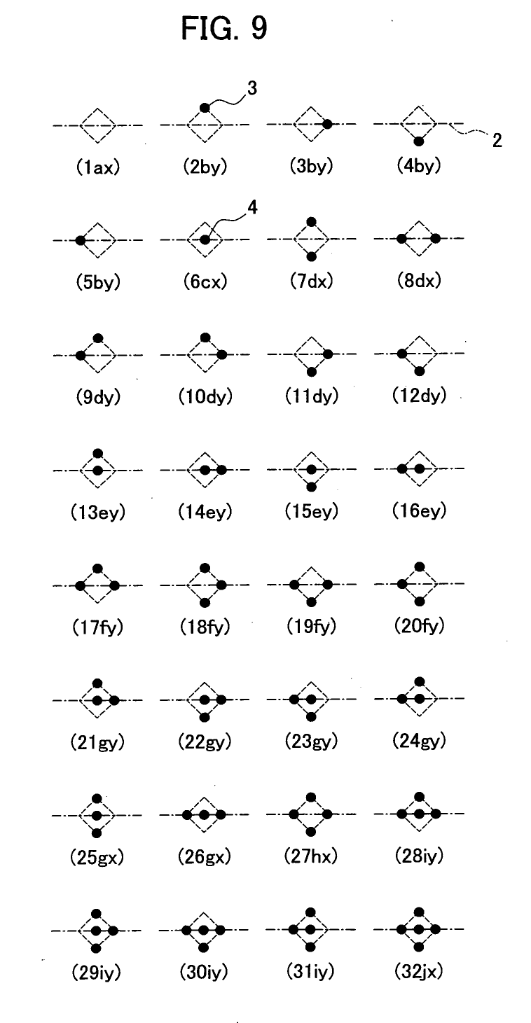

FIG. 9 is an explanatory view showing the kinds of the pit arrays (kinds of information) in the arrangement wherein the phase pits 3 are located at respective apexes of the equilateral hexagon one of the diagonal lines of which is overlapped with the information track 2 (the, respective phase pits 3 are provided at the same distance same distance from the center of the equilateral hexagon).

According to the foregoing structure of the optical disk 1, for each information unit 5, pit arrays of 32 kinds (1ax to 32jx) are available. Namely, in each information unit 5, 32 kinds of data can be recorded corresponding to the pit arrays 1ax to 32jx of the 32 kinds.

The pit array lax is a pit array without a phase pit. The pit arrays 2by, 3by, 4by, 5by and 6cx are pit arrays made up of one phase pit. The pit arrays 7dx, 8dx, 9dy, 10dy, 11dy, 12dy, 13ey, 14ey, 15ey and 16ey are pit arrays, each being made up of two phase pits. The pit arrays 17fy, 18fy, 19fy, 20fy, 21gy, 22gy, 23gy, 25gx and 26gx are pit arrays each being made up of three phase pits. The pit arrays 27hx, 28iy, 29iy, 30iy and 31iy are pit arrays, each being made up of four phase pits. Lastly, the pit array 32jx is a pit array made up of five phase pits.

Here, the reference numerals of these pit arrays lax to 32jx are identified by a combination of a serial number, a light amount identification factor and a symmetry identification factor. Namely, the serial numbers are from 1 to 32 respectively assigned to all the 32 kinds of the pit arrays.

Namely, the light amount identification factors are respectively indicative of total amounts of reflected laser light La to be incident on the photodetector 31 from the information unit having the above pit arrays.

In this case, the total reflected light amount of each pit array is classified by the light amount identification factors of ten kinds (a to j). Here, the pit arrays having the same light amount identification factors a to j have substantially the same total reflected light amount. The reflected light amounts become smaller in the order of a to j.

Here, the relationship between the number and the respective positions of the phase pits 3 and 4, and the total reflected light amount will be explained.

As described, for the pit array with the phase pits 3 and 4, the amount of reflected light is smaller than that of the pixel array without the phase pits 3 and 4. The intensity distribution of the beam spot 6 of the laser light L shows the Gaussian distribution. Therefore, for the beam spot 6, the light intensity of its center is higher than that in the circumferential region.

Furthermore, as explained earlier, the laser light L is emitted such that the center of the beam spot 6 is overlapped with the center of the information unit 5.

Therefore, there is a tendency that the amount of reflected light of the phase pit 4 at the center is smaller than the amount of reflected light of the phase pits 3 at apexes.

For any of the pit arrays 2by to 5by, a single phase pit is located in the circumference of the beam spot 6, and respective total reflected light amounts for these pit arrays 2by to 5by are all equal. For the pit array 6cx, a single phase pit 4 is located at position corresponding to the center of the beam spot 6, and total reflected light amount from the pit array 6cx is smaller than those obtained from the pit arrays 2by to 5by.

Next, for the pit arrays 7dx to 12dy made up of two phase pits 3, with an increase in the number of the phase pits, the total reflected light amounts from these arrays 7dx to 12dy are the same as that obtained from the pit array 6cx. For the pit arrays 13e to 16ey, each being made up of one phase pit 4 and one phase pit 3, the total reflected light amounts are smaller than those obtained from the pit arrays 7dx to 12dy. Similarly, for the rest of the pit arrays, with an increase in the number of the phase pits, the total reflected light amount decreases.

Incidentally, the symmetry identification factor of the pit array indicates an identification factor (x or y) indicative of the symmetry of the pit array about the direction (radial direction) which passes through the center of the pit array vertical to the direction of the information track 2 (circumferential direction) and the radial direction of the optical disk 1.

For the pit array which is axisymmetric (line symmetry) in the circumferential direction (axisymmetric (line symmetry) about an axis along the radius direction, and is axisymmetric (line symmetry) in the radius direction (axisymmetric (line symmetry) about the information track 2), the symmetry identification factor will be x.

On the other hand, for the pixel array which is not axisymmetric (line symmetry) in any direction, the symmetry identification factor is y.

Next, the structure of the photodetector 31 wherein the phase pits 3 and 4 are arranged as shown in FIG. 9 will be explained.

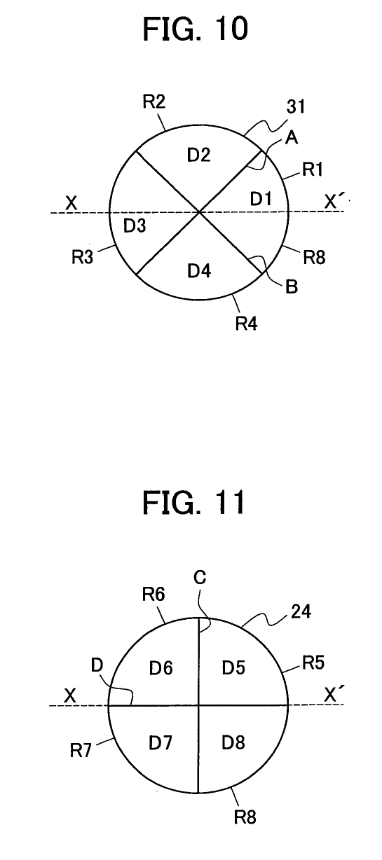

FIG. 10 is an explanatory view showing the structure of the photodetector 31 to be adopted in this example. As shown in FIG. 10, photodetector 31 includes four divided light receiving faces (photo-detecting element) D1 to D4 obtained by dividing the light receiving face into four divided light receiving faces (photo-detecting element) D1 to D4.

These divided light receiving faces D1 to D4 are formed by dividing the light receiving face of the photodetector 31 by the parting lines A and B which pass through the center of the light receiving face, and which cross at right angle, and these divided light receiving faces D1 to D4 are in the shape of a fan that radically expands from the center of the light receiving face of the photodetector 31.

These divided light receiving faces D1 to D4 respectively output voltage signals (the light receiving signal) R1 to R4 indicative of voltage values respectively corresponding to the received reflected light amounts. For the control photodetector 31, the parting lines A and B which divide the light receiving face into four divided light receiving faces D1 to D4 respectively form an angle of 60° with the straight line X-X′ corresponding to the information track 2 on the optical disk 1 (the straight line corresponding to the information track on the light receiving face of the photo photodetector 31).

The relationship between each of the phase pits 3 and 4 and the divided light receiving faces D1 to D4 will be explained.

As described, reflected light from each phase pit is diffracted, and is then incident on the entire surface of the divided light receiving faces D1 to D4. For a pit array made up of a plurality of phase pits, the diffracted light from respective phase pits interfere each other and is then incident on the divided light receiving faces D1 to D4. Namely, the reflected light from each phase pit is not incident on only one of the divided light receiving faces D1 to D6 but incident on the entire surface of the divided light receiving faces D1 to D4.

On the other hand, for a pit array made up of a single phase pit 3, the reflected from the phase pit 3 incident on any one of the divided light receiving faces D1 to D4 corresponding to that phase pit 3 has a relatively high intensity (the further is the incident position of the reflected light beam from the position corresponding to that phase pit 3, the lower is the intensity).

For example, for the pit array 2by, the intensity of the reflected light incident on the divided light receiving face D2 is relatively high, and the intensity of the reflected light incident on the divided light receiving face D4 is relatively low.

Incidentally, the reflected light from the phase pit 4 at the center of the hexagon is evenly incident around the center of all the divided light receiving faces D1 to D4. Therefore, for the pit array 8c3 made up of only one phase pit 4, the intensity of the reflected light, that is incident around the centers of all the divided light receiving faces D1 to D4, is relatively high, and the intensity of the reflected light incident on the circumferential region is relatively low.

Next, the respective functions of the circuits 43 to 46 in the circuit substrate 12 with the arrangement of the phase pits 3 and 4 shown in FIG. 9 will be explained.

As described, these circuits 43 to 46 identify the pit array of the information unit 5 to be reproduced based on the light receiving signal outputted from the photodetector 31, and generate a reproduction signal according to the identification result.

In this example, the total received light amount comparison circuit 43 adds all the light receiving signals R1 to R4 outputted from the divided light receiving faces D1 to D4 of the photodetector 31 to obtain the total reflected light amount. The total received light amount comparison circuit 43 then derives the light amount identification factors a to j for the pit array of the information unit 5 to be reproduced from the resulting the total reflected light amount.

Here, there is no other pit array which has the same amount of total reflected light as these pit arrays 1ax, 6cx, 27hx, and 32jx. Therefore, in the case where the information unit 5 to be reproduced is the foregoing pit arrays 1ax, 6cx, 27hx, and 32jx, it is possible to identify these pit arrays only by means of the total received light amount comparison circuit 43.

The partial light amount comparison circuit 44 identifies the pit array of the information unit 5 to be reproduced based on the light amount identification factors a to j derived by the total received light amount comparison circuit 43.

The identification condition by the partial light amount comparison circuit 44 is shown in Table 9.

TABLE 9

| | LIGHT AMOUNT | | | | |
|---|---|---|---|---|---|
| PIT | IDENTIFICATION | IDENTIFICATION | IDENTIFICATION | IDENTIFICATION | DEMODULATION |
| ARRAY | FACTOR | CONDITION I | CONDITION II | CONDITION III | SIGNAL |
| 1ax | a | — | — | — | 00000 |
| 2by | b | R2 > R4 | — | — | 00001 |
| 4by | | R2 < R4 | — | — | 00010 |
| 3by | | R2 = R4 | R1 > R3 | — | 00011 |
| 5by | | | R1 < R3 | — | 00100 |
| 6cy | c | — | — | — | 00101 |
| 8dy | d | R2 > R4 | R1 < R3 | — | 00110 |
| 10dy | | | R1 > R3 | — | 00111 |
| 11dy | | R2 < R4 | R1 > R3 | — | 01000 |
| 12dy | | | R1 < R3 | — | 01001 |
| 7dx | | R2 = R4 | R1 = R3 | R1 < R2 | 01010 |
| 9dx | | | | R1 > R2 | 01011 |
| 13ey | e | R2 > R4 | — | — | 01100 |
| 15ey | | R2 < R4 | — | — | 01101 |
| 14ey | | R2 = R4 | R1 > R3 | — | 01110 |
| 16ey | | | R1 < R3 | — | 01111 |
| 17fy | f | R2 > R4 | — | — | 10000 |
| 19fy | | R2 < R4 | — | — | 10001 |
| 18fy | | R2 = R4 | R1 > R3 | — | 10010 |
| 20fy | | | R1 < R3 | — | 10011 |
| 21gy | g | R2 > R4 | R1 > R3 | — | 10100 |
| 24gy | | | R1 < R3 | — | 10101 |
| 22gy | | R2 < R4 | R1 > R3 | — | 10110 |
| 23gy | | | R1 < R3 | — | 10111 |
| 25gx | | R2 = R4 | R1 = R3 | R1 < R2 | 11000 |
| 26gx | | | | R1 > R2 | 11001 |
| 27hx | h | — | — | — | 11010 |
| 28iy | i | R2 > R4 | — | — | 11011 |
| 30iy | | R2 < R4 | — | — | 11100 |
| 29iy | | R2 = R4 | R1 > R3 | — | 11101 |
| 31iy | | | R1 < R3 | — | 11110 |
| 32jx | j | — | — | — | 11111 |

As shown in Table 9, the partial light amount comparison circuit 44 compare respective intensities of the light receiving signals R1 to R4 according to the light amount identification factors a to j. Specifically, first, the partial light amount comparison circuit 44 compares respective intensities of R2 and R4 (under the identification condition I).

Next, the partial light amount comparison circuit 44 compares respective intensities of R1 and R3 (under the identification condition II). Lastly, the partial light amount comparison circuit 44 compares respective intensities of R1 and R2 (under the identification condition III). With the foregoing process, all the information units 5 can be identified.

As described, the partial light amount comparison circuit 44 compares intensities of the light receiving signals R1 to R4 based on the light amount identification factors, to identify all the pit arrays of 32 kinds.

The demodulation circuit 45 then generates the demodulation signal (demodulation data) based on the result of identification of the pit array by the partial light amount comparison circuit 44.

The demodulation circuit 45 then generates the demodulation signal (demodulation data) based on the result of identification of the pit array by the partial light-amount comparison circuit 44.

In Table 9, a demodulation signal according to each pit array is shown.

As described, for the pit arrays made up of the phase pits 3 and 4 as arranged as shown in FIG. 9, 32 kinds of pit arrays exist for the information unit 5. It is therefore possible to multiplex record 32 kinds of information for each information unit 5. As a result, 5-bit demodulation signal can be obtained from each information unit 5.

As described, according to the optical disk 1 having the pit arrays made up of up of five pits including four phase pits 3 and one phase pit 4 as arranged as shown in FIG. 9, each pit array of the information unit 5 made up of five pits in a combination of one phase pit 4 located on the information track 2 and four phase pits 3 arranged in the circumferential region.

In this example, the phase pits 3 are located at respective apexes of the square (quadrangle), wherein one of the diagonal lines is overlapped with the information track 2 The phase pit 4 is located at the center of the square.

As described, the optical disk 1 of the present embodiment is arranged so as to form the pit array of the information unit 5 by four phase pits 3 and the phase pit 4 at the center.

With the foregoing structure, the optical disk 1 of the present embodiment permits information (5-bit data) of 32 (25) kinds to be multiplex-recorded for each information unit 5. Therefore, as compared to the arrangement adopting the pit array made up of a combination of only four phase pits 3, a large volume optical disk with significant improved recording density can be realized.

According to the optical disk 1 of the present embodiment, the number of partitions for the light receiving face of the photodetector 31 required for reproduction (number of divided light receiving faces) can be set to four.

Namely, for the pit array of the information unit 5 made up of only four phase pits 3, the intensity distribution of the reflected light from the information unit 5 corresponds to the shape of square (the square is formed when the pixel array is made up of four phase pits). Therefore, the photodetector 31 to be adopted for reproducing information is divided into four corresponding to four phase pits 3. Namely, the four-divided photodetector made up of four divided light receiving faces D1 to D4 is adopted.

Then, the photodetector 31 determines with or without the phase pit 3 for all the four phase pits 3 in the information unit 5 (the location(s) of the phase pit(s) 3) according to the intensity of the reflected light to be incident on the six divided light receiving faces D1 to D4, and then identify the pit array to be reproduced based on the determination result.

For the pit array of the optical disk 1 with one phase pit 4 at the center of four phase pits 3, the four divided photo detector 31 made up of four divided light receiving faces D1 to D4 may be adopted.

Therefore, when information is reproduced from the optical disk 1, using the four-divided photodetector 31, it is possible to determine if the phase pit 4 is provided, based on the total received light amount by the entire light receiving face (the intensity of the total reflected light from the entire information unit 5 (pit array)).

For the phase pit 3, it can be determined if the phase pit 3 is provided at each position based on the intensity of the light incident on each of the four divided light receiving faces D1 to D4 as described earlier.

As described, according to the optical disk 1, although the information unit 5 made up of five phase pits 3 and 4 is adopted, it is possible to reproduce information using the four-divided photodetector 31. With this structure, the optical disk 1 permits the information to be recorded at high density, and the recorded information to be reproduced without using reproducing circuits of the complicated structure.

In the case of adopting the pit array made up of five phase pits located at apexes of the pentagon, the intensity distribution of the reflected light from the information unit 5 corresponds to the shape of the pentagon (the shape of the pentagon is formed when the pixel array is made up of five phase pits). Therefore, it is necessary to provide the divided light receiving faces corresponding to the five phase pits, and to determine if each phase pit is provided based on the intensity of the light incident on each of these five divided light receiving faces.

With this structure, it is therefore required to divide the light receiving face of the photodetector into five (the number of divided light receiving faces is five). As a result, the circuit for processing the intensity of the light incident on each of the divided light receiving faces becomes complicated, which results in an increase in cost. In particular, the partial light amount comparison circuit 44 for determining the symmetric characteristic becomes complicated in structure.

According to the optical disk 1 having the pit arrays shown in FIG. 9, the phase pits 3 and 4 are provided respectively at apexes of the square and the center of the square. As a result, the phase pits can be provided in the optical disk 1 at higher density, and it is therefore possible to realize a still higher recording density.

With the foregoing structure, in order to identify the pit array of the information unit 5 to be reproduced according to the reflected laser light La, the total received light amount comparison circuit 43 and the partial light amount-comparison circuit 44 are provided.

Then, the total received light amount comparison circuit 43 specifies the total reflected light amount and roughly classifies the pit arrays of the information unit 5 into groups according to the light amount identification factors. Then, according to the total reflected light amount as specified, the partial light amount comparison circuit 44 compares (partially compares) the intensity of the light incident on each of the divided light receiving faces D1 to D4 and identifies the pit array of the information unit 5.

As described, also with the foregoing structure of the present embodiment, the pit arrays are roughly identified into groups by the total right amount comparison circuit before carrying out the partial comparison by the partial light amount comparison circuit.

It is therefore possible to reduce the kinds and the number of partial comparisons to be performed for the identification of the pit array by the partial light amount comparison circuit.

When reproducing information from the optical disk 1 having the pit arrays shown in FIG. 9, adopted is the photodetector 31, wherein the parting lines A and B which divide the light receiving face into the divided light receiving faces D1 to D4 form an angle of 45° with the straight line X-X′ corresponding to the information track 2 formed on the optical disk 1.

Here, the photodetector 31 may be arranged such that one of the parting lines A and B is overlapped with (parallel to) the straight line X-X′ corresponding to the information track 2. With this structure, it is also possible to identify the pit array of the information unit 5 by carrying out the foregoing identification process.

With the foregoing structure, however, as the parting lines are provided at positions subjected to the maximum changes in light intensity (at positions where respective phase pits 3 are formed), a problem arises in that the detection precision of the light intensity distribution by the divided light-receiving faces D1 to D4 is lowered.

In view of an improvement in detection precision, it is therefore preferable that the parting lines A and B be provided so as to form an angle of 45° with the straight line X-X′ corresponding to the information track 2 on the optical disk 1.

With this structure, it is possible to provide respective centers of the divided light receiving faces D1 to D4 at the corresponding phase pits (at position where the intensity of the reflected light from each phase pit 3 is maximized). Therefore, it is possible to allocate these four divided light receiving faces D1 to D4 to the phase pits 3 with one to one correspondence. It is therefore possible to determine respective phase pits 3 of four kinds with accuracy by the four divided light receiving faces D1 to D4.

As described, desirable effects can be achieved by arranging such that the parting lines A and B which divide the light receiving face into the divided light receiving faces D1 to D4 form an angle of 45° with the straight line X-X′ corresponding to the information track 2 formed on the optical disk 1. Specifically, the foregoing desirable effect can be achieved from the structure wherein one of the diagonal lines of the square formed by the four phase pits 3 is overlapped with the information track 2, i.e., the structure wherein one of the parting lines A and B forms an angle of 45° with straight line on the light receiving face corresponding to one of the diagonal lines of the square.

With the foregoing structure, even with the structure wherein the parting lines A and B do not form an angle of 45° with the straight line X-X′, it is still possible to ensure the foregoing desirable effect.

Incidentally, in the case where one of the diagonal lines of the square is overlapped with the information track 2, the following effect can be achieved. That is, the axisymmetric characteristic (line symmetry) of the pit array of the information unit 5 about the information track 2 can be achieved with ease.

According to the structure of FIG. 10, the parting lines A and B of the photodetector 31 cross at right angle. In this structure, respective divided light receiving faces D1 to D4 have the same area, and it is therefore possible to compare respective intensities of the light receiving signals R1 to R4 by the partial light amount comparison circuit 44 with ease.

Incidentally, according to the present embodiment, as shown in FIG. 2, the total received light amount comparison circuit 43 is provided in the pre-stage of the partial light amount comparison circuit 44. When reproducing information from the optical disk 1 having the pit array shown in FIG. 9, after the light amount identification factors are identified by the total received light amount comparison circuit 43, the partial light amount comparison circuit 44 identifies the pit array of the information unit 5 based on these light amount identification factors and the light receiving signal R1 to R4.

However, the present invention is not intended to be limited to the foregoing structure, and, for example, it may be arranged so as to provide the partial light amount comparison circuit 44 in the pre-stage of the total received light amount comparison circuit 43.

The identification method in the foregoing structure is shown in the following Table 10.

TABLE 10

| | | SYMMETRY | SYMMETRY | LIGHT AMOUNT | |
|---|---|---|---|---|---|
| PIT | SYMMETRY | IDENTIFICATION | IDENTIFICATION | IDENTIFICATION | DEMODULATION |
| ARRAY | IDENTIFICATION I | II | III | FACTOR | SIGNAL |
| 3by | T1 > T2 | S1 > S3 | S2 < S4 | b | 00000 |
| 14ey | | | | e | 00001 |
| 17fy | | | S2 > S4 | f | 00010 |
| 28iy | | | | i | 00011 |
| 5by | | S1 < S3 | S2 > S4 | b | 00100 |
| 16ey | | | | e | 00101 |
| 19fy | | | S2 < S4 | f | 00110 |
| 30iy | | | | i | 00111 |
| 8dx | | S1 = S3 | S2 = S4 | d | 01000 |
| 26gx | | | | g | 01001 |
| 2by | T1 < T2 | S1 > S3 | S2 > S4 | b | 01010 |
| 13ey | | | | e | 01011 |
| 18fy | | | S2 < S4 | f | 01100 |
| 29iy | | | | i | 01101 |
| 4by | | S1 < S3 | S2 < S4 | b | 01110 |
| 15ey | | | | e | 01111 |
| 20fy | | | S2 > S4 | f | 10000 |
| 31iy | | | | i | 10001 |
| 7dx | | S1 = S3 | S2 = S4 | d | 10010 |
| 25gx | | | | g | 10011 |
| 10dy | T1 = T2 | S1 > S3 | S2 = S4 | d | 10100 |
| 21gy | | | | g | 10101 |
| 12dy | | S1 < S3 | S2 = S4 | d | 10110 |
| 23gy | | | | g | 10111 |
| 8dy | | S1 = S3 | S2 > S4 | d | 11000 |
| 24gy | | | | g | 11001 |
| 11dy | | | S2 < S4 | d | 11010 |
| 22gy | | | | g | 11011 |
| 1ax | | | S2 = S4 | a | 11100 |
| 6ax | | | | o | 11101 |
| 27hx | | | | h | 11110 |
| 32jx | | | | j | 11111 |

With the foregoing structure, the partial light amount comparison circuit 44 identifies the symmetric characteristic of each pit array of the information unit 5 in the symmetry identifications I to III based on the light receiving signals R1 to R4 as shown in Table 10.

In Table 10, T1 and T2 respectively correspond to (R1+R3) and (R2+R4). Similarly, S1 to S4 respectively correspond to (R1+R2), (R2+R3), (R3+R4) and (R4+R1).

With the foregoing structure, specifically, the partial light amount comparison circuit 44 compares respective intensities of T1 and T2 in the symmetry identification I. The partial light amount comparison circuit 44 then compares respective intensities of T1 and T3 in the symmetry identification II. Further, the partial light amount comparison circuit 44 compares the respective intensities of S2 and S4 in the symmetry identification III.

By carrying out the foregoing calculation (comparison), the partial light amount comparison circuit 44 determines if each pit array of the information unit 5 belongs to any one of small groups of 15 kinds in the symmetry identifications I to III.

Thereafter, the total received light amount comparison circuit 43 identifies the pit array based on the kind of the small group which each pit array belongs to and the total reflected light amount from that pit array.

According to the foregoing structure, the total received light amount comparison circuit 43 uses the information with regard to the small group to which the target pit array belongs, in addition to the total reflected light amount.

In this case, two kinds or four kinds of total reflected light amounts are to be identified in each small group. With this structure, it is therefore possible to identify the total reflected light amounts with higher precision by the total received light amount comparison circuit 43 as compared to the case of Table 9 wherein the total reflected light amounts of 10 kinds (a to j) are to be identified.

Incidentally, the total received light amount comparison circuit 43 of a simpler circuit structure can be adopted. Namely, in the case where a large number of kinds of total reflected light amounts are to be identified by the total received light amount comparison circuit 43, the total reflected light amount changes even with very small amount of change in the laser light L, which may cause such problem that the pit array of the information unit 5 is difficult to be identified.

In the foregoing structure, it is therefore preferable be arranged so as to raise the control precision of the laser control circuit 42 and the control precision of the focusing/tracking circuit 47 (tracking precision and focusing precision).

On the other hand, according to the case of Table 10, with a reduced number of kinds of the total reflected light amounts to be identified by the total received light amount comparison circuit 43, differences between respective light amounts to be identified by the total received light amount comparison circuit 43 can be made relatively large.

Therefore, without the need of improving the control precision of the laser control circuit 42 or the focusing/tracking circuit 47, the light amount identification factors can be identified with accuracy with respect to the target array to be reproduced.

In the following, the focusing control and the tracking control in the disk device in accordance with the present embodiment will be explained.

According to the disk device of the present embodiment, by utilizing the reflected light from the information units 5 shown in FIG. 1, FIG. 6 or FIG. 9, the control photodetector 29 and the focusing/tracking circuit 47 perform a focusing control and a tracking control.

FIG. 11 is an explanatory view showing the structure of-the control photodetector 29.

As illustrated in FIG. 11, the control photodetector 29 is a four-divided photodetector made up of four divided light receiving faces (photo-detecting elements) D5 to D8 obtained by dividing the light receiving face.

The divided light receiving faces D5 to D8 are obtained by dividing the circular light receiving face of the control photodetector 29 by the parting lines C and D, which pass through the center of the light receiving face and cross each other at right angle and these divided light receiving faces D5 to D8 are in the shape of a fan that radically expands from the center of the light receiving face of the control photodetector 29.

These divided light receiving faces D5 to D8 respectively output voltage signals (the light receiving signal) R5 to R8 indicative of voltage values respectively corresponding to the received reflected light amounts. For the control photodetector 29, one of the parting lines (the parting line D) which divide the light receiving face into four divided light receiving faces D5 to D8 is overlapped with the straight line X-X′ corresponding to the information track 2 on the optical disk 1 (the straight line corresponding to the information track on the light receiving face of the photo photodetector 29).

The focusing/tracking circuit 47 generates a focusing signal by the astigmatism method and a tracking signal by the push-pull method, based on a light receiving signal generated by the control photodetector 29.

The focusing/tracking circuit 47 then drives the actuator 25 based on the resulting focusing signal and the tracking signal to perform the focusing control and the tracking control.

In the following, the focusing control operation and the tracking control operation by the disk device of the present invention will be explained.

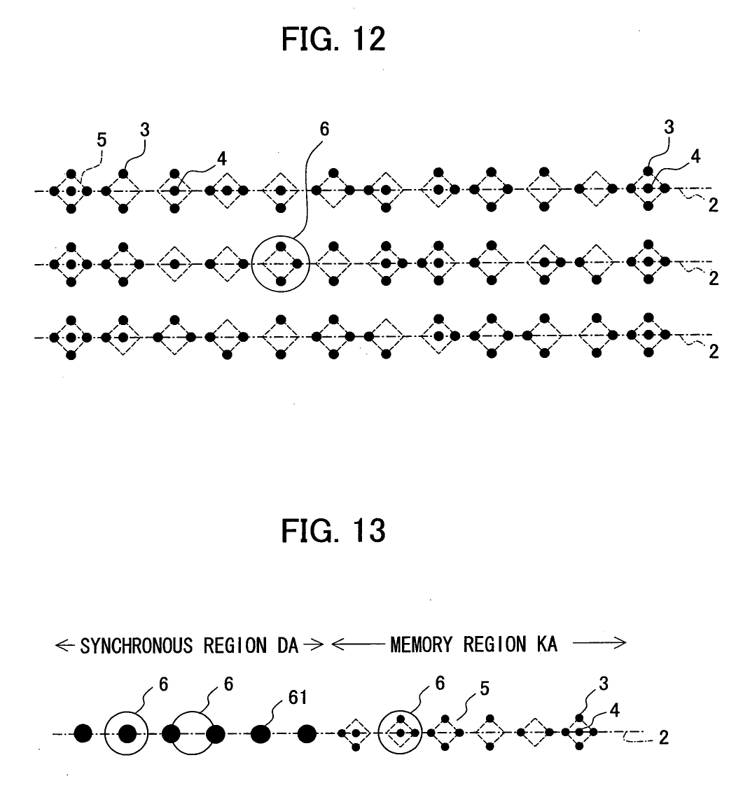

When reproducing from the disk device of the present invention, the control section controls the spindle control circuit 41 to rotate the optical disk 1. This control section also controls the laser control circuit 42 to emit laser light L from the condenser lens 24 onto the optical disk 1, and to scan beam spots 6 along the information track 2 of the optical disk 1 as illustrated in FIG. 12. In this operation, the laser light L is emitted so that the center of the beam spot 6 is on the center of the information unit 5.

As a result, the laser light L is reflected from the information unit 5 formed along the information track 2 to be a reflected laser light La, and is incident on the control photodetector 29.

These divided light receiving faces D5 to D8 of the control photodetector 29 then respectively output to the focusing/tracking circuit 47, voltage signals R5 to R8 indicative of voltage values respectively corresponding to the received reflected light amounts.

The focusing/tracking circuit 47 which receives the light receiving signals R5 to R8 executes the focusing control or the tracking control according to the instruction given by the control section. Namely, the focusing/tracking circuit 47 first generates a focusing signal by the astigmatic method using the cylindrical lens 28 for focusing the laser light L onto the recording face of the optical disk 1.

Here, the focusing/tracking circuit 47 receives the light receiving signals R5 to R8 from the control photodetector 29 and computes (R5+R7)−(R6+R8). Then, to set the value resulting from the foregoing calculation to be zero, the focusing/tracking circuit 47 generates a focusing signal for controlling the position of the condenser lens 24 in the focusing direction (in a direction vertical to the surface of the optical disk 1). The focusing/tracking circuit 47 then outputs the resulting focusing signal to the actuator 25 for controlling the position of the condenser lens 24. As a result, it is possible to set the focal position of the laser light L onto the recording face of the optical disk 1.

This focusing/tracking circuit 47 also generates the tracking signal by the push-pull method to set the center of the laser light L along the information track 2 (for the tracking control).

Here, the focusing/tracking circuit 47 receives the light receiving signals R5 to R8 from the control photodetector 29 and computes (R5+R6)−(R7+R8). Then, to set the value resulting from the foregoing calculation to be zero, the focusing/tracking circuit 47 generates a tracking signal for controlling the position of the condenser lens 24 in the tracking direction (in a direction of the radius direction of the optical disk 1). The focusing/tracking circuit 47 then outputs the resulting tracking signal to the actuator 25 for controlling the position of the condenser lens 24. As a result, it is possible to set center of the beam spot 6 on the center of the information unit 5.

According to the structure of the optical disk 1 shown in FIGS. 1, 6 and 9, a synchronous unit 61 for generating a synchronous signal may be adopted as shown in FIG. 13.

As shown in FIG. 13, according to the above structure, sectors, each being made up of a synchronous region (synchronous signal region) DA and a recording region KR are formed successively and periodically along the information track 2.

The recording region KA is a region where a plurality of information units 5 are formed.

Incidentally, the synchronous region DA is a region provided at the leading end of each sector, in which a plurality of synchronous units 61 of the same shape are provided at equal intervals.

Namely, as shown in FIG. 13, the optical disk 1 is arranged so as to from the synchronous region DA in ahead of the recording region KA formed in the information unit 5.

In each synchronous region DA, a plurality of synchronous units 61 are provided at equal intervals along the information track 2.

Incidentally, the synchronous unit 61 is a pattern of a larger area than the phase pits 3 and 4 which constitute the information unit 5, and in the same depth as the phase pits 3 and 4.

The foregoing synchronous regions DA of the synchronous unit 61 is provided in the number of around 20 to 40 per one circle of the information track 2.

In each synchronous region DA, the synchronous units 61 are formed in the number of 16 to 64 at the same pitches (intervals) as intervals at which the information unit 5 are formed along the information track.

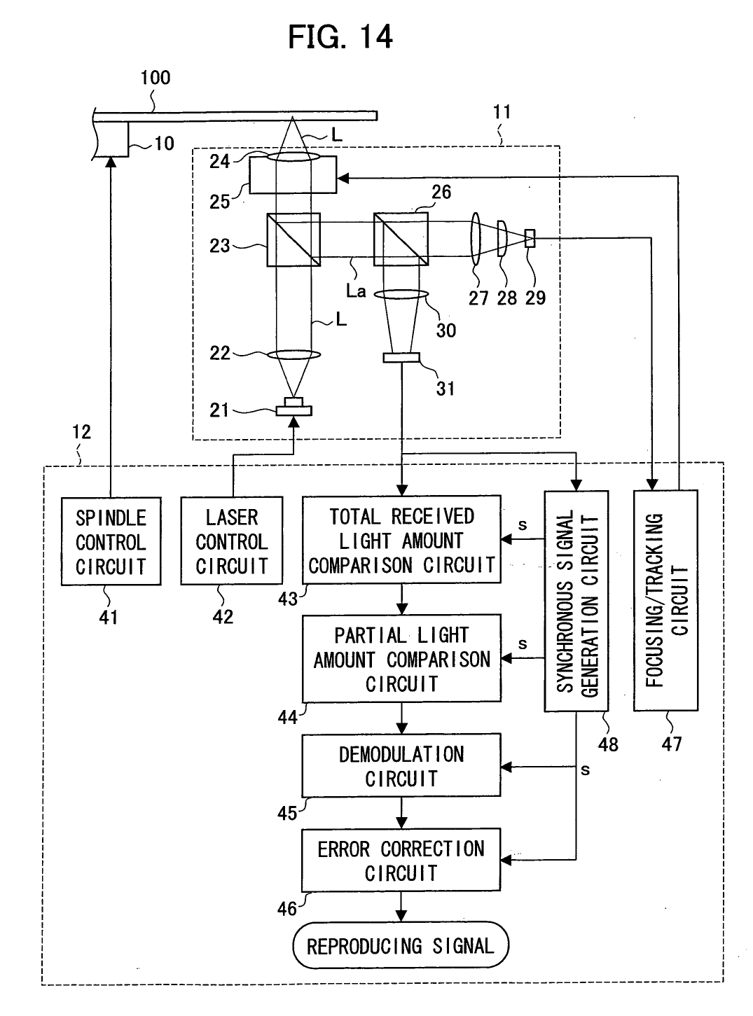

In the case of reproducing information from the optical disk 1 in which the foregoing synchronous regions are formed, it is preferable to adopt the disk device having the structure of FIG. 14.

With the foregoing structure of the disk device shown in FIG. 2, the circuit substrate 12 has the synchronous signal generation circuit 48.

The synchronous signal generation circuit 48 generates a synchronous signal S for reproducing information signal based on the light receiving signal outputted from the photodetector 31.

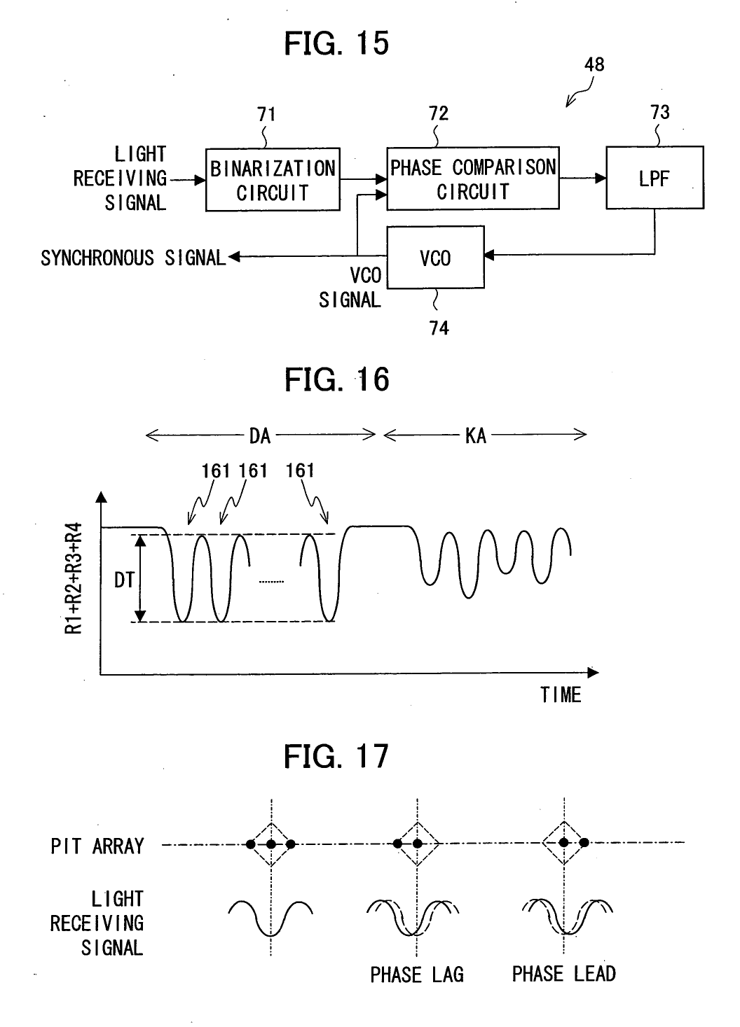

FIG. 15 is an explanatory view showing the structure of the synchronous signal generation circuit 48. The synchronous signal generation circuit 48 is an oscillation circuit generally called “PLL circuit (phase synchronous circuit).

Namely, the synchronous signal generation circuit 48 has an oscillator in its loop, which outputs a signal (synchronous signal). The synchronous signal generation circuit 48 then performs oscillation of the synchronous signal S while performing the feedback control so as to set the phase difference between the output from the oscillator and the light receiving signal outputted from the photodetector 31 to be constant (zero).

As illustrated in FIG. 15, the synchronous signal generation circuit 48 includes the binarization circuit 71, the phase comparator 72, the low pass filter (LPF) 73 and the voltage control oscillator 74.

The binarization circuit 71 converts the light receiving signal to be outputted from the photodetector 31 into a digital signal to be outputted to the phase comparator 72. The phase comparator 72 then performs a phase comparison between the digital signal and the output signal (VCO signal) of the VCO 72. The phase comparator 72 then outputs the voltage signals (phase difference signals) according to the phase difference to the LPF 73.

The LPF 73 then cuts off a high frequency components of a phase difference signal and smoothes the phase difference signal to be outputted to the VCO 74.

The VCO 74 then outputs a VCO signal at a predetermined constant self oscillation frequency. This self oscillation frequency (phase) of the VCO signal changes with changes in voltage of the phase difference signal outputted from the LPF 73.

Namely, the VCO 74 controls the frequency and phase of the VCO signal based on the phase difference signal so that a phase difference between the light receiving signal outputted from the photodetector 31 and the VCO signal becomes zero.

As a result, the VCO output signal (synchronous signal) having the same cycle and the phase of the light receiving signal which is sync with the light receiving signal can be obtained.

The method of generating the synchronous signal S in the disk device of FIG. 14 will be explained.

When reproducing information from the optical disk 1 in the disk device of the present invention, the control section controls the spindle control circuit 41 to rotate the optical disk 1. This control section also controls the laser control circuit 42 to emit laser light L from the condenser lens 24 onto the optical disk 1, and to scan beam spots 6 along the information tracks 2 of the optical disk 1 as illustrated in FIG. 13. In this operation, the laser light L is emitted so that the center of the beam spot 6 is on the information track.

As a result, the laser light L is reflected from the information unit 5 or the synchronous unit 61 formed along the information track 2 to be a reflected laser light La, and is incident on the photodetector 31.

These divided light receiving faces D1 to D4 of the photodetector 31 then generate the light receiving signal R1 to R4 respective having voltage values corresponding to the amounts of reflected light.

When the beam spot 6 is formed in the synchronous region DA, the control section outputs these light receiving signals R1 to R4 to the synchronous signal generation circuit 48 (and the total received light amount comparison circuit 43).

FIG. 16 is a graph which does the sum of the total light receiving signals (total light receiving signals) to be outputted from the photodetector 31 when scanning the beam spot 6 on the information track 16. In FIG. 16, DT indicates amplitude of the total light receiving signal obtained when passed through the synchronous unit 61.

In the synchronous signal generation circuit 48, when beam spot 6 passes through the synchronous unit 61, the total light receiving signals, which are the sum of the total light receiving signals R1 to R4, are outputted to the binarization circuit 71.

The synchronous signal generation circuit 48 then generates the synchronous signal S based on the above signals, and outputs the resulting synchronous signal S to the control section. Then, the control section generates the synchronous signal S for generating a reproducing signal, and outputs the resulting synchronous signal S to the circuits 43 to 46.

At the timing of receiving this signal S, these circuits 43 to 46 start operating. For example, at the timing of receiving the synchronous signal S, the total received light amount comparison circuit 43 adds all the light receiving signals R1 to R4 outputted from all the divided light receiving faces D1 to D4 of the photodetector 31, to obtain the total reflected light amount.

At the timing of receiving the synchronous signal S, the partial light amount comparison circuit 44 compares (holds and compares) intensities of the total reflected light amounts.

When the beam spot 6 is formed in the recording region KA, the control section adopts as a value of the synchronous signal S to be outputted from the circuits 43 to 46, not a value of the synchronous signal generated by the synchronous signal generation circuit 48, but a value of the synchronous signal S outputted when reproducing the synchronous region DA located directly before the target synchronous region DA (the synchronous signal S is latched).

According to the disk device of the present embodiment, it is possible to generate a reproducing signal corresponding to the pit array as identified at timings the center of the beam spot 6 is located on the center of the pattern (pit array) of the information unit 5. As a result, the information can be reproduced with accuracy.

Incidentally, the synchronous signal S generated when reproducing from the recording region KA contains an error due to differences in pit arrays among respective information units 5. Namely, without the synchronous region DA, a synchronous signal in sync with the data obtained by reproducing from the recording region KA (the light receiving signal from the information unit 5) is generated (self-clock-system).

In this case; however, due to differences in pit arrays of the information units 5 as illustrated in FIG. 17, a phase shift occurs in a light receiving signal obtained from the information unit 5. Therefore, an error occurs in a synchronous signal as generated based on such light receiving signal.

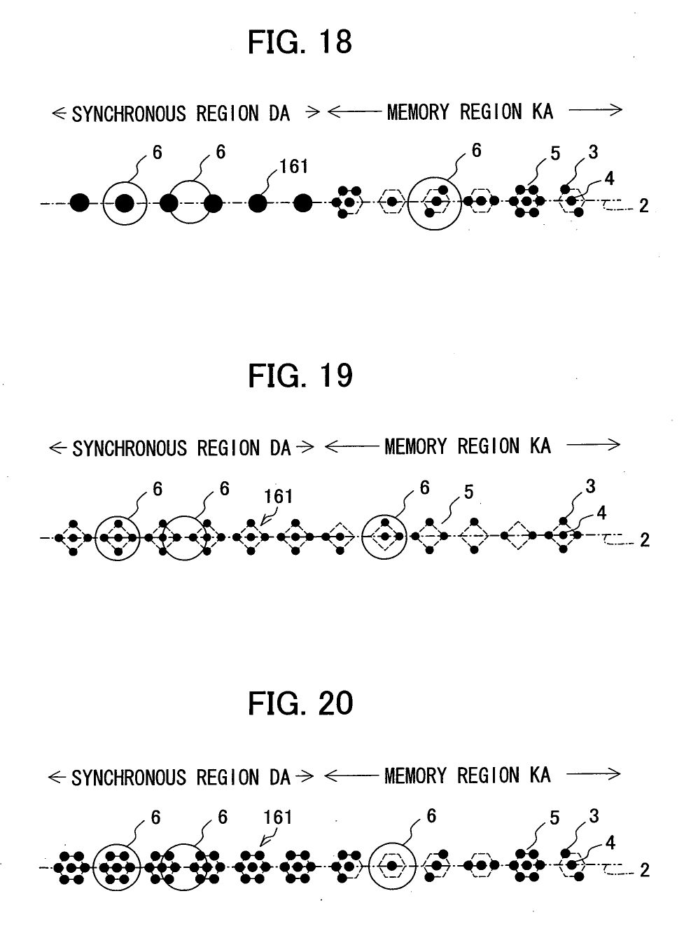

The optical disk 1 of the above example, having formed thereon the synchronous regions DA, the number of phase pits 3 of the information unit 5 is selected to be four. Here, the foregoing synchronous regions DA may be formed in the same manner also for the optical disk 1 whereon the information units 5 (see FIG. 1) made up of six phase pits 3 are formed as shown in FIG. 18.

The synchronous unit 61 shown in FIG. 18 has the same structure as that of FIG. 13.

In the optical disk 1 shown in FIG. 18, the synchronous signal S can be generated by the synchronous unit 61 as in the case of the optical disk 1 shown in FIG. 13. Incidentally, by the comparison of the total reflected light amount by the total received light amount comparison circuit 43, and the identification or identification of the symmetric characteristic by the symmetry partial light amount comparison circuit 44, it is possible to identify the pit arrays of the information units 5, thereby reproducing recorded information.

In the foregoing embodiment, for the synchronous unit 61, the pattern of a larger area than the phase pits 3 and 4 which constitute the information unit 5, and in the same depth as the phase pits 3 and 4 is adopted. However, the present invention is not intended to be limited to the foregoing structure, and the area and the depth of the synchronous unit 61 can be selected as desired by the user.

As illustrated in FIG. 19 and FIG. 20, the pattern of the synchronous unit 61 may be formed by the same phase pits as those of the information unit 5. Namely, in the synchronous region DA of the optical disks 1 shown in FIGS. 19 and 20, a plurality of synchronous units 61, each of which as the same structure as the information unit, are arranged at regular intervals. When adopting the foregoing synchronous units 61, it is still possible to generate the synchronous signal S.

According to the foregoing structure, since the phase pits 3 and 4 which constitutes the information unit 5 and the phase pits (pattern) which constitute the synchronous unit 61 have the same area, the synchronous unit 61 can be formed in an efficient manner.

Specifically, when forming the information unit 5 and the synchronous unit 61 shown in FIG. 13, using an electron beam exposure device, the electron beam is focused to a spot area for forming the phase pits 3 and 4 of the information unit 5 to expose the phase pits 3 and 4 of the information unit 5.

On the other hand, to exposure the synchronous unit 61 of larger area than the phase pits 3 and 4, the electron beam thus focused is continuously emitted, and a phase pit of relatively large size is formed by moving the electron beam at high speed in the direction vertical to the information track 2. As described, the phase pits 3 and 4 of the information unit 5, and the synchronous unit 61 are respectively formed in different manners, and it is therefore necessary to control the electron beam for the optimal conditions for forming the respective phase pits.

In response, as illustrated in FIGS. 19 and 20, for the synchronous units 61 made up of the phase pits which are the same as the phase pits 3 and 4 of the information units 5, the synchronous units 61 can be formed under the same conditions as the information units 5.

As a result, the control conditions for the formation of the master panel of the optical disk 1 can be reduced, and the master panel and the optical disk 1 can be manufactured in simplifier manner (under more stable conditions).

The synchronous units 61 shown in FIGS. 19 and 20 are made up of all the phase pits 3 and the phase pit 4. However, the synchronous units 61 of the present invention are not intended to be limited to the above, and any pit array may be adopted for the synchronous unit 61.

For the pit arrays of the synchronous unit 61, it is preferable that the respective numbers of phase pits 3 are the same on both sides about the straight line which crosses the center of the information unit 5 in a direction vertical to the information track 2.

Incidentally, the larger is the change in the total reflected light amount by the synchronous unit, the more accurately the synchronous signal S can be generated. Therefore, as illustrated in FIGS. 19 and 20, it is preferable that the pit array made up of all the phase pits 3 and the phase pit 4 be adopted.

The synchronous units 61 may be formed at intervals twice as long as intervals at which information units 5 are formed in the direction of the information track 2. With this structure, an amplitude DT of a total amount of signals obtained when passing the synchronous unit 61 can be still increased, and therefore the synchronous signal S can be generated with ease.

With differences in cycle of the light receiving signals, the information unit 5 and the synchronous unit 61 can be identified with ease (the reproducing region (DA/KA) can be identified by the control section with ease). As a result, a synchronous signal can be generated with higher precision, and the recorded information can be reproduced more accurately.

In this case, a frequency dividing circuit should be added in the synchronous signal generation circuit 48, and with this frequency dividing circuit, a synchronous signal S having a cycle of ½ of the light receiving signal from the synchronous unit 61 is generated for use in reproducing recorded information from the information unit 5.

Incidentally, intervals at which the synchronous units 61 are formed are not limited to be twice as long as the intervals at which the information units 5 are formed in the direction of the information track 2, and the intervals at which the synchronous units 61 are formed can be selected as desired, and any intervals of an integer multiple of the intervals at which the information units 5 are formed.

Incidentally, the number of the synchronous units 61 in the synchronous region DA is not intended to be limited to a range of 16 to 64. The number of the synchronous regions DA in one cycle of the information track 2 is also not intended to be limited to a range of 20 to 49. The respective numbers of the synchronous units 61 and the synchronous regions DA can be selected as desired.

In the present embodiment, the focus control and the tracking control are performed using the information units 5. However, the structure of the present embodiment is not intended to be limited to the above structure, and it may be arranged so as to perform the focus control and the tracking control using the synchronous units 61.

The information units 5 formed on the optical disk 1 include those made up of pit arrays which are asymmetric about the information track 2 like the pit arrays 9dy, 13ey of FIG. 9. For this reason, the push-pull signal obtained from the asymmetric information unit 5 may disturb an accurate tracking. In response, the focusing control and the tracking control may be performed using only the synchronous units 61.

According to the present embodiment, in the case where the beam spot 6 is formed in the recording region KA, the control section outputs the synchronous signal S as outputted when reproducing from the synchronous region DA directly before the target synchronous region DA to the circuits 43 to 46. Here, the control section may be arranged so as to stop the operations of the synchronous signal generation circuit 48 or to maintain the operations of the synchronous signal generation circuit 48.

The method of identifying the reproducing region by the control section is not specified.

According to the present embodiment, the phase pits 3 are arranged at respective apexes of the square or the equilateral hexagon. However, the arrangement of the phase pits 3 is not intended to be limited to the above. For example, the phase pits 3 may be formed at apexes of other square which is symmetric about the circumferential direction or a radius direction (lozenge obtained by compressing the square in a circumferential direction or a radius direction). With this structure, it is also possible to identify the pit array of the information unit 5 by the disk device of the present embodiment as in the above case.

The phase pits 3 may be provided at apexes of other polygon (the pentagon or the octagon). In this case, it is also possible to identify the pit array by appropriately setting the process (identification conditions) by the partial light amount comparison circuit 44.

Here, it is preferable that the phase pits 3 of the optical disk 1 be formed at the same distance from the phase pit 4. In this way, all the phase pits 3 and 4 can be formed efficiently (at high density) in a beam spot 6 of substantially circular shape with an application of a laser light L. As a result, the recording density of the optical disk 1 can be improved, and the beam spot 6 can be made smaller in size.

According to the present embodiment, the collimator lens 22 shapes the flux of light of the laser light L as emitted from the semiconductor laser light source 21 into a parallel light. Here, in the case where the laser light from the semiconductor laser light source 21 is emitted in an elliptical shape, the beam may be shaped by the collimator lens 22 (or other beam shaping member).

In the present embodiment, the optical disk 1 with a diameter of 120 mm is adopted. However, according to the disk device of the present embodiment, it is possible to reproduce recorded information from the optical disk 1 of another size by altering the movable range of the optical pickup 11 (actuator 25).

In the present embodiment, the spiral information track 2 is formed on the optical disk 1. The present invention; however, the information track 2 of the present embodiment is not intended to be limited to the foregoing structure, and a plurality of information tracks 2 of concentric circles may be adopted.

In the preset embodiment, the optical disk 1 is adopted as the medium (optical memory device) for reproducing therefrom information by the disk device of the present embodiment.

However, the present invention may be arranged so as to reproduce information from an optical card in which information tracks are linearly arranged. In this case, in the information tracks formed on the optical card, it is preferable that the information units 5 be made up of the pit arrays shown in FIGS. 1, 6 and 9.

In the disk device of the present embodiment, when adopting a transparent material for the protective film 9, it is possible to form the beam spot 6 on the metal reflective film 8 by projecting a laser light from the side of the protective film 9, to reproduce recorded information. Incidentally, it is also possible to reproduce recorded information also by projecting the laser light L from the side of the transparent substrate 7 of the optical disk 1. According to the present embodiment, for the amount of light obtained by the total received light amount comparison circuit 43, a total amount of light reflected from the information unit 5 (total reflected light amount) is adopted. To be more specific, however, the amount of light obtained by the total received light amount comparison circuit 43 is a total amount of light incident on the photodetector 31 (the divided light receiving faces D1 to D4 or the divided light receiving faces D1 to D6).

Here, the total amount of incident light can be obtained by subtracting an amount of light (control light) directed to the control photodetector side by the beam splitter 26 from the total reflected light amount, which is in proportion to the total reflected light amount.

According to the arrangement of FIG. 10, the parting lines A and B of the photodetector 31 are provided so that respective adjacent two lines form an angle of 90°. However, the present invention is not intended to be limited to the foregoing arrangement, and an angle formed by the adjacent two parting lines can be slightly different from 90°. In this case, however, respective areas of the divided light receiving faces D1 to D4 are slightly different each other. It is therefore preferable that the process of comparing the light receiving signals R1 to R4 by the partial light amount comparison circuit 44 be adjusted.

According to the present embodiment, the photodetector 31 of a circular shape is adopted. However, the photodetector of the present invention is not intended to be limited to the foregoing, and a photo-receptor of any shape can be adopted as long as all the reflected laser light La can be received. Similarly, the shape of the light receiving face of the control photodetector 29 is not limited to be a circular shape.

According to the structure of FIG. 10, the light receiving face of the photodetector 31 is divided into four divided light receiving faces. However, the number of the divided light receiving faces is not intended to be limited to four. However, the divided number of the light receiving face of the photodetector 31 is not limited to the above, and the divided number of the light receiving face of the photodetector 31 can be increase to double (eight-divided photodetector). By adopting the this photodetector 31, it is possible to identify the information units based on the light receiving signals from the eight-divided light receiving faces. With this structure, as compared to the case of adopting the four-divided photodetector, it is possible to simplify the calculation process of identifying the information unit 5. As a result, the total received light amount comparison circuit 43 and the partial light amount comparison circuit 44 can be realized by circuits of simpler structure, thereby reducing the cost, for the disk device of the present invention.

Incidentally, when the reflected lights from the phase pits 3 and 4 which constitute the information unit 5 are contaminated into the focusing signal (focus servo signal) generated by the focusing/tracking circuit 47, the focusing (focus servo) would be disturbed.

In response, it is preferable to remove the high frequency signal components corresponding to the phase pits 3 and 4 from the focusing signal through this low pass filter. As a result, it is possible to perform focusing under stable conditions.

Incidentally, the disk device of the present invention shown in FIG. 14 may be arranged such that the control section informs the synchronous signal generation circuit 48 (or the synchronous signal generation circuit 48 informs the synchronous signal generation circuit 48) if the light receiving signals R1 to R4 (or R1 to R6) obtained from the photodetector 31 correspond to the synchronous unit 61 (if the beam spot 6 scans the synchronous unit 61).

With this arrangement, it is preferable that the optical disk 1 be arranged such that a dummy special pattern which does not actually exist (the pattern for generating a peculiar reflected light) be formed in the pre-stage of the synchronous region DA, as the information unit 5 (or the synchronous unit 61).

According to the foregoing structure, by detecting the peculiar reflected from the photodetector 31, the control section or the synchronous signal generation circuit 48 can see the scanning timing of the synchronous region DA.

Specifically, for the foregoing pattern, for example, three marginal regions of the information unit 5, which does not exist as the information unit 5 (regions without pits), etc., may be adopted.

In the present embodiment, the control photodetector 29 is provided separately from the photodetector 31. However, the present invention is not intended to be limited to this structure. For example, it may be arranged such that the photodetector 31 functions also as the control photodetector 29. In this case, the focusing/tracking circuit 47 generates a servo signal based on the light receiving signal as outputted from the photodetector 31.

In the following Examples 5 to 9, concrete examples for manufacturing the optical disk 1 and reproducing information from the optical disk 1 of FIG. 13 are shown.

### EXAMPLE 5

In a recording region KR on the spiral information track 2 formed on the optical disk 1, the information units 5 made up of pit arrays shown in FIG. 9 and FIG. 13 are regularly arranged at pitches (intervals) of 350 nm.

The phase pits 3 and 4 respectively provided at respective apexes of the square and the center of the square on the information track 2 are formed on a recording surface of a transparent substrate 7 made of polycarbonate in depth of 40 nm by the injection molding method.

The phase pits 3 and 4 having a diameter of 60 nm are formed at pitches of 100 nm.

On the synchronous region DA in the information track 2, formed are synchronous units 61 shown in FIG. 1. Each of the synchronous units 61 is formed in an oval shape with a width (length in the radius direction) of 160 nm, and a length (length in a circumferential direction) of 160 nm and a depth of a circular pit of 40 nm. These synchronous units 61 are formed at equal intervals at pitches of 350 nm.

The synchronous unit 61 is formed in the pre-stage of each of the 12800 information units 5.

For the patterning of the master panel for forming the transparent substrate 7 having formed thereon the information unit 5 (phase pits 3 and 4) and the synchronous unit 61, an electron beam exposure device is adopted.

Here, for the synchronous units 61, by reciprocating the focused electron beam in a direction vertical to the information track 2 (radius direction), relatively large phase pits are formed. On the other hand, for the information unit 5, by emitting the focused electron beam which permits exposure onto respective positions where the phase pits 3 and 4 are to be formed, relatively small phase pits are formed.

Then, from the master panel, the stamper for the optical disk is formed, and the transparent substrate 7 is formed by carrying out the injection molding using this stamper.

Next, on the transparent substrate 7 having formed thereon the foregoing information units 5 and the synchronous units 61, the metal reflective film 8 made of aluminum is formed by sputtering in a thickness of 50 nm. Furthermore, on this metal reflective film 8, the polycarbonate sheet is laminated as the protective film 9 in a thickness of 0.1 mm by ultraviolet tray curing resin.

The optical disk 1 thus prepared is set in the disk device of the present invention as shown in FIG. 14. In this example, for the semiconductor laser light source 21, a semiconductor laser device having a wavelength of 405 nm is adopted. For the condenser lens 24 for condensing the laser light L onto the optical disk 1, a lens with the number of apertures (NA) of 0.85 is adopted. Incidentally, the laser light L is projected from the side of the protective film 9 of the optical disk 1.

When reproducing, the focusing is performed by the astigmatic method so that the laser light L is converged onto the metal reflective film 8 by the control section, the control photodetector 29 and the focusing/tracking circuit 47 based on the light receiving signals R5 to R8. On the other hand, the tracking of the information track 2 is performed with the beam spot 6 by the push-pull method.

The synchronous signal generation circuit 48 generates the synchronous signal S based on a total amount of signal outputted from the photodetector 31 when passes through the synchronous unit 61. Then, using the synchronous signal S as generated, a reproducing operation is performed with respect to the information unit 5.

Here, by the total received light amount comparison circuit 43 and the partial light amount comparison circuit 44, the respective light receiving signals R1 to R4 of divided light receiving faces D1 to D4 of the photodetector 31 are processed under the identification conditions shown in Table 9. As a result, pit arrays of 32 kinds (5-bits) for the information units 5 can be identified, and the 5-bit data can be demodulated.

Similarly, the pit arras for the information units 5 can be identified also in the identification method shown in Table 10. In this case, in the final step for the identification by the total received light amount comparison circuit 43, total reflected light amounts of only four kinds at a maximum are identified. It is therefore possible to reproduce recorded information from the information unit 5 under more stable conditions as compared to the case of adopting the identification method of Table 9.

### EXAMPLE 61

An optical disk 1 of this example 6 is prepared by forming the information units 5 having the pit arrays shown in FIG. 18 in the structure of the optical disk 1 of Example 5.

In the optical disk 1 of the present example, phase pits 3 are provided at respective apexes of the equilateral hexagon, and the phase pit 4 is provided at the center of the hexagon, and one of the diagonal lines which divide the hexagon into halves is overlapped with the information track 2. As in the case of Example 5, a diameter of each of the phase pits 3 and 4 is selected to be 60 nm, and these phase pits are formed at pitches of 100 nm in the depth of 40 nm.

The optical disk 1 of this example thus prepared is set in the disk device shown in FIG. 14 of the present embodiment as in the Example 5, and using the synchronous signals S generated by the synchronous signal generation circuit 48, the recorded information is reproduced from the information unit 5 is performed. With this structure, the pit arrays in each information unit 5

As a result, by adopting the six-divided photo-detecting element for the photodetector 31, the pit array for each information unit 5 can be identified, and the 7-bit data can be modulated in the same manner as the Example 5.

### EXAMPLE 7

In the structure of the optical disk 1 of Example 5 and Example 6, the synchronous units 61 are formed at equal intervals at pitches of 700 nm.

In this example, when passing the synchronous unit 62, the synchronous signal generation circuit 48 generates the synchronous signal S whose frequency is one half of that of the light receiving signal based on the total light receiving signal outputted from the photodetector 31, the synchronous unit 61.

As a result of reproducing recorded information from the foregoing optical disk 1 of the present Example, the pit array of each information unit 5 can be identified as in the case of Examples 5 and 6.

### EXAMPLE 8

In the structure of the optical disk 1 of Examples 5 and 6, the optical disk 1 having formed thereon the synchronous units 61 shown in FIGS. 19 and 20 is prepared as the optical disk 1 of this Example. In the optical disk 1 of the present embodiment, adopted is the synchronous units 61 which are made up of the pit arrays as those of the information unit 5 (all the phase pits 3 and the phase pit 4 are the same).

Incidentally, these synchronous units 61 are arranged at equal intervals of 350 nm pitches.

As a result of reproducing recorded information from the foregoing optical disk 1 of the present Example in the same manner as the Examples 5 and 6, the synchronous signal S can be generated based on the reflected light from the synchronous units 61, and the pit array of each information unit 5 can be identified as in the case of Examples 5 and 6.

### EXAMPLE 9

In the structure of the optical disk 1 of Example 8, the synchronous units 61 are formed at equal intervals at pitches of 700 nm, to prepare the optical disk 1 of the present Example.

As a result of reproducing recorded information from the foregoing optical disk 1 of the present Example in the same manner as the Example 7, the synchronous signal S can be generated based on the reflected light from the synchronous units 61, and the pit array of each information unit 5 can be identified as in the case of Example 8.

An optical memory device of the present invention wherein a) a recording region KA, in which a plurality of information units 5 having recorded thereon information corresponding to pit arrays are formed, and b) a synchronous region for use in generating the synchronous signal S are formed along a recording track 2 may be arranged such that the pit array of each information unit 5 in the recording region KA is made up of a combination of a phase pit 4 at a center and phase pits 3 located surrounding the phase pit 4 in the information track 2, and a plurality of synchronous units 61 are arranged at equal intervals in the synchronous region DA.

The present invention also concerns the optical memory device in which information is recorded using phase pits, and the reproducing device at least capable of reproducing recorded information by the light beam.

It is an object of the present invention to provide an optical disk (optical memory device) capable of reproducing therefrom recorded information without requiring reproducing circuits of the complicated structure with accuracy under stable conditions and to provide the optical disk (optical memory device) on which information are recorded at high intensity.

In the conventional optical disk, asymmetric recording units (information units) are formed, with the information track sandwiched in between in the radius direction of the optical disk. With this conventional structure, a push-pull signal for tracking is liable to be disturbed, which disturbs tracking when passing the asymmetric recording units each time, and a reproducing error is therefore liable to increase.

To realize a high density optical disk, the arrangement of the phase pits in the information unit is an important factor for reproducing recorded information from the information unit under stable conditions.

For the reproduction photodetector 31, it is preferably arranged such that one of two parting lines for dividing six-divided photo-detecting elements D1 to D6 crosses the straight lien X-X′ corresponding to the information track 2 at right angle.

Conventionally, it is preferable that a reproducing operation of reproducing recorded information from the information unit 100 made up of a plurality of pits 101, information unit 100 be performed such that when a center of a light beam spot is on the information unit 100 to be reproduced, the pit array is identified based on the light receiving state of the light receiving faces D1 to D8 and readout the recorded information. It is therefore preferable that a high precision synchronous signal be adopted when reproducing.

Incidentally, the control photodetector 29 shown in FIG. 2 may be arranged so as to generate a focusing signal by the astigmatic method, and generates a tracking signal by the push-pull method, based on the reflected laser light La. In this case, focusing/tracking circuit 47 drives the actuator 25 by the focusing signal and the tracking signal generated by the control photodetector 29, and performs the focusing and the tracking. In the structure of the pit arrays of FIG. 9 wherein phase pits 3 and 4 are provided respectively at apexes of the square, it is preferable that one of the diagonal lines be overlapped with the information track. With this structure, the pit array of the information unit which is axisymmetric (line symmetry) about the information track can be formed with ease. In the case of performing a tracking control by the pus-pull method, etc., based on the reflected light from the information unit, for the pit arrays which are not symmetrical in the radius direction, the respective intensities of the reflected lights from both sides of the information track become asymmetric, and a push-pull signal is disturbed, resulting in a problem that an accurate tracking control cannot be performed (tracking becomes unstable).

The symmetry identification factor of the pit array shown in FIG. 1 will be explained. Namely, the symmetry identification factor indicates the symmetry of the apexes of the hexagon made up of adjacent two phase pits, and the positions of the apexes symmetrical about the center of the hexagon. As illustrated in FIG. 7, symmetric characteristics of the apexes P1 and P2, and apexes P4 and P5 are taken into consideration, and it is determined the pit array to be determined to be symmetrical when phase pits 3 are provided at both of the apexes P1 and P2, and the phase pits 3 are provided at both of the apexes P4 and P5. It is also determined the pit array to be symmetrical when the phase pit 3 exists at either one of the apex P1 and the apex P2, and the phase pit 3 exits at either one of the apex P4 and the apex P5. Similarly, it is determined the pit array to be symmetrical when the pit array 3 is not provided at neither of the apexes P1 and P2, or neither of the apexes P4 and P5.

The numbers 0, 1, or 3 for the symmetry identification factor indicates the number of symmetric patterns in the information unit 5, which are important factors for the identification of the information unit 5. According to the optical disk 1 of the present embodiment, a plurality of information units are formed in the information track, each of the information unit being made up of a phase pit provided at the center of the information unit, and phase pits provided in the shape of hexagon with the center of the information unit as a center-of-gravity; one of the diagonal lines dividing the hexagon is overlapped with the information track; and the symmetric characteristic of the phase pits 3 and 4 in the information unit 5 are identified, whereby the information unit 5 can be identified with ease, and information of 128 kinds (7-bit data) can be multiplex-recorded for each information unit 5, thereby realizing a high capacity optical disk.

The disk device of the present embodiment is characterized by including:

light irradiation means for irradiating the information unit 5 of the optical disk 1 with laser light;

an optical system in which one of the parting lines which divide the six-divided photo-detecting elements for detecting the reflected light from the information unit 5 crosses the straight line corresponding to the information track at right angle;

reproducing means for reproducing recorded information by identifying the information unit based on an optical detection signal of the six-divided photo-detecting elements.

In the present invention, by adopting the foregoing six-divided photo-detecting element, the comparison of the optical detection signals can be performed using the comparative circuit of a simple structure, and it is therefore possible to identify the information unit 5 with ease.

For the arrangement of the six-divided photo-detecting element, explanations have been given through the case wherein one of the parting lines which divide the six-divided photo-detecting element crosses the straight line corresponding to the information track at right angle.

However, the present invention is not intended to be limited to the foregoing, and the arrangement wherein on of the parting lines is on the straight line corresponding to the information track may be adopted, and when adopting the foregoing structure, it is also possible to identify the information unit 5 by carrying out the same identification process.

With the foregoing structure, however, one of the parting lines is on the straight line corresponding to the information track, and these parting lines are on the positions corresponding to the phase pits, namely, the parting lines are provided at positions subjected to the maximum changes in light intensity, a problem arises in that the detection precision of the light intensity distribution by the photo-detection element is lowered. In view of an improvement in detection precision, it is therefore preferable that one of the parting lines which divide the six-divided photo detecting element be cross the straight line corresponding to the information track at right angle.

Incidentally, the number of the divided light receiving faces for the reproducing photodetector 31 can be increased to double, i.e., twelve, and twelve-divided photo-detecting element may be adopted to identify the information unit 5 based on an output from each of the photo-detecting elements.

According to the present invention, by adopting the six-divided photo-detecting element, the calculation for identifying the information unit 5 can be simplified, and the information unit 5 can be identified by the circuit of more simplified structure, thereby reducing the cost for the reproducing device.

As described, the present invention is directed to the optical memory device wherein information are recorded using the phase pits 3 and 4, and a reproducing device at least capable of reproducing recorded information by the light beam.

Conventionally, when reproducing recorded information from the information unit 5 made up of a plurality of pits, the pit array is identified when the center of the light beam spot formed on the information unit 5 is substantially at the center of the light beam, and the recorded information are reproduced.

It is therefore necessary to adopt a high precision synchronous signal when reproducing.

To realize a high density optical disk, the arrangement of the phase pits is an important factor for reproducing recorded information from the information unit under stable conditions.

The arrangement of FIG. 13 may be arranged as follows. Namely, a plurality of phase pits 3 are provided in the square at equal dissonance from the center of the square, and one of the diagonal lines of the square is overlapped with the information track 2. Furthermore, along the information track 2, a plurality of synchronous units 61 are provided at equal interval in ahead of the recording region KA in which a plurality of information units 2 are formed. In the structure of FIG. 13, for the phase pits of the synchronous unit 61, larger phase pits than the phase pits 3 and 4 for the information unit 5 are adopted.

According to the disk device of FIG. 14, the photodetector 31 receives the reflected light from the information unit 5 and detects the intensity distribution of the reflected light from each of the photo-detecting elements (divided light receiving faces) D1 to D4, and identifies the information unit using the output signals (light receiving signals) R1 to R4 from respective photo-detecting elements.

According to the optical disk 1 having the structure of FIG. 13, the information units 5 are regularly arranged in the spiral information tracks 2 wherein each of the information units 5 is made up of a plurality of phase pits 3 provided at apexes of the square one of the diagonal lines of which is on the information track 2, and the phase pit 4 provided at the center of the square. With this structure, information of 32 kinds (5-bit data) can be multiplex-recorded for each information unit 5, thereby realizing a high capacity optical disk.

The disk device of the present embodiment shown in FIG. 14 includes light irradiation means for irradiating the information unit 5 of the optical disk 1 with laser light; an optical system in which the reflected light from the information unit 5 is incident on the reproduction photodetector (photodetector 31) made up of the four-divided photo-detecting element in which one of the parting lines forms an angle of 45° with the straight line X-X′ corresponding to the information track 2; and reproducing means for reproducing recorded information by identifying the information unit 5 based on a photo-detection signal of the four-divided photo-detecting element.

According to the foregoing structure of the present invention, by adopting the four-divided photo-detecting element, the calculation for identifying the information unit 5 can be simplified, and the information unit 5 can be identified by the circuit of more simplified structure, thereby reducing the cost for the reproducing device.

Next, the Table 10 will be explained. The partial light amount comparison circuit 44 is provided for executing the identification process of the symmetric characteristic under the conditions I, II and II. Specifically, the partial light amount comparison circuit 44 compares respective intensities of T1 and T2 under the symmetric characteristic identification condition I, compares respective intensities of S1 and S3 under the symmetric characteristic identification condition II, and compares respective intensities of S2 and S4 under the symmetric characteristic identification condition III.

By the foregoing intensity comparison, with respect to the information units 5 which are divided into small groups, the respective total reflected light amounts are identified by the total received light amount comparison circuit 43, and the identification process for each of the information units 5 is completed.

In this case, the kinds of the total reflected light amounts to be identified in each small group are two kinds or four kinds.

According to the identification method shown in Table 9, first, it is required to identify the total reflected light amounts of 10 kinds (a to j), and a high precision comparative circuit is required. Moreover, the total reflected light amount changes even with very small amount of change in the laser light L, which may cause a problem that the pit array of the information unit 5 is difficult to be identified.

In contrast, according to the identification method of Table 10, it is therefore possible to identify the total reflected light amounts with higher precision by the total received light amount comparison circuit 43 as compared to the case of Table 9 wherein the total reflected light amounts of 10 kinds (a to j) are to be identified, and the total reflected light amount changes with small change in laser amount, which makes the identification of the information unit 5 difficult. Further, as the number of kinds of the total reflected light amounts to be compared is reduced, and the information unit 5 can be identified by the comparative circuit of simple structure. As a result, the reproducing device which permits the information unit 5 to be identified accurately irrespectively of changes in amount of laser light can be realized at low cost.

In the disk device shown in FIG. 14, the synchronous signal S may be generated in the following manner. The synchronous signal S is generated by a plurality of synchronous units 61 which are provided along the information track 2 at equal intervals. By detecting the state of reflected light which the light beam spot 6 moves over the synchronous unit 61 by the photodetector 31, a synchronous signal is generated. FIG. 16 shows changes in signal of (R1+R2+R3+R4) when the light beam spot 6 moves over the information track 2. In FIG. 16, DT indicates a signal amplitude of a total amount of signal when the light beam spot 6 passes over the synchronous unit 61. Here, the synchronous signal generation circuit 48 is made up of the binarization circuit, the phase comparator, the LPF and the VCO. The synchronous signal generation circuit 48 generates the synchronous signal S based on the total amount of signal outputted from the photodetector 31 when the light beam spot passes over the synchronous unit 61.

The synchronous unit 61 shown in FIG. 19 and FIG. 20 are made up of a plurality of phase pits located at predetermined positions.

Generally, the synchronous unit 61 is formed in the specific area in the disk. As disclosed in the patent document 2, the synchronous unit 61 is formed at the leading end position of each sector obtained by dividing one circle of the spiral information track into small sectors with an array of recording information units. In this synchronous unit 61, a synchronous signal S is generated, and using the resulting synchronous signal S, the information unit 5 is reproduced with accuracy. Here, the focusing control is generally performed on the steady basis. In this focusing control, with a contamination of a signal from the phase pits which constitute the recorded information unit to the focus servo signal, the focus servo would be disturbed. However, by removing the high frequency components corresponding to the phase pits through the low pass filter, it is possible to perform the focusing control under stable conditions.

Generally, the tracking control is performed regularly. However, reproduction of the recorded information may be performed by obtaining a tracking signal only at the synchronous units 61, and the fixing the position of the condenser lens at the information unit 5.

Incidentally, by forming a patter which does not exist as the recorded information unit string, to make the reflected from the synchronous unit 61 distinguishable from the reflected light from phase pits of the information unit 5, it is possible to identify the-synchronous unit 61. For example, by forming the margin space (the region without pits) for three information units 5 which does not exist as the recorded information unit string, the synchronous unit 61 subsequent to the margin space can be recognized.

The optical reproducing device of the present invention wherein light is emitted onto the information unit of the optical memory device of the present invention, and recorded information is reproduced based on the reflected light may be arranged so as include:

the photodetector which receives reflected light from the information unit and the synchronous unit, and outputs a light receiving signal according to the received amount of light;

the pit array identification circuit for identifying the pit array of the information unit to be reproduced based on the light receiving signal from the information unit; and

the synchronous signal generation circuit which generates a synchronous signal for reproducing the information unit based on the light receiving signal from the synchronous unit.

The optical memory device and the optical memory device reproducing device of the present invention may be arranged as the following first to thirteenth optical memory devices and the first through seventh optical memory device reproducing devices.

The first optical memory device of the present invention wherein a plurality of information units are formed in the information track is arranged such that each of the information units is made up of a phase pit provided at the center of the information unit, and phase pits provided at the same distance from the center of the information unit.

According to the first optical memory device, the phase pits of each of the information units is made up of a phase pit provided at the center of the information unit, and phase pits provided at the same distance from the center of the information unit, a plurality phase pits can be efficiently arranged within the light beam spot of substantially circular shape of an incident light for reproducing, thereby realizing a high capacity optical device from which the recorded information can be reproduced under stable conditions.

The second optical memory device having the arrangement of the foregoing first optical memory device is arranged the phase pits provided at the same distance from the center of the information unit are arranged in the shape of hexagon with the center of the information unit as a center-of-gravity; one of the diagonal lines dividing the hexagon is overlapped with the information track.

According to the second optical memory device, the phase pits provided at the same distance from the center of the information unit are arranged in the shape of hexagon with the center of the information unit as a center-of-gravity, and the plurality of phase pits are arranged within the optical beam spot of the incident light for reproduction at the highest density. As a result, the information can be multiplex recorded in each of the information units at the maximum intensity, and a high capacity optical memory device can be realized.

The third optical memory device having the structure of the foregoing first optical memory device is arranged such that the phase pit pattern for each of the information units is a specific phase pit pattern selected from all the possible phase patterns defined based on with/without a phase pit at each position.

According to the third optical memory device, the phase pit pattern is a specific phase pit pattern selected by an appropriate selection means, (a) the identification of the information units by comparing the total reflected light amount by the reproduction photodetector and (b) the identification of the information units by comparing light intensity distributions on the reproduction photodetector can be performed by the comparison means of simple structure. As a result, the identification precision can be improved, and the comparative circuit of simplified structure can be adopted, thereby realizing optical memory device at low cost.

The fourth optical memory device having the structure of the third optical memory device is arranged such that the phase pit pattern is selected according to the total reflected light amount of the light beam incident on each of the information units.

According to the fourth optical memory device, the phase pit pattern is selected by the total reflected light amount of the light beam incident on each of the information units without using the information unit having a specific total reflected light amount. With this structure, the number of groups, each being made up of the information units having substantially the same total reflected light amounts, can be reduced, and differences in total reflected light amounts among the groups can be increased.

As a result, the identification can be performed with high precision using the total reflected light amount comparison circuit of a simple structure.

The fifth optical memory device having the structure of the foregoing third optical memory device is arranged such that the pit array pattern is symmetrical.

According to the fifth optical memory device wherein the pit array pattern is symmetrical, by determining the symmetric characteristic of array pattern, i.e., light intensity distributions on the reproduction photodetector, it is possible to identify the information units. With this structure, it is only required to identify the light intensity level for the comparison circuit, and it is therefore possible to identify each information unit with high precision by the comparative circuit of a simple structure.

The first optical memory device reproducing device for reproducing recorded information from the first to the fifth optical memory devices is arranged so as to include:

light irradiation means for irradiating the recording unit of the optical memory device with the reproducing light; and an optical system for directing the reflected light from the recording unit to the reproduction photodetector; and

the optical system for directing the reflected light from each recording unit to the reproduction photodetector, wherein the reproduction photodetector is made up of a plurality of divided photo detecting elements, and

the first optical memory device reproducing device further includes reproducing means for reproducing recorded information by identifying each information unit based on a photo-detection signal from each of the divided photo detecting elements.

According to the foregoing first optical memory device reproducing device, the reproducing light is emitted onto the optical memory device so that the reflected light can be incident on the divided photo-detecting faces of the photo-detecting element, and each information unit is identified based on a photo-detecting signal obtained from each of the divided photo-detecting faces, thereby reproducing information multiplex recorded on the optical memory device.

The optical memory device reproducing device having the structure of the foregoing first optical memory device reproducing device is arranged such that the optical system is provided with the control photodetector for generating the focusing signal and the tracking signal which is separately provided from the reproduction photodetector, wherein the reflected lights from each of the information units are separated into the reflected light to be incident on the reproduction photodetector and the reflected light to be incident on the control photodetector.

According to the foregoing second optical memory device reproducing device wherein the control photodetector is provided separately from the reproduction photodetector, it is possible to make an appropriate reflected light incident on a plurality of divided photo-detecting faces of the reproduction photodetector. As a result, an occurrence of an error can be suppressed when identifying each of the information units, thereby realizing the optical memory device in which a reproduction error is less likely to occur. The reflected light to be incident on the control photodetector is emitted via the cylindrical lens for focusing, and in this case, the wave front of the reflected light to be incident on the control photodetector is disturbed.

Therefore, when using the common photodetector for the reproduction and the control, the reflected light whose wave front is disturbed is also incident on the reproduction photodetector via the cylindrical lens, the light intensity distribution is disturbed on the reproduction photodetector, and the information units cannot be identified with precision. In response, by separately providing the reproduction photodetector and the control photodetector, the light intensity distribution on the reproduction photodetector is not disturbed, and the information units can be identified with precision.

The optical memory device reproducing device having the foregoing structure of the first optical memory device reproducing device is arranged such that the reproduction photodetector is a six-divided photo-detecting element.

According to the foregoing third optical memory device reproducing device, by adopting the six-divided photo detecting element for the reproduction photodetector, the required process for identifying the information units can be simplified; respective structures of the circuits for comparing total signals which input to the reproduction photodetector and for comparing light amounts of respective divided photo-detecting faces of the reproduction photodetector can be simplified; in the meantime, the time required for identifying each of the information units can be reduced; and the reduction in cost for the optical memory device reproducing device by reducing the size of the circuits.

The fourth optical memory device reproducing device having the structure of the foregoing third optical memory device reproducing device is arranged such that one of the parting lines which divide the six-divided photo-detecting element crosses the straight line corresponding to the information track at right angle.

According to the foregoing forth optical memory device reproducing device, one of the parting lines which divide the six-divided photo-detecting element crosses the straight line corresponding to the information track at right angle, and the parting lines do not exist at positions corresponding to the phase pits. With this structure, the light intensity distribution of the reproduction photodetector based on if a phase pit is provided in each position can be detected with accuracy, and it is therefore possible to identify the total reflected light amount with high precision, and also, the respective intensities of the lights incident of the divided photo-detecting element can be compared with high precision. As a result, an occurrence of a detection error in determination of the information units can be suppressed.

The fifth optical memory device reproducing device having the structure of the first optical memory device reproducing device, is arranged such that:

the means for identifying the information units compares the total amount of signals obtained by adding the photo detection signals of the plurality of divided photo-detecting element, to divide the information units into groups, and then compares levels of the photo detecting signals from the plurality of the photo-detecting elements to identify each of the information units.

According to the fifth optical memory device reproducing device, the total amount of signals obtained by adding the photo detection signals from the plurality of divided photo-detecting element are compared to divide the information units into groups, and then compares levels of the photo detecting signals from the plurality of the photo-detecting elements to identify each of the information units, thereby reproducing recorded information.

The sixth optical memory device wherein information units, each being made up of a plurality of phase pits arranged at predetermined positions are provided at equal intervals on the information track, is arranged such that a plurality of synchronous units are provided at equal intervals in the information track.

According to the foregoing sixth optical memory device, it is possible to generate a synchronous signal by the reflected light from the synchronous unit with respect to the information track. As a result, it is possible to regularly provide the synchronous signal under stable condition, and to identify the information unit with high precision by adopting this synchronous signal.

The seventh optical memory device having the structure of the sixth optical memory device is arranged such that such that each of the information units is made up of a phase pit provided at the center of the information unit, and phase pits provided at the same distance from the center of the information unit.

According to the foregoing optical memory device, the phase pits of each of the information units is made up of a phase pit provided at the center of the information unit, and phase pits provided at the same distance from the center of the information unit, a plurality phase pits can be efficiently arranged within the light beam spot of substantially circular shape of an incident light for reproducing, thereby realizing a high capacity optical device from which the recorded information can be reproduced under stable conditions in addition to the effect of identifying the information unit with accuracy.

The eighth optical memory device having the structure of the seventh optical memory device, is arranged such that in the information unit, the phase pits provided at the same distance from the center of the information unit are arranged in the shape of square with the center of the information unit as a center-of-gravity; one of the diagonal lines dividing the square is overlapped with the information track.

According to the eighth optical memory device, the phase pits provided at the same distance from the center of the information unit are arranged in the shape of square with the center of the information unit as a center-of-gravity, and the plurality of phase pits are arranged within the optical beam spot of the incident light for reproduction at the highest density. As a result, the information can be multiplex recorded in each of the information units at the maximum intensity, and a high capacity optical memory device can be realized, in addition to the effect of identifying the information unit with accuracy.

The ninth optical memory device having the structure of the seventh optical memory device is arranged such that in the information unit, the phase pits provided at the same distance from the center of the information unit are arranged in the shape of hexagon with the center of the information unit as a center-of-gravity; one of the diagonal lines dividing the hexagon is overlapped with the information track.

According to the second optical memory device, the phase pits provided at the same distance from the center of the information unit are arranged in the shape of hexagon with the center of the information unit as a center-of-gravity, and the plurality of phase pits are arranged within the optical beam spot of the incident light for reproduction at the highest density. As a result, the information can be multiplex recorded in each of the information units at the maximum intensity, and a high capacity optical memory device can be realized, in addition to the effect of identifying the information unit with accuracy.

The tenth optical memory device reproducing device having the structure of the sixth optical memory device is arranged such that the phase pits for the synchronous units are arranged at larger intervals than the phase pits which constitute the information unit.

According to the foregoing structure, changes in reflected light from the synchronous unit can be made larger, and it is possible to identify each of the information units more accurately.

The eleventh optical memory device having the sixth optical memory device is arranged such that each of the synchronous units is made up of a plurality of phase pits provided at predetermined positions.

According to the foregoing structure, a phase pit of the same shape can be adopted for the phase pits for the synchronous unit and the phase pits for the information unit. With this structure, when forming the original substrate for the optical memory device, the respective phase pits for the synchronous unit and for the information unit can be formed under the same conditions, and the required control conditions for forming the master for the optical memory device can be reduced. As a result, the master for the optical memory device and the optical memory device can be formed under stable conditions.

The twelfth optical memory device having the structure of the foregoing eleventh optical memory device is arranged such that the phase pit array of the synchronous unit is the same as the phase pit array of the information unit.

According to the foregoing structure, when forming the master for the optical memory device, the respective phase pit arrays can be formed under the same conditions, and the required control conditions for forming the master for the optical memory device can be reduced. As a result, the master for the optical memory device and the optical memory device can be formed under stable conditions.

The thirteenth optical memory device having the structure of the twelfth optical memory device is arranged such that the synchronous unit is made up of phase pits provided at all the positions in which phase pits are to be formed.

According to the foregoing structure, changes in reflected light from the synchronous unit are increased, and it is therefore possible to identify the information unit more accurately.

The sixth optical memory device reproducing device for reproducing recorded information from the sixth to the thirteenth optical memory devices is arranged so as to include:

light irradiation means for irradiating the recording unit of the optical memory device with the reproducing light; and an optical system for directing the reflected light from the recording unit to the reproduction photodetector; and

the optical system for directing the reflected light from each information unit to the reproduction photodetector, wherein the reproduction photodetector is made up of a plurality of divided photo detecting elements, and

the sixth optical memory device reproducing device further includes reproducing means for reproducing recorded information by identifying each information unit based on a photo-detection signal from each of the divided photo detecting elements.

According to the foregoing structure, respective information units are identified based on the state of the reflected lights of the lights incident on the divided plurality of photo-detecting faces of the photo-detecting element, and it is therefore possible to provide the optical memory device reproducing device of the present invention which permits recorded information to be reproduced under stable conditions.

The seventh optical memory device reproducing device for reproducing recorded information from the optical memory device of the foregoing structure is arranged such that the synchronous signal is generated based on the reflected light from the synchronous unit. According to the foregoing structure, the synchronous signal is generated based on the reflected light from the synchronous unit, and it is therefore possible to provide the optical memory device reproducing device of the present invention for reproducing the recorded information from the optical memory device of the present invention more accurately.

As described, the optical memory device (optical disk) of the present invention, in which a plurality of information units in which information are recorded according to the pit arrays, is characterized in that:

the pit array of each information unit is made up of a phase pit provided at the center of the information unit, and phase pits provided surrounding the phase pit at the center.

For the optical memory device of the present invention, recording medium from which recorded information are read out by projecting light such as DVD(Digital Versatile Disc), CD(Compact Disk), or other optical disks, optical cards, etc., may be adopted.

According to the optical memory device of the present invention, the information are recorded on the information track by forming the information units, each being made up of phase pits.

The phase pit is a protrusion (or a recession) formed on the substrate of the optical memory device, and the reflectance of light of such phase pit differs from the reflectance of light of the flat pat of the substrate (where the phase pit is not formed).

Incidentally, the information unit is a unit for recording information in the optical memory device, each being made up of a group of phase pits.

Namely, according to the optical memory device of the present invention, the information (recorded content) of each information unit is determined by a combination of the number and the position of the pits (pit array).

When reproducing recorded information from the optical memory device, based on the reflected light from the information unit, it is possible to identify the pit array of the information unit.

According to the optical memory device, the pit array of the information unit is made up of a phase pit provided at the center of the information unit and the phase pits surrounding the center of the information unit.

According to the optical memory device of the present invention, as compared to the case wherein the pit array is made up of phase pits surrounding the phase pit at the center, the recording density can be significantly improved.

According to the optical memory device of the present invention, the phase pit is provided at the center of the surrounding phase pits. As a result, the phase pits can be provided at high density, and the recording density can be still improved.

According to the optical memory device of the present invention, the number of divided light receiving faces (partial light receiving faces) required for reproducing information is set in the number of the surrounding phase pits.

Namely, for example, in the case where the pit array of the information unit is made up of only six surrounding phase pits, the intensity distribution of the reflected light from the information unit corresponds to the shape of the hexagon (the phase pits form a shape of the hexagon when all the phase pits are provided).

Accordingly, the reproduction photodetector for use in reproducing the recorded information, when light receiving face is divided into six corresponding to the six surrounding phase pits, and the photodetector having six divided light receiving faces is adopted.

Generally, the six divided light receiving faces are obtained by dividing by the three parting lines which pass through the center of the reproduction photodetector, and these six divided light receiving faces are in the shape of a fan that radically expands from the center of the reproduction photodetector.

The reproduction photodetector determines with or without the surrounding phase pit for the six surrounding phase pits in the information unit (the location(s) of the surrounding phase pit(s)) according to the intensity of the reflected lights incident on the six divided light receiving faces. The reproduction photodetector then identifies the pit array to be reproduced based on the determination result.

When adopting the phase pit array made of six surrounding phase pits and the phase pit at the center as in the optical memory device of the present invention, the six-divided photodetector made up of six-divided light receiving faces can be adopted.

Namely, the reflected lights from the phase pit 4 have an intensity distribution according to the distance from the center of the reproduction photo-detector (the lights incident at positions apart from the center of the photo photodetector by the same distance have the same intensity). Therefore, the reflected lights having the same intensity distribution are incident respectively on the six divided light receiving faces in the reproduction photodetector 31.

Therefore, when reproducing information from the optical memory disk of the present invention using the six-divided photodetector, it is possible to determine if the phase pit is provided at the center, based on the intensity of the total received light amount by the entire light receiving faces (the total reflected light amount from the entire information unit (pit array)).

As explained earlier, for the surrounding phase pits, it can be determined if the surrounding phase pit is provided at each position based on the intensity of the light incident on each of the six divided light receiving faces.

As described, according to the optical memory device of the present invention which adopts, for the information unit, the phase pit array made up of phase pits in the number of n (n is an integer) including the pit array provided at the center, it is possible to reproduce the recorded information using the divide photodetector whose light receiving face is divided in the number of n-1.

As a result, the present invention provides the optical memory device which permits information to be recorded at high density and the recorded information to be reproduced without requiring the reproduction circuits of complicated structure.

It is preferable that the optical memory device of the present invention be arranged such that the surrounding phase pits are provided at the same distance from the central phase pit.

According to the foregoing structure, within the light spot formed on the information unit to be reproduced, all the phase pits can be arranged efficiently (high density). As a result, the light spot for reproduction can be made smaller.

It is preferable that the optical memory device of the present invention be arranged such that the surrounding phase pits are provided at apexes of the hexagon with the central phase pit at the center of the hexagon.

According to the foregoing structure, the information (7-bit data) of 128 (27) kinds can be multiplex-recorded for each information unit. Therefore, as compared to the arrangement adopting the pit array made up of a combination of only six surrounding phase pits, the recording density can be significantly raised.

According to the foregoing structure wherein the phase pits are provided at apexes of the hexagon and the center (center-of-gravity) of the hexagon, the phase pits can be arranged at the maximum density.

As described, according to the optical memory device of the present invention, as a large number of information units can be formed, the recording density of the optical memory device can be increased. Furthermore, the light spot for reproduction can be reduced.

In the case of adopting the pit array made up of seven phase pits located at apexes of the heptagon, the intensity distribution of the reflected light from the information unit 5 corresponds to the shape of the heptagon (the shape of the heptagon is formed when the pixel array is made up of seven phase pits). Therefore, it is necessary to provide the divided light receiving faces corresponding to these seven phase pits, and to determine if each phase pit is provided based on the intensity of the light incident on each of the seven divided light receiving faces.

With this structure, it is therefore required to divide the light receiving face of the photodetector into seven (the number of divided light receiving faces is seven). Therefore, the circuit for processing the intensity of the light incident on each of these seven divided light receiving faces becomes complicated, which results in an increase in cost.

Incidentally, when adopting the photo-receptor whose light receiving face is divided into seven, an angle formed between the adjacent light receiving faces becomes smaller, and a reproducing error is therefore more liable to occur due to a lower precision in determining the position of each phase pit.

It is preferable that the optical memory device of the present invention be arranged such that the surrounding phase pits are provided at apexes of the square, and the central phase pit is provided at the center of the square.

According to the foregoing structure, the information unit is made up of five phase pits, i.e., four surrounding phase pits and the central phase pit formed on the information track.

According to the foregoing structure, the information (5-bit data) of 32(25) kinds can be multiplex-recorded for each information unit. Therefore, as compared to the arrangement adopting the pit array made up of a combination of only four phase pits 3, the recording density can be significantly improved.

In the case of adopting the pit array made up of five phase pits located at apexes of the pentagon to multiplex record five-bit data, the intensity distribution of the reflected light from the information unit 5 corresponds to the shape of the pentagon (the shape of the pentagon is formed when the pixel array is made up of five phase pits). Therefore, it is necessary to provide the divided light receiving faces corresponding to the five phase pits, and to determine if each phase pit is provided based on the intensity of the light incident on each of these five divided light receiving faces.

With this structure, it is therefore required to divide the light receiving face of the photodetector into five (the number of divided light receiving faces is five). As a result, the circuit for processing the intensity of the light incident on each of the divided light receiving faces becomes complicated, which results in an increase in cost.

Incidentally, when adopting the photo-receptor whose light receiving face is divided into five, an angle formed between the adjacent light receiving faces becomes smaller, and a reproducing error is therefore more liable to occur due to a lower precision in determining the position of each phase pit.

In the structure wherein surrounding phase pits are provided at apexes of the hexagon or the square, it is preferable that one of the diagonal lines be overlapped with the information track.

With this structure, the pit array of the information unit which is axisymmetric (line symmetry) about the information track can be formed with ease.

Namely, it is preferable that the optical memory device be arranged such that the pit array made up of phase pits axisymmetrically arranged about the information track is adopted for the pit array of the information unit.

Generally, when reproducing recorded information from the optical memory device of the present invention, the information track (tracking) is scanned with the light (reproducing light) emitted onto the optical memory device. Such tracking is controlled based on the reflected light from the information unit, for example, by the push-pull method.

In this case, if the pit arrays are not arranged symmetrically in the radius direction, a push-pull signal is liable to be disturbed as the respective intensities of the reflected light from both sides of the information track are not symmetrical, and a problem may arise in that an accurate tracking control cannot be performed (tracking becomes unstable). This in turn causes a problem that the total reflected light amount from each information unit cannot be measured with accuracy, and a pit array cannot be identified accurately.

On the other hand, in the case of adopting only the pit arrays symmetrical arranged in a radius direction, it is possible to surely prevent the foregoing disturbance in push-pull signals. As a result, tracking can be performed under stable conditions.

In the structure wherein the surrounding phase pits are arranged at apexes of the hexagon, it is preferable that only the pit arrays made up of surrounding phase pits in an odd number or the pit arrays made up of surrounding phase pits in an even number be adopted.

When reproducing recorded information from the optical memory device, generally, generally, the pit array is identified mainly based on all the reflected light amount (he total reflected light amount) for the entire information unit (pit arrays). Incidentally, the total reflected light amount changes basically according to the number of phase pits.

In the case where the phase pits are provided at the apexes of the hexagon and at the center of the apex, the kinds of the total reflected light amount are nine kinds in total.

In the case where only the pit arrays made up of surrounding phase pits in an odd number or an even number are adopted, the total reflected light amounts can be made of four (or five) kinds. Furthermore, a difference in the total reflected light amount (a range of one step) can be increased.

With the foregoing structure, when reproducing, the total reflected light amount can be identified accurately with ease. As a result, the structure of the apparatus for measuring the total reflected light amount can be simplified.

In the structure wherein the surrounding phase pits are provided at apexes of the hexagon, it is preferable that the pit array of the information unit be symmetrical about the one of the diagonal lines passing through the center of the hexagon.

According to the foregoing structure, it is possible to identify the total reflected light amount accurately without being affected by certain fluctuations in intensity of the reproducing light.

In the arrangement of reproducing recorded information from the memory element having the information units made up of a plurality of pits as in the optical memory device of the present invention, it is preferable that the recorded information be read out at timings the center of the light beam incident on the information unit is substantially on the center of the information unit to be reproduced.

Therefore, when reproducing, it is preferable that a synchronous signal of high precision be adopted for controlling the timing of reading out from the information unit.

Here, it is preferable that a plurality of synchronous units of the same shape be formed at equal intervals along the information track of the optical memory device.

Incidentally, without the synchronous unit, a synchronous signal in sync with the light receiving signal from the information unit is generated (self-clock system).

In this case; however, due to differences in pit arrays of the information units, a phase shift occurs in a light receiving signal obtained from the information unit. Therefore, an error occurs in a synchronous signal as generated based on such light receiving signal.

As a result, when reproducing using such synchronous signal, it is difficult to detect the total reflected light amount accurately from the information unit, and the pit array of the information unit cannot be identified accurately.

In contrast, according to the foregoing structure of the present invention in which the synchronous units are formed, a synchronous signal for use in the reproduction from the information unit can be generated based on the reflected light from the synchronous unit. As a result, a synchronous signal can be generated with high precision, and the information unit can be identified accurately, thereby accurately reproducing information.

It is preferable that the synchronous unit in the optical memory device of the present invention be made up of a larger pattern than the phase pits of the information unit.

According to the foregoing structure, changes in reflected light from the synchronous unit can be made larger, and it is possible to generate the synchronous signal with ease.

Incidentally, the synchronous unit in the optical memory device of the present invention may be made up of a large size pattern or a plurality of small size patterns.

In the case of adopting the synchronous unit made up of a plurality of small patterns, it is preferable that same phase pits as those adopted in the information unit be adopted.

According to the foregoing structure, as the phase pits (pattern) of the information unit are the same as the phase pits of the synchronous unit, the synchronous units can be formed with ease.

In the case of adopting the phase pits of the information units for the pattern of the synchronous unit, it is preferable that the pattern of the synchronous unit is made up of all the surrounding phase pits and the central phase pit.

According to the foregoing structure, changes in reflected light from the synchronous unit can be made larger, and it is possible to generate the synchronous signal with ease.

Incidentally, it is preferable that the synchronous units be formed at the same pitches (intervals) as the pitches at which the information units are formed in the direction of the information track. With this structure, when generating a synchronous signal based on the light receiving signal from the synchronous unit, the cycle of the synchronous signal can be set to be the same as the light receiving signal. It is therefore possible to simplify the structure of the circuit which generates a synchronous signal. As a result, the reproducing device for reproducing recorded information from the optical memory device can be realized at low cost.

Here, the synchronous units may be formed at intervals twice as long as the intervals at which the information units are formed.

With this structure, changes in reflected light from the synchronous unit can be made larger, and therefore the synchronous signal can be generated with ease based on the light receiving signal obtained by receiving the reflected light. Incidentally, by the difference in cycle of the light receiving signal, it is possible to identify the information unit and the synchronous unit with ease. As a result, the recorded information can be reproduced with an improved precision.

With this structure, a synchronous signal is generated which as a cycle of ½ of the light receiving signal from the synchronous unit for use in the reproduction of the information unit.

For the optical memory device, an optical disk or an optical card may be adopted.

The optical disk has a spiral information track or concentric information tracks. The optical card has an information track formed in a straight line.

The optical reproducing device of the present invention wherein light is emitted onto the information unit of the optical memory device to reproduce the recorded information based on the reflected light, is arranged so as to include:

the reproduction photodetector which receives the reflected light from the information unit and outputs a light receiving signal according to the received amount of light; and

the pit array identification circuit which specifies the pit array of the information unit to be reproduced based on the light receiving signal from the reproduction photodetector.

The optical reproducing device of the present invention for reproducing recorded information from the optical memory device is arranged such that light is emitted onto the information unit of the optical memory device of the present invention, and the pit array of the information unit is identified based on the reflected light, thereby reproducing recorded information.

Namely, according to the optical reproducing device of the present invention, the reproduction photodetector receives reflected light from the information unit and outputs a light receiving signal according to the received amount of light. Then, based on the light receiving signal, the pit array identification circuit specifies the pit array of the information unit (the information unit irradiated with light) to be reproduced.

The optical reproducing device of the present invention may be arranged so as to include the control photodetector separately provided from the foregoing reproduction photodetector. This control photodetector receives the reflected light from the information unit and outputs to the optical control circuit, a light receiving signal according to the received amount of light.

The light control circuit controls the light to be emitted onto the optical memory device based on the light receiving signal from the control photodetector (controls the irradiation position or the focal position of light).

Generally, as the reflected light incident onto the control photodetector is subjected to focusing by the cylindrical lens, the wave front of the reflected light is disturbed. For this reason, in the case where the same photodetector is used both as the control photodetector and the photodetector, the reflected light with uneven wave front is incident on the reproduction photodetector. A problem therefore arises in that the intensity distribution of the light incident on the light receiving face is disturbed, and it is difficult to accurately identify the pit array of the information unit.

In response, according to the structure of the present invention by separately providing the reproduction photodetector and the control photodetector, the light intensity distribution on the reproduction photodetector is not disturbed. As a result, it is possible to accurately control the light, and in the meantime, the recorded information can be reproduced accurately.

As described, when reproducing recorded information from the optical memory device of the present invention wherein the surrounding phase pits are formed at apexes of the hexagon, the six-divided photodetector can be used for the reproduction photodetector.

This six-divided photodetector has six divided light receiving faces obtained by equally dividing the light receiving face into six by the three parting lines.

In such six-divided photodetector, each of the divided light receiving faces outputs a light receiving signal according to the received amount of light to the pit array identification circuit.

Then, based on the light receiving signals from these divided light receiving faces, the pit array identification circuit specifies the pit array of the information unit to be reproduced.

For such six-divided photodetector, it is preferable that the three parting lines which divide the light receiving face of the reproduction photodetector be provided so that any adjacent two parting lines form an angle of 60°. With this structure, as respective divided light receiving faces have the same area, the light receiving signal can be processed by the pit array identification circuit with ease.

It is preferable that the foregoing parting lines of the reproduction photodetector be formed so that any adjacent two parting lines form an angle of 60°, and one of the parting lines crosses the straight line on the light receiving face according to one of the diagonal lines of the hexagon at right angle.

With this structure, it is possible to provide respective centers of the divided light receiving faces at the corresponding phase pits (at position where the intensity of the reflected light from each surrounding phase pit is maximized). Therefore, it is possible to allocate these six divided light receiving faces to the surrounding phase pits with one to one correspondence. It is therefore possible to determine respective surrounding phase pits of six kinds with accuracy by the six divided light receiving faces.

As described, when reproducing recorded information from the optical memory device of the present invention wherein the surrounding phase pits are formed at apexes of the square, the four-divided photodetector can be used for the reproduction photodetector.

This four-divided photodetector has four divided light receiving faces obtained by equally dividing the light receiving face into four by the two parting lines.

In such four-divided photodetector, each of the divided light receiving faces outputs a light receiving signal according to the received amount of light to the pit array identification circuit.

Then, based on the light receiving signals from these divided light receiving faces, the pit array identification circuit specifies the pit array of the information unit to be reproduced.

For such four-divided photodetector, it is preferable that the two parting lines which divide the light receiving face of the reproduction photodetector cross at right angle.

With this structure, as respective divided light receiving faces have the same area, the light receiving signal can be processed by the pit array identification circuit with ease. It is preferable that the foregoing two parting lines of the reproduction photodetector cross at right angle, and form an angle of 45° with the straight line corresponding to one of the diagonal lines of the square of the light receiving face.

With this structure, it is possible to provide respective centers of the divided light receiving faces at the corresponding phase pits (at position where the intensity of the reflected light from each surrounding phase pit is maximized). Therefore, it is possible to allocate these four divided light receiving faces to the surrounding phase pits with one to one correspondence. It is therefore possible to determine if a surrounding phase pit is provided at each position for all the surrounding phase pits of four kinds with accuracy by the four divided light receiving faces.

Incidentally, the pit array identification circuit can be made up of the total received light amount comparison circuit and the partial light amount comparison circuit.

Here, the total received light amount comparison circuit identifies the total reflected light amount from the information unit, based on the light receiving signals outputted from all the divided light receiving faces of the reproduction photodetector.

The pit array with the phase pit(s) has a smaller reflected light amount as compared to that of the pit array without the phase pit. Namely, the larger is the number of the phase pits in the information unit, the smaller is the reflected light amount.

Incidentally, when adopting a laser light for the light to be incident on the optical memory device, the reflected light amount for the pit array with one central phase pit is generally smaller than the reflected light amount for the pit array with one surrounding phase pit.

Therefore, by identifying the total reflected light amounts by total received light amount comparison circuit, the pit arrays of the information units can be roughly classified into groups.

The partial light amount comparison circuit compares (partially compares) the respective intensities of the lights incident on the divided light receiving faces based on the light receiving signals to be outputted from each of the divided light receiving faces, each of the divided light receiving faces.

The specific conditions for the partial comparison (kinds and the number of partial comparisons) to be performed by the partial light amount comparison circuit are determined based on the result of determination by the total received light amount comparison circuit.

The partial light amount comparison circuit determines if each of the surrounding phase pits and the central phase pit is provided based on the result of comparison, and determines the pit array of the information unit.

As described, according to the foregoing structure, before carrying out the partial comparison by the partial light amount comparison circuit, the pit arrays are roughly identified into groups by the total right amount comparison circuit.

It is therefore possible to reduce the kinds and the number of partial comparisons to be performed for the identification of the pit array by the partial light amount comparison circuit.

It is preferable that the reproducing device of the present invention for reproducing recorded information from the optical memory device in which the synchronous units are formed includes a synchronous signal generation circuit.

The synchronous signal generation circuit generates a synchronous signal to be outputted to the pit array identification circuit based on the light receiving signal from the synchronous unit.

In this case, it is preferable that the pit array identification circuit specifies the pit array of the information unit to be reproduced using the synchronous signal.

According to the foregoing structure, as synchronous signals can be generated based on the synchronous unit, it is possible to identify the pit array of the information unit with high precision. As a result, the recorded information can be reproduced with accuracy.

In the optical memory device of the present invention, in the case where the synchronous units are formed at the same pitches (intervals) as pitches at which the information units are formed, it is preferable that synchronous signal generation circuit be arranged so as to generate a synchronous signal having the same cycle as that of the light receiving signal from the synchronous unit.

According to the foregoing arrangement, the structure of the synchronous signal generation circuit can be simplified, and the reproducing device provided with the synchronous signal generation circuit can be realized without increasing costs.

For the optical memory device wherein the synchronous units are formed at intervals twice as long as the intervals at which the information units are formed, it is preferable that the synchronous signal generation circuit generates a synchronous signal whose cycle is ½ of that-of the light receiving signal from the synchronous unit.

According to the foregoing structure, changes in intensity of the reflected light from the synchronous unit can be made still larger, and therefore the synchronous signal generation circuit can generate the synchronous signal with ease. Incidentally, by the difference in cycles of the light receiving signals, the information unit and the synchronous unit can be identified with ease. As a result, the information can be reproduced accurately.

### Second Embodiment

The following will explain another embodiment of the present invention.

An optical disk device (disk device; optical reproducing device) in accordance with the present embodiment is a reproducing device for reproducing information recorded on an optical disk.

FIG. 2 is an explanatory view illustrating the structure of a disk device in accordance with the present embodiment.

As illustrated in FIG. 2, the disk device of the present embodiment includes a spindle 10, an optical pickup 11, and a circuit substrate 12.

The spindle 10 rotates the optical disk 1, from which information are to be reproduced, in a fixed state.

The structure of the optical disk 1 will be explained in detail later.

The optical pickup 11 emits a laser light (light beam) L onto the rotating optical disk 1 while moving in the radius direction of the optical disk 1. The disk device of the present invention reproduces information recorded on the optical disk 1 by emitting the laser light L. The circuit substrate 12 includes a group of a plurality of circuits for driving the spindle 10 and the optical pickup 11.

As illustrated in FIG. 2, the optical pickup 11 includes a semiconductor laser light source 21, a collimator lens 22, a beam splitter 23, a condenser lens 24, an actuator 25, a beam splitter 26, a condenser lens 27, a cylindrical lens 28, a control photodetector 29, a condenser lens 30, and a photodetector (reproduction photodetector) 31.

The semiconductor laser light source 21 is a light source which produces a laser light L.

The collimator lens 22 shapes the flux of the laser light L emitted from the semiconductor laser light source 21 into parallel light.

The beam splitter 23 allows the laser light L to pass through the collimator lens 22 and reflects the laser light L incident from the side of the optical disk 1 (condenser lens 24) and bends the optical path of the reflected laser light L at a right angle.

The condenser lens 24 condenses the laser light L as passed through the beam splitter 23 to be converged onto the recording surface of the optical disk 1. The condenser lens 24 also converges the reflected laser light La from the optical disk 1.

The actuator 25 adjusts the position of the condenser lens 24 (drives the condenser lens 24) for the focusing control and the tracking control.

The reflected laser light La from the optical disk 1 is returned to the optical path of the light when incident on the optical disk 1, and is reflected from the beam splitter 23 and is then guided to the beam splitter 26.

Some of the reflected laser light La incident on the beam splitter 26 pass therethrough, and some are reflected to the side of the condenser lens 30.

The condenser lens 27 and the cylindrical lens 28 are provided for condensing the laser light La as passed through the beam splitter 26 onto the control photodetector 29.

The control photodetector 29 outputs light receiving signals R5 to R8 (to be explained later) based on the reflected laser light La.

The condenser lens 30 is provided for condensing the reflected laser light La from the beam splitter 26 onto the photodetector 31.

The photodetector 31 receives the reflected laser light La and generates an electrical signal (light receiving signal).

The structure of this photodetector 31 will be explained later.

As illustrated in FIG. 2, the circuit substrate 12 includes a spindle control circuit 41, a laser control circuit 42, the total received light amount comparison circuit 43, a partial light amount comparison circuit 44, a demodulation circuit 45, an error correction circuit 46, and a focusing/tracking circuit 47.

The spindle control circuit 41 drives the optical disk 1 fixed to the spindle 10 to rotate together with the spindle 10.

The laser control circuit 42 is provided for controlling (driving) the semiconductor laser light source 21 to emit laser light L.

The focusing/tracking circuit 47 generates a focusing signal by the astigmatism method and a tracking signal by the sample servo method, based on the light receiving signals S5 to S8 generated by the control photodetector 29. The focusing/tracking circuit 47 then drives the actuator 25 based on the resulting focusing signal and the tracking signal to perform the focusing control and the tracking control.

The respective operations of the focusing/tracking circuit 47 and the control photo detector 29 will be explained later.

By the group of the foregoing circuits 43 to 46, a reproducing signal is generated based on the light receiving signals as outputted from the photodetector 31.

These circuits 43 to 46 will be explained in detail later.

The disk device of the present embodiment is provided with a control section (not shown) for controlling overall operations of the disk device by controlling the circuits on the circuit substrate 12.

The structure of the optical disk 1 will be explained here.

FIG. 3 is a plan view illustrating the structure of the optical disk (optical memory device) 1. The optical disk 1 has a diameter of 120 mm, and as illustrated in FIG. 3, and on this optical disk 1, spiral information tracks 2 for recording information are formed on the recording surface (surface) thereof.

FIG. 4 is a cross-sectional view of the optical disk 1.

As illustrated in FIG. 4, the optical disk 1 includes a transparent substrate 7 whereon the metal reflective film 8 and the protective film 9 are laminated in this order.

The transparent substrate 7 is made of a transparent material such as polycarbonate resin.

The metal reflective film 8 is formed over the transparent substrate 7. This metal reflective film 8 is made of, for example, aluminum.

The protective film 9 is formed over the metal reflective film 8.

On the surface of the transparent substrate 7 on the side of the metal reflective film 8, formed are convex-shaped phase pits 3 and 4. The phase pits 3 and 4 constitute the information unit 5 as a unit of the recorded information (recorded information unit). These phase pits 3 and 4 are formed long the information tracks 2.

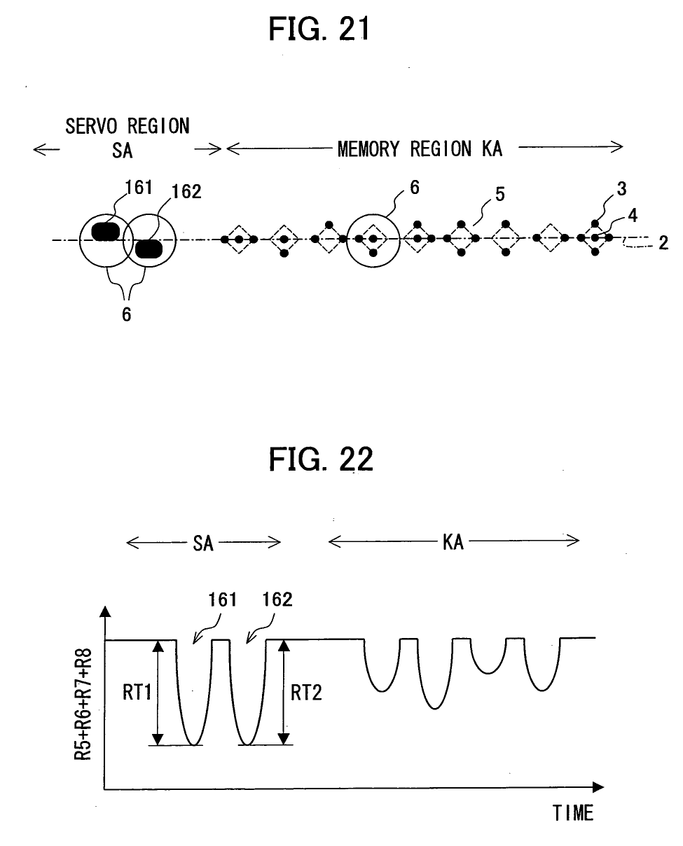

FIG. 21 is an explanatory view which explains the structure of the information track 2 in detail. As illustrated in FIG. 21, a plurality of sectors, each being made up of a servo region SA and a recording region KR are formed successively and periodically along the information track 2.

The servo region SA is formed in the reading end of each sector, and in this servo region SA, a pair of servo units.(servo information units) 161 and 162 are formed.

In the recording region KA formed subsequent to the servo region SA, a plurality of information units 5 are formed.

These servo units 161 and 162 are used for the focusing control and the tracking control performed by the control photo detector 29, and the focusing/tracking circuit 47.

The explanations on these servo units 161 and 162 will be explained later.

The information unit 5 is a unit of recording information (information unit).

The information unit 5 is made up of phase pits 3 in the number of four at the maximum, and the phase pit 4 in the number of one at the maximum, which are arranged regularly (at regular intervals) in the information track 2.

The phase pits (surrounding phase pits) 3 are located at respective apexes of the square, one of the diagonal lines of which is overlapped with the information track 2. The phase pit (central phase pit) 4 is located at the center of the square.

In the optical disk 1, the information (recorded content) of the information unit 5 are defined by a combination of the number and the position of the phase pits 3 and 4 (arrangement of the phase pits; pit array).

FIG. 9 is an explanatory views which shows respective structures of pit arrays (kinds of information) in the information unit 5. As illustrated in FIG. 9, the information unit 5 of the optical disk 1 is designed to have 32 kinds of information as expressed by the pit arrays 1ax to 32jx.

The pit array lax is a pit array without a phase pit.

The pit arrays 2by, 3by, 4by, 5by and 6cx are pit arrays made up of one phase pit.

The pit arrays 7dx, 8dx, 9dy, 10dy, 11dy, 12dy, 13ey, 14ey, 15ey, and 16ey are pit arrays, each being made up of two phase pits.

The pit arrays 17fy, 18fy, 19fy, 20fy, 21gy, 22gy, 23gy, 24gy, 25gx, and 26gx are pit arrays each being made up of three phase pits.

The pit arrays 27hx, 28iy, 29iy, 30iy and 31iy are pit arrays, each being made up of four phase pits.

The pit array 32jx is made up of five phase pits.

Here, the reference numerals of these pit arrays 1ax to 23jx are defined by a combination of a serial number, a light amount identification factor and a symmetry identification factor.

Namely, the serial numbers are from 1 to 32 respectively assigned to all the 32 kinds of the pit arrays.

Each amount of light identification factor corresponds to a total amount of reflected laser light La (total amounts of reflected light) of the light incident on the photodetector 31 (to be described later) and reflected from the information unit 5 made up of a pit array.

Namely, when reproducing from the disk device of the present invention, the control section controls the spindle control circuit 41 to rotate the optical disk 1. This control section also controls the laser control circuit 42 to emit laser light L from the condenser lens 24 onto the optical disk 1, and to scan beam spots 6 along the information tracks 2 of the optical disk 1 as illustrated in FIG. 21.

In this operation, the laser light L is emitted so that the center of the beam spot 6 is on the center of the information unit 5 (information track 2).

As a result, the laser light L is reflected from the information unit 5 formed along the information track 2 to be a reflected laser light La.

This amount of reflected laser light La differs for each pit array of the information unit 5.

Namely, the light amount identification factors are respectively indicative of amounts of reflected laser light La corresponding to the respective pit arrays of the information unit 5. In the optical disk 1, respective total reflected light amounts from the pit arrays are classified into the light amount identification factors a to j of ten kinds.

Incidentally, the respective pit arrays having the same light amount identification factors a to i have substantially the same total reflected light amounts. Here, “a” indicates the largest total reflected light amount, and respective total reflected light amounts indicated by a to i are smaller in this order.

Here, the relationship between the respective number and the locations of the phase pits 3 and 4 and the total reflected light amounts will be explained.

As compared to the reflected amount of light from the pit array without phase pits 3 and 4, the reflected amount of light from the pit array with the phase pits 3 and 4 is smaller.

The intensity distribution of the beam spot 6 of the laser light L shows the Gaussian distribution. Therefore, for the beam spot 6, the light intensity of its center is higher than that in the circumferential region. Furthermore, as explained earlier, the laser light L is emitted such that the center of the beam spot 6 is on the center of the information unit 5.

Therefore, generally, the amount of reflected light of the central phase pit 4 is smaller than the amount of reflected light of the surrounding phase pits 3 at apexes.

For any of the pit arrays 2by to 5by, a single phase pit is located in the circumference of the beam spot 6, and respective total reflected light amounts for these pit arrays 2b1 to 7b1 are all equal.

For the pit array 6cx, a single phase pit 4 is located at position corresponding to the center of the beam spot 6, and total reflected light amount from the pit array 6cx is smaller than those obtained from the pit arrays 2by to 5by.

Next, for the pit arrays 7dx to 12dy made up of two phase pits 3, with an increase in the number of the phase pits, the total reflected light amounts from these arrays 7dx to 12dy are smaller than that from the pit array 6cx.

For the pit arrays 13gy to 16ey, each being made up of one phase pit 4 and one phase pit 3, the total reflected light amounts are smaller than those obtained from the pit arrays 7dx to 12dy. Similarly, for the rest of the pit arrays, with an increase in the number of the phase pits, the total reflected light amount decreases.

The symmetry identification factors 0, 1 and 3 of the pit array are defined as follows.

Next, the structure of the photodetector 31 will be explained.

FIG. 10 is an explanatory view illustrating the structure of the photodetector 31. As illustrated in FIG. 10, the photodetector 31 is made up of four divided light receiving faces (photo-detecting elements) D1 to D4.

The divided light receiving faces D1 to D4 are obtained by dividing the circular light receiving face of the photodetector 31 by the three parting lines A and B which cross at right angle, and these divided light receiving faces D1 to D4 are in the shape of a fan that radically expands from the center of the light receiving face of the photodetector 31.

Here, the respective parting lines A and B are provided so as to pass the center of the light receiving face, and divide the light receiving face equally into six, i.e., 60° for each divided light receiving face. Therefore, respective divided light receiving faces D1 to D6 have the same area and the shape.

These divided light receiving faces D1 to D4 respectively output voltage signals (the light receiving signal) R1 to R4 indicative of voltage values respectively corresponding to the received reflected light amounts. In the foregoing photo detector 31, the parting lines A and B are provided so as to form an angle of 45° with the straight line X-X′ corresponding to the information track 2 on the optical disk 1 (the straight line corresponding to the information track on the light receiving face of the photodetector 31).

Here, the relationship between each of the phase pits 3 and 4 and the divided light receiving faces D1 to D4 will be explained.

A reflected light from each phase pit is diffracted, and is then incident on the divided light receiving faces D1 to D4. For a pit array made up of a plurality of phase pits, the diffracted light from respective phase pits interfere each other and is then incident on the divided light receiving faces D1 to D4. Namely, the reflected light from each phase pit is not incident on only one of the divided light receiving faces D1 to D4 but incident on the entire surface of the divided light receiving faces D1 to D6.

On the other hand, for a pit array made up of a single phase pit 3, the reflected from the phase pit 3 incident on any one of the divided light receiving faces D1 to D4 corresponding to that phase pit 3 has a relatively high intensity (the further is the incident position of the reflected light beam from the position corresponding to that phase pit 3, the lower is the intensity).

For example, for the pit array 2by, the intensity of the reflected light incident on the divided light receiving face D2 is relatively high, and the intensity of the reflected light incident on the divided light receiving face D4 is relatively low.

Incidentally, the reflected light from the phase pit 4 at the center of the square is evenly incident around the center of all the divided light receiving faces D1 to D4.

Therefore, for the pit array 8c3 made up of only one phase pit 4, the intensity of the reflected light incident in the vicinity of the centers of all the divided light receiving faces D1 to D4 is relatively high, and the intensity of the reflected light incident on the circumferential region is relatively low.

Next, the circuits 43 to 46 in the circuit substrate 12 shown in FIG. 2 will be explained.

These circuits 43 to 46 are provided for identifying respective pit arrays of the information unit 5 to be reproduced based on the light receiving signals outputted from the photodetector 31, and generate reproducing signals according to the identification results.

The total received light amount comparison circuit 43 adds all the light receiving signals R1 to R4 outputted from the divided light receiving faces D1 to D4 of the photodetector 31 to obtain the total reflected light amount. The total received light amount comparison circuit 43 then derives the light amount identification factors a to j for the pit array of the information unit 5 to be reproduced from the resulting the total reflected light amount.

Here, there is no other pit array which has the same amount of total reflected light as these pit arrays 1ax, 6cx, 27hx and 32jx. Therefore, in the case where the information unit 5 to be reproduced is the foregoing pit arrays, it is possible to identify these pit arrays only by means of the total received light amount comparison circuit 43.

In the following Table 11, the conditions for identification in the partial light amount comparison circuit 44 are shown.

TABLE 11

| | LIGHT AMOUNT | | | | |
|---|---|---|---|---|---|
| PIT | IDENTIFICATION | IDENTIFICATION | IDENTIFICATION | IDENTIFICATION | DEMODULATION |
| ARRAY | FACTOR | CONDITION I | CONDITION II | CONDITION III | SIGNAL |
| 1ax | a | — | — | — | 00000 |
| 2by | b | R2 > R4 | — | — | 00001 |
| 4by | | R2 < R4 | — | — | 00010 |
| 3by | | R2 = R4 | R1 > R3 | — | 00011 |
| 5by | | | R1 < R3 | — | 00100 |
| 6cy | c | — | — | — | 00101 |
| 8dy | d | R2 > R4 | R1 < R3 | — | 00110 |
| 10dy | | | R1 > R3 | — | 00111 |
| 11dy | | R2 < R4 | R1 > R3 | — | 01000 |
| 12dy | | | R1 < R3 | — | 01001 |
| 7dx | | R2 = R4 | R1 = R3 | R1 < R2 | 01010 |
| 9dx | | | | R1 > R2 | 01011 |
| 13ey | e | R2 > R4 | — | — | 01100 |
| 15ey | | R2 < R4 | — | — | 01101 |
| 14ey | | R2 = R4 | R1 > R3 | — | 01110 |
| 16ey | | | R1 < R3 | — | 01111 |
| 17fy | f | R2 > R4 | — | — | 10000 |
| 19fy | | R2 < R4 | — | — | 10001 |
| 18fy | | R2 = R4 | R1 > R3 | — | 10010 |
| 20fy | | | R1 < R3 | — | 10011 |
| 21gy | g | R2 > R4 | R1 > R3 | — | 10100 |
| 24gy | | | R1 < R3 | — | 10101 |
| 22gy | | R2 < R4 | R1 > R3 | — | 10110 |
| 23gy | | | R1 < R3 | — | 10111 |
| 25gx | | R2 = R4 | R1 = R3 | R1 < R2 | 11000 |
| 26gx | | | | R1 > R2 | 11001 |
| 27hx | h | — | — | — | 11010 |
| 28iy | i | R2 > R4 | — | — | 11011 |
| 30iy | | R2 < R4 | — | — | 11100 |
| 29iy | | R2 = R4 | R1 > R3 | — | 11101 |
| 31iy | | | R1 < R3 | — | 11110 |
| 32jx | j | — | — | — | 11111 |

As shown in Table 11, the partial light amount comparison circuit 44 compares respective intensities of the light receiving signals R1 to R4 based on the light amount identification factors a to j.

Specifically, the partial light amount comparison circuit 44 first compares respective intensities of the light receiving signals R2 and R4 (identification condition I). The partial light amount comparison circuit 44 then compares the respective intensities of R1 and R3 (identification condition II). Lastly, the partial light amount comparison circuit 44 compares the respective intensities of R1 and R2 (identification condition III).

As a result, all the information units 5 can be identified.

As described, the partial light amount comparison circuit 44 can identify all the pit arrays of 32 kinds by comparing the respective intensities of the light receiving signals R1 to R4 based on the light amount identification factors.

The demodulation circuit 45 then generates the demodulation signal (demodulation data) based on the result of identification of the pit array by the partial light amount comparison circuit 44.

In the foregoing Table 11, a demodulation signal according to each pit array is shown.

As shown in FIG. 9, the disk device of the present embodiment adopts 32 kinds of the pit arrays for the information unit 5. It is therefore possible to record 32 kinds of information for each information unit 5. Therefore, a 5-bit demodulation signal can be obtained from one information unit 5.

The error correcting circuit 46 performs an error correction with respect to the demodulation signal generated by the demodulation circuit 45, and generate reproducing signal.

The disk device of the present embodiment then converts the reproducing signal into a video signal (video data) or a voice signal (voice data) by a converter circuit (not shown). Then, these signals are displayed on a display device (not shown) such as a display screen, a speaker, etc.

As described, the optical disk 1 of the present embodiment adopts the pit arrays of the information unit 5, which are made up of combinations of five phase pits (four surrounding phase pits 3 located in the circumferential region and one central phase pit 4 on the information track 2).

In this example, the surrounding phase pits 3 are located at apexes of the square one of the diagonal lines t is overlapped with the information track 2.

The phase pit 4 is located at a center of the square.

As described, the optical disk 1 of the present embodiment adopts the pit array of the information unit 5 made up of a combination of four surrounding phase pits 3 and one central phase pit 4.

With the foregoing structure, the optical disk 1 of the present embodiment permits information (5-bit data) of 32 (25) kinds to be multiplex-recorded for each information unit 5. Therefore, as compared to the arrangement adopting the pit array made up of a combination of only four phase pits 3, the recording density can be significantly raised.

For the optical disk 1, the required number of divided light receiving faces of the photoreceptor 31 for reproducing information can be reduced to four.

Namely, for the pit array of the information unit 5 made up of only four phase pits 3, the intensity distribution of the reflected light from the information unit 5 corresponds to the shape of square (the shape of the square is formed when the pixel array is made up of six phase pits).

Therefore, the photodetector 31 to be adopted for reproducing information is divided into four corresponding to the four phase pits 3. Namely, the four-divided photodetector made up of four divided light receiving faces D1 to D4 is adopted.

The photodetector 31 determines with or without the phase pit 3 for the four phase pits 3 in the information unit 5 (the location(s) of the phase pit(s) 3) according to the intensity of the reflected lights from the four divided light receiving faces D1 to D4. The photodetector 31 then identifies the pit array to be reproduced based on the determination result.

For the pit array of the optical disk 1 with one central phase pit 4 and the four surrounding phase pits 3, the four divided photo detector 31 made up of four divided light receiving faces D1 to D4 can be adopted.

Namely, the reflected lights from the phase pit 4 have an intensity distribution according to the distance from the center of the photodetector 31 (the lights incident at positions apart from the center of the photodetector by the same distance have the same intensity). Therefore, the reflected lights having the same intensity distribution are incident respectively on the four divided light receiving faces D1 to D4 in the photodetector 31.

Therefore, when reproducing information from the optical disk 1 using the four-divided photodetector 31, it is possible to determine if the phase pit 4 is provided, based on the total received light amount by the entire light receiving faces (the intensity of the total reflected light amount from the entire information unit 5 (pit array)).

For the phase pit 3, it can be determined if the phase pit 3 is provided at each position based on the intensity of the light incident on each of the four divided light receiving faces D1 to D4 as described earlier.

As described, according to the optical disk 1, although the information unit 5 made up of five phase pits 3 and 4 is adopted, it is possible to reproduce information using the four-divided photodetector 31. With this structure, the optical disk 1 permits the information to be recorded at high density, and the recorded information to be reproduced without using reproducing circuits of the complicated structure.

In the case of adopting the pit array made up of five phase pits located at apexes of the pentagon, the intensity distribution of the reflected light from the information unit 5 corresponds to the shape of the pentagon (the shape of the pentagon is formed when the pixel array is made up of five phase pits). Therefore, it is necessary to provide the divided light receiving faces corresponding to the five phase pits, and to determine if each phase pit is provided based on the intensity of the light incident on each of these five divided light receiving faces.

With this structure, it is therefore required to divide the light receiving face of the photodetector into five (the number of divided light receiving faces is five). As a result, the circuit for processing the intensity of the light incident on each of the divided light receiving faces becomes complicated, which results in an increase in cost. In particular, the partial light amount comparison circuit 44 for determining the symmetric characteristic becomes complicated in structure.

According to the optical disk 1 of the foregoing structure, the phase pits 3 and 4 are provided respectively at apexes of the square and the center of the square. As a result, the phase pits can be provided in the optical disk 1 at higher density, and it is therefore possible to realize a still higher recording density.

With the foregoing structure, in order to identify the pit array of the information unit 5 to be reproduced according to the reflected laser light La, the total received light amount comparison circuit 43 and the partial light amount comparison circuit 44 are provided.

Then, the total received light amount comparison circuit 43 specifies the total reflected light amount and roughly classifies the pit arrays of the information unit 5 into groups according to the light amount identification factors. Then, according to the total reflected light amount as specified, the partial light amount comparison circuit 44 compares (partially compares) the intensity of the light incident on each of the divided light receiving faces D1 to D4 and identifies the pit array of the information unit 5.

As described, also with the foregoing structure of the present embodiment, the pit arrays are roughly identified into groups by the total right amount comparison circuit before carrying out the partial comparison by the partial light amount comparison circuit.

It is therefore possible to reduce the kinds and the number of partial comparisons to be performed for the identification of the pit array by the partial light amount comparison circuit.

According to the optical disk device of the foregoing structure, the photodetector 31 is arranged such that the parting lines A and B which divide the light receiving face into the divided light receiving faces D1 to D4 form an angle of 45° with the straight line X-X′ corresponding to the information track 2 formed on the optical disk 1, is adopted.

In view of an improvement in detection precision, it is therefore preferable that the parting lines A and B be provided so as to form an angle of 45° with the straight line X-X′ corresponding to the information track 2 on the optical disk 1.

With this structure, it is possible to provide respective centers of the divided light receiving faces D1 to D4 at the corresponding phase pits (at position where the intensity of the reflected light from each phase pit 3 is maximized). Therefore, it is possible to allocate these four divided light receiving faces D1 to D4 to the phase pits 3 with one to one correspondence. It is therefore possible to determine respective phase pits 3 of four kinds with accuracy by the four divided light receiving faces D1 to D4.

As described, desirable effect can be achieved by arranging such that the parting lines A and B which divide the light receiving face into the divided light receiving faces D1 to D4 form an angle of 45° with the straight line X-X′. Specifically, the foregoing desirable effect can be realized by the arrangement wherein the parting lines A and B form an angle of 45° with straight line on the light receiving face according to one of the diagonal lines of the square. With this structure, even in the case where the parting lines A and B do not form an angle of 45° with the straight line X-X′, it is still possible to ensure the foregoing desirable effect.

Incidentally, in the case where one of the diagonal lines of the square is overlapped with the information track 2, the following effect can be achieved. That is, the axisymmetric characteristic (line symmetry) of the pit array of the information unit 5 about the information track 2 can be achieved with ease.

According to the disk device of the present embodiment, the parting lines A and B of the photodetector 31 cross at right angle. In this structure, respective divided light receiving faces D1 to D4 have the same area, and it is therefore possible to compare respective intensities of the light receiving signals R1 to R4 by the partial light amount comparison circuit 44 with ease.

In the disk device of the present embodiment, the control photodetector 29 is provided separately from the photodetector 31 in view of the following problem. That is, as the reflected light incident onto the control photodetector 29 is subjected to focusing by the cylindrical lens 28, the wave front of the reflected light is disturbed. For this reason, in the case where the same photodetector is used both as the control photodetector 29 and the photodetector 31, the reflected light with uneven wave front is incident on the photodetector 31. Thus, a problem arises in that the intensity distribution of the light incident on these divided light receiving faces D1 to D4 is disturbed, and it is difficult to accurately identify the pit array of the information unit 5.

In response, the disk device of the present embodiment is arranged so as to form these photo detectors separately so as to avoid the foregoing problem of the reflected light with an uneven wave front being incident on the photodetector 31. With the foregoing structure of the disk device of the present invention, it is possible to reproduce recorded information accurately while accurately controlling the intensity.

Incidentally, according to the present embodiment, as shown in FIG. 2, the total received light amount comparison circuit 43 is provided in the pre-stage of the partial light amount comparison circuit 44. With this structure, after the light amount identification factors are identified by the total received light amount comparison circuit 43, the partial light amount comparison circuit 44 identifies the pit array of the information unit 5 based on these light amount identification factors and the light receiving signal R1 to R4.

However, the present invention is not intended to be limited to the foregoing structure, and, for example, it may be arranged so as to provide the partial light amount comparison circuit 44 in the pre-stage of the total received light amount comparison circuit 43.

The identification method in the foregoing structure is shown in the following Table 12.

TABLE 12

| | | SYMMETRY | SYMMETRY | LIGHT AMOUNT | |
|---|---|---|---|---|---|
| PIT | SYMMETRY | IDENTIFICATION | IDENTIFICATION | IDENTIFICATION | DEMODULATION |
| ARRAY | IDENTIFICATION I | II | III | FACTOR | SIGNAL |
| 3by | T1 > T2 | S1 > S3 | S2 < S4 | b | 00000 |
| 14ey | | | | e | 00001 |
| 17fy | | | S2 > S4 | f | 00010 |
| 28iy | | | | i | 00011 |
| 5by | | S1 < S3 | S2 > S4 | b | 00100 |
| 16ey | | | | e | 00101 |
| 18fy | | | S2 < S4 | f | 00110 |
| 30iy | | | | i | 00111 |
| 8dx | | S1 = S3 | S2 = S4 | d | 01000 |
| 26gx | | | | g | 01001 |
| 2by | T1 < T2 | S1 > S3 | S2 > S4 | b | 01010 |
| 13ey | | | | e | 01011 |
| 18fy | | | S2 < S4 | f | 01100 |
| 29iy | | | | i | 01101 |
| 4by | | S1 < S3 | S2 < S4 | b | 01110 |
| 15ey | | | | e | 01111 |
| 20fy | | | S2 > S4 | f | 10000 |
| 31iy | | | | i | 10001 |
| 7dx | | S1 = S3 | S2 = S4 | d | 10010 |
| 25gx | | | | g | 10011 |
| 10dy | T1 = T2 | S1 > S3 | S2 = S4 | d | 10100 |
| 21gy | | | | g | 10101 |
| 12dy | | S1 < S3 | S2 = S4 | d | 10110 |
| 23gy | | | | g | 10111 |
| 9dy | | S1 = S3 | S2 > S4 | d | 11000 |
| 24gy | | | | g | 11001 |
| 11dy | | | S2 < S4 | d | 11010 |
| 22gy | | | | g | 11011 |
| 1ax | | | S2 = S4 | a | 11100 |
| 6cx | | | | c | 11101 |
| 27hx | | | | h | 11110 |
| 32jx | | | | j | 11111 |

With the foregoing structure, the partial light amount comparison circuit 44 identifies the symmetric characteristic of each pit array of the information unit 5 in the symmetry identifications I to III based on the light receiving signals R1 to R4 as shown in Table 12.

In Table 12, T1 and T2 respectively corresponds to (R1+R3) and (R2+R4). Similarly, S1 to S4 respectively correspond to (R1+R2), (R2+R3), (R3+R4) and (R4+R1).

With the foregoing structure, specifically, the partial light amount comparison circuit 44 compares respective intensities of T1 and T2 in the symmetry identification I. The partial light amount comparison circuit 44 then compares respective intensities of T1 and T3 in the symmetry identification II.

Further, the partial light amount comparison circuit 44 compares the respective intensities of S2 and S4 in the symmetry identification III.

By carrying out the foregoing calculation (comparison), the partial light amount comparison circuit 44 determines if each pit array of the information unit 5 belongs to any one of small groups of 15 kinds in the symmetry identifications I to III.

Thereafter, the total received light amount comparison circuit 43 identifies the pit array based on the kind of the small group which each pit array belongs to and the total reflected light amount from that pit array.

According to the foregoing structure, the total received light amount comparison circuit 43 uses the information with regard to the small group to which the target pit array belongs, in addition to the total reflected light amount. In this case, two kinds or four kinds of total reflected light amounts are to be identified in each small group.

With this structure, it is therefore possible to identify the total reflected light amounts with higher precision by the total received light amount comparison circuit 43 as compared to the case of Table 11 wherein the total reflected light amounts of 10 kinds (a to j) are to be identified. Additionally, the total received light amount comparison circuit 43 of a simpler circuit structure can be adopted.

Namely, in the case where a large number of kinds of total reflected light amounts are to be identified by the total received light amount comparison circuit 43, the total reflected light amount changes even with very small amount of change in the laser light L, which may cause a problem that the pit array of the information unit 5 is difficult to be identified.

In the foregoing structure, it is preferable be arranged so as to raise the control precision of the laser control circuit 42 and the control precision of the focusing/tracking circuit 47 (tracking precision and focusing precision).

On the other hand, according to the case of Table 12, wherein the number of kinds of the total reflected light amounts to be identified by the total received light amount comparison circuit 43 is reduced, differences between respective light amounts to be identified by the total received light amount comparison circuit 43 can be made relatively large.

Therefore, without the need of improving the control precision of the laser control circuit 42 or the focusing/tracking circuit 47, the light amount identification factors can be identified with accuracy with respect to the target array to be reproduced.

In the following, the focusing control and the tracking control by the disk device of the present embodiment will be explained.

As illustrated in FIG. 21, in the optical disk 1, a servo region SA is formed in ahead of the recording region KR in which a plurality of information units 5 are formed. In this servo region SA, a pair of servo units 161 and 162 are formed.

As illustrated in FIG. 21, these servo units 161 and 162 are formed on both sides of the information track 2 at positions shifted in a direction vertical to the information track 2 (radial direction) and in a direction parallel to the information track (circumferential direction).

The positions where the servo units 161 and 162 are formed are shifted in the radial direction to be symmetrical about the information track 2 (respective centers of the servo units 161 and 162 are apart from the information track 2 by the same distance in the radial direction).

For these servo units 161 and 162, the pattern of a larger area than the phase pits 3 and 4 of the information unit 5, and in the same depth as the phase pits 3 and 4 of the information unit 5 is adopted.

The servo regions SA having formed therein the foregoing servo units 161 and 162 are formed in the number of 10 to 20 in one cycle of the information track 2.

The disk device of the present invention is arranged such that the control photodetector 29 and the focusing/tracking circuit 47 perform the focusing control and the tracking control utilizing these servo region SA and the servo units 161 and 162.

FIG. 11 is an explanatory view showing the structure of the control photodetector 29.

As illustrated in FIG. 11, the control photodetector 29 is a four-divided photodetector made up of four divided light receiving faces (photo-detecting elements) D5 to D8 obtained by dividing the light receiving face.

The divided light receiving faces D5 to D8 are obtained by dividing the circular light receiving face of the control photodetector 29 by the parting lines C and D, which pass through the center of the light receiving face and cross each other at right angle and these divided light receiving faces D5 to D8 are in the shape of a fan that radically expands from the center of the light receiving face of the control photodetector 29.

These divided light receiving faces D5 to D8 respectively output voltage signals (the light receiving signal) R5 to R8 indicative of voltage values respectively corresponding to the received reflected light amounts. For the control photodetector 29, one of the parting lines (the parting line D) which divide the light receiving face into four divided light receiving faces D5 to D8 is overlapped with the straight line X-X′ corresponding to the information track 2 on the optical disk 1 (the straight line corresponding to the information track on the light receiving face of the photo photodetector 29).

The focusing/tracking circuit 47 generates a focusing signal by the astigmatism method and a tracking signal by the sample servo method, based on light receiving signals R5 to R8 generated by the control photodetector 29.

The focusing/tracking circuit 47 then drives the actuator 25 based on the resulting focusing signal and the tracking signal to perform the focusing control and the tracking control.

In the following, the focusing control operation and the tracking control operation by the disk device of the present invention will be explained.

When reproducing from the disk device of the present invention, the control section controls the spindle control circuit 41 to rotate the optical disk 1. This control section also controls the laser control circuit 42 to emit laser light L from the condenser lens 24 onto the optical disk 1, and to scan beam spots 6 along the information tracks 2 of the optical disk 1 as illustrated in FIG. 21. In this operation, the laser light L is emitted so that the center of the beam spot 6 is on the center of the information unit 5.

When the light spot 6 is formed on the servo region SA, the laser light L is reflected by the servo units 161 and 162, and the resulting reflected laser light La is incident on the control photodetector 29. Then, the divided light receiving faces D5 to D8 of the control photodetector 29 respectively output to the focusing/tracking circuit 27, voltage signals R5 to R8 indicative of voltage values respectively corresponding to the received reflected light amounts.

Then, the focusing/tracking circuit 47 which receives the light receiving signals R5 to R8 performs the focusing control and the tracking control based on the instructions from the control section.

Namely, the focusing/tracking circuit 47 first generates a focusing signal by the astigmatic method using the cylindrical lens 28 for focusing the laser light L onto the recording face of the optical disk 1.

Here, the focusing/tracking circuit 47 receives the light receiving signals R5 to R8 from the control photodetector 29 and computes (R5+R7)−(R6+R8). Then, to set the value resulting from the foregoing calculation to be zero, the focusing/tracking circuit 47 generates a focusing signal for use in controlling the position of the condenser lens 24 in the focusing direction (in a direction vertical to the surface of the optical disk 1). The focusing/tracking circuit 47 then outputs the resulting focusing signal to the actuator 25 for controlling the position of the condenser lens 24.

As a result, it is possible to set the focal position of the laser light L onto the recording face of the optical disk 1.

This focusing/tracking circuit 47 also generates the tracking signal by the sample servo method using the pair of servo units 161 and 162, for adjusting the center of the laser light L to be on the information track 2 (for the tracking control).

Namely, the focusing/tracking circuit 47 generates a tracking signal for controlling the position in the tracking direction of the condenser lens 24 (in the radial direction of the optical disk 1) so that the reflected light amount from the servo unit 161 can be set equal to the, reflected light amount from the servo unit 162. The focusing/tracking circuit 47 then outputs the resulting tracking signal to the actuator 25.

FIG. 22 is a graph showing a sum of all the light receiving signals (R5+R6+R7+R8; total amount of signals) outputted from the control photo detector 29 when scanning the information track 2 with the light beam spot 6.

RT1 indicates a total amount of signals when scanned on the servo unit 161, and RT2 indicates a total amount of signals when scanned on the servo unit 162.

Here, RT1 and RT2 become equal when the center of the light beam spot 6 is on the information track 2.

The foregoing effect can be acehived from the structure wherein the servo units 161 and 162 are formed on both sides of the information track 2 at positions apart from the information track 2 by the same distance.

On the other hand, when the center of the light beam spot 6 is shifted from the information track 2, the RT1 and the RT2 become not equal.

This is because, one of the servo units 161 and 162 is moved close to the center of the light beam spot 6, and the other of the servo units 161 and 162 is moved apart from the center of the light beam spot 6.

The focusing/tracking circuit 47 generates a tracking signal which satisfies the condition of “RCT1−RAT=0” and outputs the resulting tracking signal to the actuator 25.

As described, the optical disk 1 of the present embodiment includes a pair of servo units 161 and 162 formed so as to sandwich the information track 2.

According to the disk device of the present embodiment, when reproducing the recorded information from the optical disk 1, the tracking control can be performed by the sample servo method using the reflected lights from the servo units 161 and 162. When adopting the optical disk 1, the tracking can be performed under stable conditions, thereby reproducing recorded information with high precision.

For the tracking method, the push-pull method may be adopted other than the sample servo method. When adopting the push-pull method for the optical disk 1, the tracking control can be performed using the push pull signal obtained from the information unit 5.

The information units 5 formed on the optical disk 1 include those made up of pit arrays which are asymmetric about the information track 2 like the pit arrays 9dy, 13ey of FIG. 9. For this reason, the push-pull signal obtained from the asymmetric information unit 5 may disturb an accurate tracking. It is therefore preferable that the tracking control be performed with respect to the optical disk 1 by the sample servo method using the pair of the servo units 161 and 162.

In the present embodiment, the number of the surrounding phase pits 3 is selected to be four. However, the present invention is not intended to limit the number of the surrounding phase pits 3 to be four.

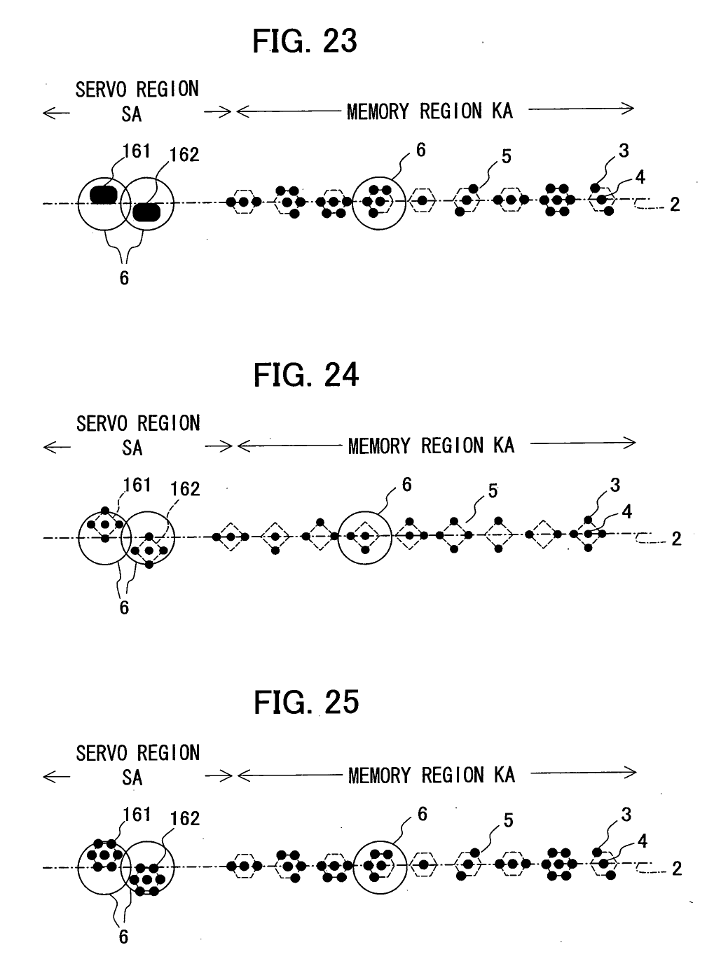

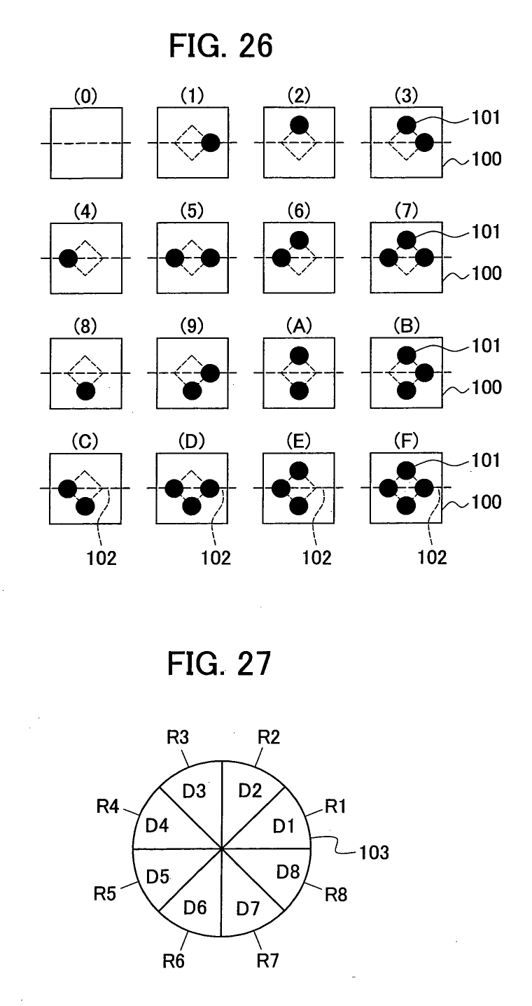

For example, as illustrated in FIG. 23, the phase pits 3 may be formed at respective apexes of the hexagon (respective phase pits 3 are formed at positions apart from the center of the hexagon by the same distance).

In this case, the servo units have the same structure as that of FIG. 21.

It is preferable that the foregoing hexagon be arranged such that one of the diagonal lines is overlapped with the information track 2.

With respect the optical disk 1 of FIG. 23, the tracking control can be performed by the sample servo method using the pair of the servo units 161 and 162 as in the case of the optical disk 1 of FIG. 21. Incidentally, by the comparison of the total reflected light amount by the total received light amount comparison circuit 43, and the identification or determination identification of the symmetric characteristic by the symmetry partial light amount comparison circuit 44, it is possible to reproduce recroded information by identifying the pit arrays of the information units 5.

In the structure of FIG. 23, the number of symmetry axes for the phase pits 3 of the information unit 5 is larger than that in the structure of FIG. 21. It is therefore preferable to adop the six-divided photo detection device as the photodetector 31.

In the above embodiment, for the servo units 161 and 162, the pattern of a larger area than the phase pits 3 and 4 of the information unit 5, and in the same depth as the phase pits 3 and 4 of the information unit 5 is adopted. However, the area and the depth of the servo units 161 and 162 are not intended to be limited to the above, and may be selected as the user desires.

Incidentally, as illustrated in FIGS. 24 and 25, in the pattern of the servo units 161 and 162, the phase pits of the same structure as those of the information units 5 may be adopted.

As illustrated in FIG. 24 and FIG. 25, these servo units 161 and 162 are formed on both sides of the information track 2 at positions shifted in a direction vertical to the information track 2 (radial direction) and in a direction parallel to the information track (circumferential direction).

The positions where the servo units 161 and 162 are formed are shifted in the radial direction to be symmetrical about the information track 2 (respective centers of the servo units 161 and 162 are apart from the information track 2 by the same distance in the radial direction).

When adopting the foregoing servo units 161 and 162, it is possible to perform the focusing control and the tracking control. Specifically, the total reflected light amount (total signal amount) from the servo units 161 and 162 differ depending on in which part of the light beam spot, the servo units 161 and 162 are formed. It is therefore possible to perform the tracking control by the sample servo method.

According to the foregoing structure, as the phase pits (pattern) 3 and 4 of the information unit 5 are the same as the phase pits of the servo units 161 and 162, the servo units 161 and 162 can be formed with ease.

Specifically, when forming the servo units 161 and 162 shown in FIG. 21 using the electron beam exposure unit, the electron beam is focused into a spot size with which the phase pits 3 and 4 of the information unit can be formed, thereby exposing the phase pits 3 and 4 of the information unit 5.

On the other hand, when exposing the servo units 161 and 162 of the larger pattern than the phase pits 3 and 4, the electron beam as focused is applied continuously, and is moved in the direction vertical to the information track 2 at high speed, thereby forming the phase pit of relatively large area. In this case, the phase ptis 3 and 4 of the information unit 5 and the servo units 161 and 162 are formed in different methods, it is necessary to control an electron beam to be suitable for respective forming conditions.

In contrast, as shown in FIGS. 24 and 25, when adopting for the phase pits of the servo units 161 and 162, those of the phase pits (pattern) 3 and 4 of the information unit 5, the servo units 161 and 162 can be formed with ease only by deflecting the electron beam in the direction vertical to the information track 2.

With the above structure, the servo units 161 and 162 can be formed under the same condition as the information unit 5. As a result, the required conditions for controlling the formation of the master panel of the optical disk 1 can be reduced, and the master panel and the optical disk 1 can be manufactured in more simple manner (under more stable conditions).

The servo units 161 and 162 shown in FIGS. 24 and 25 are made up of all the phase pits 3 and the phase pit 4. However, the servo units 161 and 162 of the present invention are not intended to be limited to the above, and any pit array may be adopted for the servo units 161 and 162.

In view of an improvement in detection precision, it is preferable that all the patterns which constitute the servo units 161 and 162 be symmetrical about the information track 2.

Incidentally, the larger is an amount of change in the total reflected light in the servo units 161 and 162, in more stably, the tracking control and the focusing control can be performed. It is therefore preferable that the pit array be made up of all the phase pits 3 and the phase pit 4 as illustrated in FIG. 24 and FIG. 25.

According to the present embodiment, in this servo region SA, a pair of servo units (servo information units) 161 and 162 are formed. However, the present invention is not intended to be limited to the foregoing structure, and it may be arranged so as to form two or more pairs of the servo units 161 and 162 in one servo region. Also, the number of the servo regions SA formed in the information track 2 is not limited to the range of 10 to 20 in one circle of the information track 2, and the number of the servo regions SA may be selected as the user desires.

According to the present embodiment, the surrounding phase pits 3 are provided at apexes of the square of the hexagon. However, the arrangement of the surrounding phase pits 3 is not limited to the foregoing arrangement.

For example, the phase pits 3 may be formed at apexes of other square which is symmetric about the circumferential direction or a radius direction (lozenge obtained by compressing the square shape in a circumferential direction or a radius direction). With this structure, it is also possible to identify the pit array of the information unit 5 and to perform the tracking control by the disk device of the present embodiment.

The phase pits 3 may be provided at respective apexes of other hexagon which is symmetrical in the circumferential direction and the radial direction (the hexagon formed by compressing the equilateral hexagon shape in the circumferential direction or radial direction). With this structure, it is also possible to identify the pit array of the information unit 5 and to perform the tracking control by the disk device of the present embodiment.

The phase pits 3 may be provided at apexes of other polygon (the pentagon or the octagon). In this case, it is also possible to identify the pit array by appropriately setting the process (identification conditions) by the partial light amount comparison circuit 44.

Here, it is preferable that the phase pits 3 of the optical disk 1 be formed at the same distance from the phase pit 4. In this way, all the phase pits 3 and 4 can be formed efficiently (at high density) in a beam spot 6 of substantially circular shape with an application of a laser light L. As a result, the recording density of the optical disk 1 can be improved, and the beam spot 6 can be made smaller in size.

According to the present embodiment, the collimator lens 22 shapes the flux of light of the laser light L as emitted from the semiconductor laser light source 21 into a parallel light. Here, in the case where the laser light from the semiconductor laser light source 21 is emitted in an elliptical shape, the beam may be shaped by the collimator lens 22 (or other beam shaping member).

In the present embodiment, the optical disk 1 with a diameter of 120 mm is adopted. However, according to the disk device of the present embodiment, it is possible to reproduce recorded information from the optical disk 1 of another size by altering the movable range of the optical pickup 11 (actuator 25).

In the present embodiment, the spiral information track 2 is formed on the optical disk 1. The present invention; however, the information track 2 of the present embodiment is not intended to be limited to the foregoing structure, and a plurality of information tracks 2 of concentric circles may be adopted.

In the preset embodiment, the optical disk 1 is adopted as the medium (optical memory device) for reproducing therefrom information by the disk device of the present embodiment.

However, the present invention may be arranged so as to reproduce information from an optical card in which information tracks are linearly formed. In this case, in the information tracks formed on the optical card, it is preferable that the information units 5 be made up of the pit arrays shown in FIG. 9 or FIG. 23.

In the disk device of the present embodiment, when adopting a transparent material for the protective film 9, it is possible to form the beam spot 6 on the metal reflective film 8 by projecting a laser light from the side of the protective film 9, to reproduce recorded information.

Incidentally, it is also possible to reproduce recorded information also by projecting the laser light L from the side of the transparent substrate 7 of the optical disk 1.

According to the present embodiment, for the amount of light obtained by the total received light amount comparison circuit 43, a total amount of light reflected from the information unit 5 (total reflected light amount) is adopted. To be more specific, however, the amount of light obtained by the total received light amount comparison circuit 43 is a total amount of light incident on the photodetector 31 (the divided light receiving faces D1 to D4).

Here, the total amount of incident light can be obtained by subtracting an amount of light (control light) directed to the control photodetector side by the beam splitter 26 from the total reflected light amount, which is in proportion to the total reflected light amount.

According to the arrangement of FIG. 10, the parting lines A and B of the photodetector 31 are provided so that respective adjacent two lines form an angle of 90°. However, the present invention is not intended to be limited to the foregoing structure, and an angle formed by the adjacent two parting lines can be slightly different from 90°. In this case, however, since respective areas of the divided light receiving faces D1 to D4 are slightly different from each other, it is therefore preferable to adjust the process of comparing the light receiving signals R1 to R4 by the partial light amount comparison circuit 44.

According to the present embodiment, the photodetector 31 of a circular shape is adopted. However, the photodetector of the present invention is not intended to be limited to the foregoing photodetector, and a photo-receptor of any shape can be adopted as long as all the reflected laser light La can be received. Similarly, the shape of the light receiving face of the control photodetector 29 is not limited to be a circular shape.

According to the structure of FIG. 10, the light receiving face of the photodetector 31 is divided into four divided light receiving faces. However, the number of the divided light receiving faces is not intended to be limited to four. However, the divided number of the light receiving face of the photodetector 31 is not limited to the above, and the divided number of the light receiving face of the photodetector 31 can be increase to double (eight-divided photodetector). By adopting the this photodetector 31, it is possible to identify the information units based on the light receiving signals from the eight-divided light receiving faces. With this structure, as compared to the case of adopting the four-divided photodetector, it is possible to simplify the required calculation for identifying the information unit 5.

As a result, the total received light amount comparison circuit 43 and the partial light amount comparison circuit 44 can be realized by circuits of simpler structure, thereby reducing the cost for the disk device of the present invention.

According to the present embodiment, the focusing control and the tracking control are performed based on the reflected lights from the servo units 161 and 162. However, the present invention is not limited to the above, and it may be arranged, for example, to perform the focusing control regularly.

Incidentally, when the reflected lights from the phase pits 3 and 4 which constitute the information unit 5 are contaminated into the focusing signal (focus servo signal) generated by the focusing/tracking circuit 47, the focusing (focus servo) would be disturbed.

In response, it is preferable to remove the high frequency signal components corresponding to the phase pits 3 and 4 from the focusing signal through this low pass filter. As a result, it is possible to perform a focusing control under stable conditions.

Incidentally, it may be arranged so as to perform the tracking control based on the reflected lights from the servo units 161 and 162 without carrying out the focusing control.

The tracking control is generally performed based on only the reflected light from the servo units 161 and 162 in the servo region SA. In this case, it is preferable that the condenser lens 24 be fixed in the radial direction while the recording region KA is being scanned with the beam spot 6.

Incidentally, the optical disk of the present invention may be arranged such that the control section informs the focusing/tracking circuit 47 if the light receiving signals D5 to D8 obtained from the control photodetector 29 correspond to the servo units 161 and 162 (if the servo units are being scanned with the beam spot 6), or the focusing/tracking circuit 47 detects if the light receiving signals D5 to D8 obtained from the control photodetector 29 correspond to the servo units 161 and 162.

When adopting the foregoing structure, it is preferable that the optical disk 1 be arranged such that a dummy special pattern which does not actually exist (the pattern for generating a peculiar reflected light) be formed in the pre-stage of the servo region SA, as the information unit 5 (or the servo units 161 and 162).

According to the foregoing structure, by detecting the peculiar reflected from the control photodetector 29, the control section or the focusing/tracking circuit 47 can see the scanning timing of the servo region SA.

Specifically, for the foregoing pattern, for example, three marginal regions of the information unit 5, which do not exist as the information unit 5 (regions without pits), etc., may be adopted.

In the present embodiment, the control photodetector 29 is provided separately from the photodetector 31. However, the present invention is not intended to be limited to this structure. For example, it may be arranged such that the photodetector 31 functions also as the control photodetector 29. In this case, the focusing/tracking circuit 47 generates a servo signal based on the light receiving signal as outputted from the photodetector 31.

In the present embodiment, the control photodetector 29 is provided separately from the photodetector 31. However, the present invention is not intended to be limited to this structure. For example, it may be arranged such that the control photodetector 29 functions also as the photodetector 31. In this case, the circuits 43 to 46 identify respective pit arrays of the information unit 5 to be reproduced based on the light receiving signals D5 to D8 outputted from the control photodetector 29.

In the present embodiment, the parting line D of the parting lines which divide the light receiving face of the control photodetector 29 into the divided light receiving faces D5 to D8 is overlapped with the straight line X-X′ corresponding to the information track 2 of the optical disk 1. However, the present invention is not intended to be limited to this structure, and, for example, the parting line C of the parting lines which divide the light receiving face of the photodetector 29 may be overlapped with the straight line X-X′.

In the following Examples 10 to 12, concrete examples for manufacturing the optical disk 1 and reproducing information from the optical disk 1 are shown.

### EXAMPLE 10

In the recording region K in the spiral information track 2 formed on the optical disk 1, the information units 5 made up of pit arrays shown in FIG. 9 and FIG. 21 are regularly arranged at pitches (intervals) of 350 nm.

The phase pits 3 and 4 are formed on a recording surface of a transparent substrate 7 made of polycarbonate in depth of 40 nm by the injection molding method.

The phase pits 3 and 4 having a diameter of 60 nm are formed at pitches of 100 nm.

In the servo region SA in the information track 2, formed are servo units 161 and 162 shown in FIG. 21. Each of the servo units 161 and 162 is formed in an oval shape with a width (length in the radius direction) of 160 nm, and a length (length in a circumferential direction) of 160 nm and a depth of a circular pit of 40 nm. These servo units 161 and 142 are formed at positions shifted from the center of the information track 2 by 80 nm each. These synchronous units 61 are formed at equal intervals at pitches of 350 nm.

The synchronous unit 61 is formed in the pre-stage of each of the 12800 information units 5.

For the patterning of the master panel for forming the transparent substrate 7 having formed thereon the information unit 5 (phase pits 3 and 4) and the servo units 161 and 162, an electron beam exposure device is adopted.

Here, for the servo units 161 and 162, by reciprocating the focused electron beam in a direction vertical to the information track 2 (radius direction), relatively large phase pits are formed.

On the other hand, for the information unit 5, by emitting the focused electron beam which permits exposure onto respective positions where the phase pits 3 and 4 are to be formed, relatively small phase pits are formed.

Then, from the master panel, the stamper for the optical disk is formed, and the transparent substrate 7 is formed by carrying out the injection molding using this stamper.

Next, on the transparent substrate 7 having formed thereon the foregoing information units 5 and the servo units 161 and 162, the metal reflective film 8 made of aluminum is formed by sputtering in a thickness of 50 nm.

Furthermore, on this metal reflective film 8, the polycarbonate sheet is laminated as the protective film 9 in a thickness of 0.1 mm by ultraviolet tray curing resin.

The optical disk 1 thus prepared is set in the disk device of the present invention as shown in FIG. 2.

In this example, for the semiconductor laser light source 21, a semiconductor laser device having a wavelength of 405 nm is adopted. For the condenser lens 24 for condensing the laser light L onto the optical disk 1, a lens with the number of apertures (NA) of 0.85 is adopted.

Incidentally, the laser light L is projected from the side of the protective film 9 of the optical disk 1.

When reproducing, the focusing is performed by the astigmatic method so that the laser light L is converged onto the metal reflective film 8 by the control section, the control photodetector 29 and the focusing/tracking circuit 47 based on the light-receiving signals R5 to R8. On the other hand, the tracking of the information track 2 is performed with the beam spot 6 by the sample servo method.

Here, by the total received light amount comparison circuit 43 and the partial light amount comparison circuit 44, the respective light receiving signals R1 to R4 of divided light receiving faces D1 to D4 of the photodetector 31 are processed under the identification conditions shown in Table 11. As a result, pit arrays of 32 kinds (5-bits) for the information units 5 can be identified, and the 5-bit data can be demodulated.

Similarly, the pit arras for the information units 5 can be identified also in the identification method shown in Table 12.

In this case, in the final step for the identification by the total received light amount comparison circuit 43, total reflected light amounts of only four kinds at a maximum are identified. It is therefore possible to reproduce recorded information from the information unit 5 under more stable conditions as compared to the case of adopting the identification method of Table 11.

### EXAMPLE 11

An optical disk 1 of this example 11 is prepared by forming the information units 5 having the pit arrays shown in FIG. 23 in the structure of the optical disk 1 of Example 10.

In the optical disk 1 of the present example, phase pits 3 are provided at respective apexes of the equilateral hexagon, and the phase pit 4 is provided at the center of the hexagon, and one of the diagonal lines which divide the hexagon into halves is overlapped with the information track 2.

As in the case of Example 10, a diameter of each of the phase pits 3 and 4 is selected to be 60 nm, and these phase pits are formed at pitches of 100 nm in the depth of 40 nm.

The optical disk 1 of this example thus prepared is set in the disk device of the present embodiment as in the Example 10, and the recorded information is reproduced. As a result, the focusing control can be performed by the astigmatism method, and the tracking control can be realized by the sample servo method.

As a result, by adopting the six-divided photo-detecting element for the photodetector 31, the pit array for each information unit 5 can be identified, and the 7-bit data can be modulated in the same manner as the Example 10.

### EXAMPLE 12

In the structure of the optical disk 1 of Examples 10 and 11, the optical disk 1 having formed thereon the servo units 161 and 162 shown in FIGS. 24 and 25 is prepared as the optical disk 1 of this Example.

In this optical disk 1, adopted is the servo units 161 and 162 each being made up of the same pit array as those of the information unit 5 (the pit array made up of all the phase pits 3 and the phase pit 4).

These servo units 161 and 162 are formed at positions respectively shifted from the information track 2 in opposite directions by 100 nm.

As a result of reproducing recorded information from the foregoing optical disk 1 of this Example in the same manner as the Examples 10 and 11, light receiving signals for focusing and tracking (for sample holding) can be from the control photodetector 29, and the tracking can be performed under stable conditions, and the pit array of each information unit 5 can be identified as in the case of Examples 10 and 11.

The optical memory device of the present invention wherein a recording region, in which a plurality of information units, each having information recorded according to a pit array are formed, and a servo region for use in sample servo are formed on the information track may be arranged such that the pit array of each information unit in the recording region is made up of a combination of the central phase pit formed on the information track and surrounding phase pits surrounding the central phase pit, and in the servo region, a pair of servo units formed on both sides of the information track.

The present invention also concerns the optical memory device in which information is recorded using phase pits, and the reproducing device at least capable of reproducing recorded information by the light beam.

In the conventional optical disk, asymmetric recording units (information units) are formed, with the information track sandwiched in between in the radius direction of the optical disk. With this conventional structure, a push-pull signal for tracking is liable to be disturbed, which disturbs tracking when passing the asymmetric recording units each time, and a reproducing error is therefore liable to increase.

To realize a high density optical disk, the arrangement of the phase pits in the information unit is an important factor for reproducing recorded information from the information unit under stable conditions.

The structure of FIG. 21 can be explained as follows. In this example of FIG. 21, a plurality of phase pits 3 provided at positions apart from the center of the square by the same distance are arranged in the square with the center of the square as a center-of-gravity; one of the diagonal lines of which is overlapped with the information track. Further, the pair of servo units 161 and 162 are formed on the information track 2 in ahead of the recording region in which the information tracks 5 are formed, at positions respectively shifted from the information track 2 in opposite directions. In FIG. 21, the servo units 161 and 162 made up of larger phase pits than the phase pits 3 and 4 of the information unit 5 are adopted. Here, it is preferable that pairs of the foregoing servo units 161 and 162 be formed in the number of 10 to 20 in one cycle of the information track 2. According to the disk device of the present invention, the photodetector receives the reflected light from the information unit 5 and detects the intensity distribution of the reflected light on each of the photo detectors (divided light receiving faces) D1 to D4, and performs the identification of the information unit 5 based on the intensities of the output signals (light receiving signals R1 to R4).

According to the optical disk 1 having the structure of FIG. 21, the information units 5 are regularly arranged in the spiral information tracks 2 wherein each of the information units 5 is made up of a plurality of phase pits 3 provided at apexes of the square one of the diagonal lines of which is on the information track 2, and the phase pit 4 provided at the center of the square. With this structure, information of 32 kinds (5-bit data) can be multiplex-recorded for each information unit 5, thereby realizing a high capacity optical disk.

The disk device of the present embodiment shown in FIG. 14 includes light irradiation means for irradiating the information unit 5 of the optical disk 1 with laser light; an optical system in which the reflected light from the information unit 5 is incident on the reproduction photodetector (photodetector 31) made up of the four-divided photo-detecting element in which one of the parting lines forms an angle of 45° with the straight line X-X′ corresponding to the information track 2; and reproducing means for reproducing recorded information by identifying the information unit 5 based on a photo-detection signal of the four-divided photo-detecting element.

According to the foregoing structure of the present invention, by adopting the four-divided photo-detecting element, the calculation for identifying the information unit 5 can be simplified, and the information unit 5 can be identified by the circuit of more simplified structure.

Moreover, the total reflected light amount changes even with very small amount of change in the laser light L, which may cause a problem that the pit array of the information unit 5 is difficult to be identified. In contrast, according to the identification method of Table 12, it is therefore possible to identify the total reflected light amounts with higher precision by the total received light amount comparison circuit 43 as compared to the case of Table 9 wherein the total reflected light amounts of 10 kinds (a to j) are to be identified, and the total reflected light amount changes with small change in laser amount, which makes-the identification of the information unit 5 difficult. In response, according to the identification method shown in Table 12, as the number of kinds of the total reflected light amounts to be compared is reduced, it is possible to identify the information unit 5 by the comparative circuit of simple structure. As a result, the reproducing device which permits the information unit 5 to be identified accurately irrespectively of changes in amount of laser light can be realized at low cost.

Next, the tracking operation of the disk device of the present embodiment will be explained. The tracking operation with respect to the information track 2 is performed by the sample servo method using the pair of the servo units 161 and 162. These servo units 161 and 162 are formed at positions respectively shifted from the information track 2 in opposite directions. The tracking operation is performed by detecting by the control photodetector 29, the state of the reflected light which moves over the pair of the servo units 161 and 162. FIG. 8 shows changes in signal of (R5+R6+R7+R8) when the light beam spot 6 moves over the information track 2. In FIG. 8, RT1 indicates an amount of change in signal when scanned on the servo unit 161, and RT2 indicates an amount of change in signal when scanned on the servo unit 162. Here, RT1 and RT2 become equal when the center of the light beam spot 6 moves on the information track 2. The foregoing effect is achieved from the structure wherein the servo units 161 and 162 are formed on both sides of the information track 2 at positions apart from the information track 2 by the same distance. On the other hand, when the center of the light beam spot 6 is shifted from the information track 2, the RT1 and the RT2 become not equal. This is because, one of the servo units 161 and 162 is moved close to the center of the light beam spot 6, and the other of the servo units 161 and 162 is moved apart from the center of the light beam spot 6. Therefore, by adjusting the position of the condenser lens 13 in the radial direction of the optical disk 1 so as to satisfy the condition of “RT1−RT2=0”, the tracking can be realized. Incidentally, the servo units 161 and 162 shown in FIG. 24 and FIG. 25 are respectively made up of a plurality of phase pits arranged at predetermined positions.

Generally, the servo units 161 and 162 are provided in the specific region of the disk. As disclosed in the patent document 2, the one cycle of the spiral information track is divided into small sectors in which information recording units are formed, and a servo information unit is formed at a leading end of each sector. With this structure, the tracking is performed based on the tracking information obtained at this servo information unit position.

Generally, the focusing is performed regularly. Here, when the reflected lights from the phase pits and which constitute the information unit are contaminated into the focus servo signal, the focusing (focus servo) would be disturbed. In response, it is preferable to remove the high frequency signal components corresponding to the phase pits and from the focusing signal through this low pass filter. As a result, it is possible to perform focusing under stable conditions. When reproducing recorded information, a tracking signal is obtained only at the position of the servo information unit, and the condenser lens is fixed at the position of the information recording unit.

Incidentally, to distinguish the reflected light from the servo information unit (servo unit) and the reflected light from the phase pit, the a dummy special pattern which does not actually exist (the pattern for generating a peculiar reflected light) be formed in the pre-stage of the servo information unit, as the unit of recorded information so that the servo information unit can be recognized.

Specifically, for the foregoing pattern, for example, three marginal regions of the unit of the recorded information, which does not exist as the information unit (regions without pits), etc., may be adopted. With this structure, it is confirmed that the servo information unit exists subsequent to these marginal regions.

The optical memory device and the optical memory device reproducing device of the present invention may be arranged as the following first to eight optical memory devices and the first and the second optical memory device reproducing devices.

The first optical memory device of the present invention wherein the recorded information units made up of a plurality of phase pits arranged at predetermined positions are arranged on the information track at regular intervals is arranged such that a pair of servo information units is formed at positions shifted in opposite directions from the information track.

According to the foregoing structure, the tracking can be performed with respect to the information track by the so-called sample servo method based on the reflected lights from the pair of servo information units at positions shifted from the information track in opposite directions. With this structure, even for the arrays which are asymmetric about the information track, the tracking can be performed under stable conditions, and the unit of the recorded information can be identified accurately.

The second optical memory device having the first optical memory device is arranged such that each of the information units is made up of a phase pit provided at the center of the information unit, and a plurality of phase pits provided at the same distance from the center of the information unit.

According to the foregoing structure, in addition to the effect of realizing the tracking operation under stable condition, the following effect can be achieved. That is, with the structure wherein phase pits which constitute the information unit are arranged at the center of the information unit and the positions at the same distance apart from the center of the information unit, a plurality of phase pits can be efficiently arranged within a substantially circular light beam spot to be projected for reproduction. As a result, the recorded information in the information unit can be reproduced under stable conditions, and a high capacity optical disk can be realized.

The third optical memory device having the structure of the second optical memory device is arranged such that:

a plurality of phase pits formed at the same distance apart from the center of the recorded information unit are arranged in a shape of a square with the center of the recorded information unit as a center-of-gravity, and one of the diagonal lines dividing the square is overlapped with the information track.

According to the third optical memory device, in addition to the effect of realizing the tracking operation under stable condition, the following effect can be achieved. That is, with the structure wherein the phase pits formed at the same distance apart from the center of the information unit are arranged in the shape of square with the center of the information unit as a center-of-gravity, and the plurality of phase pits are arranged within the optical beam spot of the incident light for reproduction at the highest density. With this structure, the information can be multiplex recorded in each of the information units at the maximum intensity, and a high capacity optical memory device can be realized.

The fourth optical memory device having the structure of the second optical memory device is arranged such that:

a plurality of phase pits arranged at the same distance from the center of the recorded information unit are arranged in a shape of a square with the center of the recorded information unit as a center-of-gravity, and one of the diagonal lines dividing the hexagon is overlapped with the information track.

According to the third optical memory device, in addition to the effect of realizing the tracking operation under stable condition, the following effect can be achieved. That is, with the structure wherein the phase pits formed at the same distance apart from the center of the information unit are arranged in the shape of square with the center of the information unit as a center-of-gravity, and the plurality of phase pits are arranged within the optical beam spot of the incident light for reproduction at the highest density. As a result, the information can be multiplex recorded in each of the information units at the maximum intensity, and a high capacity optical memory device can be realized.

The fifth optical memory device having the structure of the first optical memory device is arranged such that the servo information unit is made up of a pair of larger servo phase pits than the phase pits of the recorded information unit.

According to the foregoing structure, the servo information unit is made up of a pair of larger servo phase pits than the phase pit of the recorded information unit, changes in reflected light from the servo information unit can be made larger, and the tracking operation can be performed under more stable condition.

The six optical memory device having the first optical memory device is arranged such that the servo information unit is made up of a plurality of phase pits arranged at predetermined positions.

According to the foregoing structure, a phase pit of the same shape can be adopted for the phase pits for the servo information unit and the phase pits for the information unit. With this structure, when forming the original substrate for the optical memory device, the respective phase pits for the servo information unit and for the information unit can be formed under the same conditions, and the required control conditions for forming the master for the optical memory device can be reduced. As a result, the master for the optical memory device and the optical memory device can be formed under stable conditions.

The seventh optical memory device having the structure of the six optical memory device is arranged such that the phase pits of the servo information unit are arranged in the same pattern as the phase pits of the recording information unit.

According to the foregoing arrangement wherein the phase pits of the servo information unit are arranged in the same pattern as the phase pits of the recording information unit, when forming the original substrate for the optical memory device, the respective phase pits for the servo information unit and for the information unit can be formed under the same conditions, and the required control conditions for forming the master for the optical memory device can be reduced. As a result, the master for the optical memory device and the optical memory device can be formed under stable conditions.

The eighth optical memory device having the seventh optical memory device is arranged such that the servo information unit is made up of the phase pits arranged at all the phase pit positions of the recording information unit.

According to the foregoing structure, in addition to the foregoing effect, the following effect can be achieved. That is, with the structure wherein the servo information unit is made up of the phase pits arranged at all the phase pit positions of the recording information unit, changes in reflected light from the synchronous unit can be made larger, and the tracking can be performed in more stable condition.

The first optical memory device reproducing device for reproducing recorded information from the foregoing first to the eighth optical memory devices is arranged so as to include:

light irradiation means for irradiating the recording unit of the optical memory device with the reproducing light; and an optical system for directing the reflected light from the recording unit to the reproduction photodetector; and

the optical system for directing the reflected light from each recording unit to the reproduction photodetector, wherein the reproduction photodetector is made up of a plurality of divided photo detecting elements, and
the first optical memory device reproducing device further includes reproducing means for reproducing recorded information by identifying each recording information unit based on a photo-detection signal from each of the divided photo detecting elements.

According to the foregoing first optical memory device reproducing device, the reproducing light is emitted onto the optical memory device so that the reflected light can be incident on the divided photo-detecting faces of the photo-detecting element, and each information unit is identified based on a photo-detecting signal obtained from each of the divided photo-detecting faces, thereby reproducing information multiplex recorded on the optical memory device.

The second optical memory device reproducing device is arranged so as to perform a tracking operation based on the reflected light from the servo information unit when reproducing the recorded information from the optical memory device. With this structure wherein the tracking operation is performed based on the reflected light from the servo information unit, the optical memory device reproducing device of the present invention which permits the tracking operation to be performed under stable condition can be realized.

As described, the optical memory device (optical disk) of the present invention in which a plurality of information units, each having information recorded according to a pit array are formed, are arranged on the information track is characterized in that the pit array of each information unit in the recording region is made up of a combination of the central phase pit formed on the information track and surrounding phase pits surrounding the central phase pit, and in the servo region, a pair of servo units are formed on both sides of the information track.

For the optical memory device of the present invention, the recording medium from which recorded information are read out by projecting light, such as DVD (Digital Versatile Disc), CD(Compact Disk), or other optical disks, optical cards, etc., may be adopted.

According to the optical memory device of the present invention, the information are recorded on the information track by forming the information units, each being made up of phase pits.

The phase pit is a protrusion (or a recession) formed on the substrate of the optical memory device, and the reflectance of light of such phase pit differs from the reflectance of light of the flat pat of the substrate (where the phase pit is not formed).

Incidentally, the information unit is a unit for recording information in the optical memory device, each being made up of a group of phase pits.

Namely, according to the optical memory device of the present invention, the information (recorded content) of each information unit is determined by a combination of the number and the position of the pits (pit array).

When reproducing recorded information from the optical memory device, based on the reflected light from the information unit, it is possible to identify the pit array of the information unit.

According to the optical memory device, the pit array of the information unit is made up of a phase pit provided at the center of the information unit and the phase pits surrounding the center of the information unit.

According to the optical memory device of the present invention, as compared to the case wherein the pit array is made up of phase pits surrounding the phase pit at the center, the recording density can be significantly improved.

According to the optical memory device of the present invention, the phase pit is provided at the center of the surrounding phase pits. As a result, the phase pits can be provided at high density, and the recording density can be still improved.

According to the optical memory device of the present invention, the number of divided light receiving faces (partial light receiving faces) required for reproducing information is set in the number of the surrounding phase pits.

Namely, for example, in the case where the pit array of the information unit is made up of only four surrounding phase pits, the intensity distribution of the reflected light from the information unit corresponds to the shape of the square (the phase pits form a shape of the square when all the phase pits are provided).

Accordingly, for the reproduction photodetector for use in reproducing the recorded information, adopted is the photodetector having four divided light receiving faces is adopted which is obtained by dividing the light receiving face into four corresponding to the four surrounding phase pits.

Generally, the six divided light receiving faces are obtained by dividing by two parting lines which pass through the center of the reproduction photodetector, and these four divided light receiving faces are in the shape of a fan that radically expands from the center of the reproduction photodetector.

The reproduction photodetector determines with or without the surrounding phase pit for the four surrounding phase pits in the information unit (the location(s) of the surrounding phase pit(s)) according to the intensity of the reflected lights incident on the four divided light receiving faces. The reproduction photodetector then identifies the pit array to be reproduced based on the determination result.

When adopting the phase pit array made of four surrounding phase pits and the phase pit at the center as in the optical memory device of the present invention, the four-divided photodetector made up of four-divided light receiving faces can be adopted.

Namely, the reflected lights from the phase pit have an intensity distribution according to the distance from the center of the reproduction photo-detector (the lights incident at positions apart from the center of the photo photodetector by the same distance have the same intensity). Therefore, the reflected lights having the same intensity distribution are incident respectively on the four-divided light receiving faces in the reproduction photodetector.

Therefore, when reproducing information from the optical memory disk of the present invention using the four-divided photodetector, it is possible to determine if the phase pit is provided at the center, based on the intensity of the total received light amount by the entire light receiving faces (the total reflected light amount from the entire information unit (pit array)).

As explained earlier, for the surrounding phase pits, it can be determined if the surrounding phase pit is provided at each position based on the intensity of the light incident on each of the four-divided light receiving faces.

As described, according to the optical memory device of the present invention which adopts for the information unit, the phase pit array made up of phase pits in the number of n (n is an integer) including the pit array provided at the center, it is possible to reproduce the recorded information using the divide photodetector whose light receiving face is divided in the number of n-1.

As a result, the present invention provides the optical memory device which permits information to be recorded at high density and the recorded information to be reproduced without requiring the reproduction circuits of complicated structure.

Further, the optical memory device is provided with a pair of servo units formed on both sides of the information track.

The pair of servo units is a pair of patterns arranged on both sides of the information track formed at positions shifted from the information track in a direction crossing the information track at right angle.

It is preferable that the pair of the patterns be formed in such a manner that the two servo units are axisymmetric about the information track.

Here, the pattern indicates recessions (protrusions) formed on the substrate, like the phase pits.

Here, when reproducing from the optical memory device without the servo unit, the tracking operation is controlled by the push-pull method based on the reflected lights from the information unit.

When adopting the pit arrays which are not symmetrical in the radius direction, the intensity distribution of the reflected light from both sides of the information track also become symmetrical. Therefore, a problem arises in that a push-pull signal is disturbed, and an accurate tracking control cannot be performed (the tracking operation becomes unstable). The unstable tracking in turn causes the problem in that the total reflected light amount cannot be measured accurately from each of the information units and the pit array of the information unit cannot be identified accurately.

According to the foregoing structure of the optical memory device including the above servo units, the tracking can be controlled by the sample servo method based on the reflected light from the servo unit. Therefore, by adopting the foregoing optical memory device, the tracking can be performed under stable condition, and the recorded information can be reproduced with high precision.

It is preferable that the optical memory device of the present invention be arranged such that the surrounding phase pits are provided at the same distance from the central phase pit.

According to the foregoing structure, within the light spot formed on the information unit to be reproduced, all the phase pits can be arranged efficiently (high density). As a result, the light spot for reproduction can be made smaller.

It is preferable that the optical memory device of the present invention be arranged such that the surrounding phase pits are provided at apexes of the square, and the central phase pit is provided at the center of the square.

According to the foregoing structure, the information unit is made up of five phase pits, i.e., four surrounding phase pits and the central phase pit formed on the information track.

According to the foregoing structure, the information (5-bit data) of 32 (25) kinds can be multiplex-recorded for each information unit. Therefore, as compared to the arrangement adopting the pit array made up of a combination of only four phase pits, the recording density can be significantly improved.

In the case of adopting the pit array made up of five phase pits located at apexes of the pentagon to multiplex record five-bit data, the intensity distribution of the reflected light from the information unit corresponds to the shape of the pentagon (the shape of the pentagon is formed when the pixel array is made up of five phase pits). Therefore, it is necessary to provide the divided light receiving faces corresponding to the five phase pits, and to determine if each phase pit is provided based on the intensity of the light incident on each of these five divided light receiving faces.

With this structure, it is therefore required to divide the light receiving face of the photodetector into five (the number of divided light receiving faces is five). As a result, the circuit for processing the intensity of the light incident on each of the divided light receiving faces becomes complicated, which results in an increase in cost.

Incidentally, when adopting the photo-receptor whose light receiving face is divided into five, an angle formed between the adjacent light receiving faces becomes smaller, and a reproducing error is therefore more liable to occur due to a lower precision in determining the position of each phase pit.

In the structure wherein surrounding phase pits are provided at apexes of the square, it is preferable that one of the diagonal lines be overlapped with the information track.

With this structure, the pit array of the information unit which is axisymmetric (line symmetry) about the information track can be formed with ease. With this structure, the push-pull signal can be surely prevented from being disturbed. It is therefore possible to perform the tracking control of the optical memory device of the present invention also by the push-pull method under stable condition.

It is preferable that the optical memory device of the present invention be arranged such that the surrounding phase pits are provided at apexes of the hexagon with the central phase pit at the center of the hexagon.

According to the foregoing structure, the information (7-bit data) of 128 (27) kinds can be multiplex-recorded for each information unit. Therefore, as compared to the arrangement adopting the pit array made up of a combination of only six surrounding phase pits, the recording density can be significantly raised.

According to the foregoing structure wherein the phase pits are provided at apexes of the hexagon and the center (center-of-gravity) of the hexagon, the phase pits can be arranged at the maximum density.

As described, according to the optical memory device of the present invention, as a large number of information units can be formed, the recording density of the optical memory device can be increased. Furthermore, the light spot for reproduction can be reduced.

In the case of adopting the pit array made up of seven phase pits located at apexes of the heptagon, the intensity distribution of the reflected light from the information unit 5 corresponds to the shape of the heptagon (the shape of the heptagon is formed when the pixel array is made up of seven phase pits). Therefore, it is necessary to provide the divided light receiving faces corresponding to these seven phase pits, and to determine if each phase pit is provided based on the intensity of the light incident on each of the seven divided light receiving faces.

With this structure, it is therefore required to divide the light receiving face of the photodetector into seven (the number of divided light receiving faces is seven). Therefore, the circuit for processing the intensity of the light incident on each of these seven divided light receiving faces becomes complicated, which results in an increase in cost.

Incidentally, when adopting the photo-receptor whose light receiving face is divided into seven, an angle formed between the adjacent light receiving faces becomes smaller, and a reproducing error is therefore more liable to occur due to a lower precision in determining the position of each phase pit.

In the structure wherein surrounding phase pits are provided at apexes of the hexagon, it is preferable that one of the diagonal lines which pass through the center of the hexagon be overlapped with the information track.

With this structure, the pit array of the information unit which is axisymmetric (line symmetry) about the information track can be formed with ease. With this structure, the push-pull signal can be surely prevented from being disturbed. It is therefore possible to perform the tracking control of the optical memory device of the present invention also by the push-pull method under stable condition.

It is preferable that the synchronous unit in the optical memory device of the present invention be made up of a larger pattern than the phase pits of the information unit.

According to the foregoing structure, changes in reflected light from the synchronous unit can be made larger, and it is possible to generate the synchronous signal with ease.

Incidentally, the synchronous unit in the optical memory device of the present invention may be made up of a large size pattern or a plurality of small size patterns.

In the case of adopting the servo unit made up of a plurality of small patterns, it is preferable that same phase pits as those adopted in the information unit be adopted.

According to the foregoing structure, as the phase pits (pattern) of the information unit are the same as the phase pits of the servo unit, the servo units can be formed with ease.

In the case of adopting the phase pits of the information units for the pattern of the servo unit, it is preferable that the pattern of the servo unit is made up of all the surrounding phase pits and the central phase pit.

According to the foregoing structure, changes in reflected light from the synchronous unit can be made larger, and the tracking control can be performed by the sample servo method with ease.

The optical memory device of the present invention is applicable to for example an optical disk, an optical card, etc.

The optical disk has a spiral information track or concentric information tracks. The optical card has an information track formed in a straight line.

The optical reproducing device of the present invention wherein light is emitted onto the information unit of the optical memory device to reproduce the recorded information based on the reflected light, is arranged so as to include:

the reproduction photodetector which receives the reflected light from the information unit and outputs a light receiving signal according to the received amount of light; and

the pit array identification circuit which specifies the pit array of the information unit to be reproduced based on the light receiving signal from the reproduction photodetector.

The optical reproducing device of the present invention for reproducing recorded information from the optical memory device is arranged such that light is emitted onto the information unit of the optical memory device of the present invention, and the pit array of the information unit is identified based on the reflected light, thereby reproducing recorded information.

Namely, according to the optical reproducing device of the present invention, the reproduction photodetector receives reflected light from the information unit and outputs a light receiving signal according to the received amount of light. Then, based on the light receiving signal, the pit array identification circuit specifies the pit array of the information unit (the information unit irradiated with light) to be reproduced.

The optical reproducing device of the present invention may be arranged so as to include the control photodetector. This control photodetector receives the reflected light from the information unit and outputs to the optical control circuit, a light receiving signal according to the received amount of light.

The light control circuit controls the light to be emitted onto the optical memory device based on the light receiving signal from the control photodetector (controls the irradiation position or the focal position of light).

It is preferable that the control photodetector be provided separately from the foregoing reproduction photodetector.

Generally, as the reflected light incident onto the control photodetector is subjected to focusing by the cylindrical lens, the wave front of the reflected light is disturbed. For this reason, in the case where the same photodetector is used both as the control photodetector and the photodetector, the reflected light with uneven wave front is incident on the reproduction photodetector. A problem therefore arises in that the intensity distribution of the light incident on the light receiving face is disturbed, and it is difficult to accurately identify the pit array of the information unit.

In response, according to the structure of the present invention by separately providing the reproduction photodetector and the control photodetector, the light intensity distribution on the reproduction photodetector is not disturbed. As a result, it is possible to accurately control the light, and in the meantime, the recorded information can be reproduced accurately.

The present invention can be suitably applied to DVDs, CDs, or other optical disks, and an optical disk device for reproducing recorded information from such optical disks.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

1. An optical memory device in which a plurality of information units are arranged along an information track, each of said plurality of information units having information recorded according to a pit array,
wherein the pit array of each information unit in a recording region is made up of a combination of a central phase pit provided on the information track and surrounding phase pits surrounding said central phase pit.

2. The optical memory device as set forth in claim 1, wherein:
said surrounding phase pits are provided at the same distance from said central phase pit.

3. The optical memory device as set forth in claim 2, wherein:
said surrounding phase pits are provided at apexes of a hexagon, and said central phase pit is provided at a center of said hexagon.

4. The optical memory device as set forth in claim 3, wherein:
one of the diagonal lines of said hexagon is overlapped with said information track.

5. The optical memory device as set forth in claim 3, wherein:
for the pit- arrays of said plurality of information units, only combinations of the surrounding phase pits in an odd number, or only combinations of the surrounding phase pits in an even number are adopted.

6. The optical memory device as set forth in claim 3, wherein:
the pit array of each information unit is symmetrical about one of the diagonal lines, which passes the center of the hexagon.

7. The optical memory device as set forth in claim 1, wherein:
the pit array of each information unit is symmetrical about one of the information track.

8. The optical memory device as set forth in claim 1, wherein:
said information track is formed in a spiral form or a concentric form.

9. The optical memory device as set forth in claim 1, wherein:
a plurality of synchronous units of the same shape are arranged at equal intervals along the information track.

10. The optical memory device as set forth in claim 9, wherein:
each of said plurality of synchronous units is made up of a larger pattern than a pattern of phase pits of said information unit.

11. The optical memory device as set forth in claim 9, wherein:
said plurality of synchronous units are made up of a group of a plurality of patterns.

12. The optical memory device as set forth in claim 11, wherein:
the pattern of each of said plurality of synchronous units is made up of same phase pits as the phase pits of the information unit.

13. The optical memory device as set forth in claim 12, wherein:
each of said plurality of synchronous units is made up of all the surrounding phase pits and the central phase pit of the information unit.

14. The optical memory device as set forth in claim 9, wherein:
said plurality of synchronous units are formed at the same intervals as intervals at which the information units are formed in the direction of the information track.

15. The optical memory device as set forth in claim 9, wherein:
said plurality of synchronous units are formed at intervals twice as long as intervals at which the information units are formed in the direction of the information track.

16. The optical memory device as set forth in claim 1, wherein:
a plurality servo units are formed on both sides of said information track.

17. The optical memory device as set forth in claim 16, wherein:
said surrounding phase pits are provided at the same distance from said central phase pit.

18. The optical memory device as set forth in claim 17, wherein:
said surrounding phase pits are provided at apexes of a square, and the central phase pit is provided at a center of the square.

19. The optical memory device as set forth in claim 18, wherein:
one of diagonal lines of the square is overlapped with the information track.

20. The optical memory device as set forth in claim 16, wherein:
each of said servo units is made up of a larger pattern than a pattern of phase pits of said information unit.

21. The optical memory device as set forth in claim 16, wherein:
said pair of servo units is made up of a group of a plurality of patterns.

22. The optical memory device as set forth in claim 21, wherein:
the pattern of each of said servo units is made up of same phase pits as the phase pits of the information unit.

23. The optical memory device as set forth in claim 22, wherein:
each of said servo units is made up of all the surrounding phase pits and the central phase pit.

24. An optical reproducing device which reproduces recorded information from the optical memory device which includes a plurality of information units arranged along an information track, each of said plurality of information units having information recorded according to a pit array, wherein the pit array of each information unit in a recording region is made up of a combination of a central phase pit provided on the information track and surrounding phase pits surrounding said central phase pit, and said surrounding phase pits are provided at apexes of a hexagon at the same distance from a center of said hexagon at which said central phase pit is provided, said optical reproducing device emitting lights onto said information units of said optical memory device and reproducing the recorded information from said optical memory device based on reflected lights, said optical memory device, comprising:
reproduction photodetector which receives the reflected light from the information unit, and outputs a light receiving signal according to the received amount of light;
a pit array identification circuit for identifying the pit array of the information unit to be reproduced based on the light receiving signal outputted from said reproduction photodetector.

25. The optical reproducing device as set forth in claim 24, further comprising:
a control photodetector which receives reflected light from the information unit of said optical memory device and outputs the light receiving signal according to the received amount of light, said control photodetector being provided separately from said reproduction photodetector; and
an optical control circuit for controlling light to be emitted onto said optical memory device, based on a light receiving signal to be outputted from said control photodetector.

26. The optical reproducing device as set forth in claim 24, further comprising:
said reproduction photodetector is a six-divided photodetector having six divided light receiving faces formed by dividing a light receiving face equally into six by three parting lines.

27. The optical reproducing device as set forth in claim 26, further comprising:
the three parting lines which divide the light receiving face of the reproduction photodetector are provided so that any adjacent two parting lines form an angle of 60°; and
one of these parting lines crosses a straight line corresponding to one of the diagonals of the hexagon on the light receiving face at right angle.

28. The optical reproducing device as set forth in claim 26, wherein said pit array identification circuit includes:
a total received light amount comparison circuit for specifying a total reflected light amount obtained by adding all the reflected lights from the information unit based on light receiving signals outputted from all the divided light receiving faces; and
a partial light amount comparison circuit 44 which compares respective intensities of the lights incident on respective divided light receiving faces based on the light receiving signals outputted from the divided light receiving faces and identifies each pit array of the information unit,
wherein said partial light amount comparison circuit identifies the content of the comparison based on the total reflected light amount.

29. An optical reproducing device which reproduces recorded information from the optical memory device which includes a plurality of information units arranged along an information track, each of said plurality of information units having information recorded according to a pit array, wherein the pit array of each information unit in a recording region is made up of a combination of a central phase pit provided on the information track and surrounding phase pits surrounding said central phase pit, and a plurality of synchronous units of the same shape are arranged at equal intervals along the information track, said optical reproducing device emitting lights onto said optical memory device and reproducing the recorded information based on reflected lights, said optical memory device, comprising:
photodetector which receives a reflected light from said information unit and said synchronous unit, and outputs a light receiving signal according to the received amount of light; and
a pit array identification circuit for identifying the pit array of the information unit to be reproduced based on the light receiving signal outputted from said photodetector; and
a synchronous signal generation circuit which generates a synchronous signal to be outputted to said pit array identification circuit, based on the light receiving signal from said synchronous unit,
wherein said pit array identification circuit specifies the pit array of the information unit to be reproduced based on this synchronous signal.

30. The optical reproducing device of claim 29, wherein:
said plurality of synchronous units are formed at the same intervals as intervals at which the information units are formed in the direction of the information track; and
said synchronous signal generation circuit generates a synchronous signal having the same cycle as the light receiving signal.

31. The optical reproducing device of claim 29, wherein:
said synchronous units are formed at intervals twice as long as intervals at which said information units are formed; and
said synchronous signal generation circuit generates a synchronous signal whose cycle is ½ of that of the light receiving signal from said synchronous unit.

32. An optical reproducing device for reproducing recorded information from an optical memory device which includes a plurality of information units arranged along an information track, each of said plurality of information units having information recorded according to a pit array, wherein the pit array of each information unit in a recording region is made up of a combination of a central phase pit provided on the information track and surrounding phase pits surrounding said central phase pit, and a pair of servo units are formed on both sides of the information track, said optical reproducing device emitting lights onto said optical memory device and reproducing the recorded information based on reflected lights, said optical memory device, comprising:
a reproduction photodetector which receives the reflected light from the information unit, and outputs a light receiving signal according to the received amount of light; and
a pit array identification circuit for identifying the pit array of the information unit to be reproduced based on the light receiving signal outputted from said reproduction photodetector.

33. The optical reproducing device of claim 32, wherein:
a control photodetector which receives reflected light from the servo units of said optical memory device and outputs the light receiving signal according to the received amount of light; and
an optical control circuit for carrying out a tracking control of light to be emitted onto said optical memory device based on the light receiving signal to be outputted from said control photodetector.

34. The optical reproducing device of claim 33, wherein:
said control photodetector is separately provided from said reproduction photodetector.
